(19) United States
(12) Patent Application Publication
(10) Pub. No.: US 2018/0004526 A1
(43) Pub. Date: Jan. 4, 2018

(54) System and Method for Tracing Data Addresses

(71) Applicant: Intel IP Corporation, Santa Clara, CA (US)

(72) Inventor: Markus Lyra, Munich (DE)

(21) Appl. No.: 15/198,568

(22) Filed: Jun. 30, 2016

(51) Int. Cl. G06F 9/30; G06F 17/50; G06F 9/32

(52) U.S. Cl. CPC G06F 9/30167; G06F 9/322; G06F 17/5009

(57) ABSTRACT

A processor includes a front end to receive instructions, a decoder to decode instructions, a core to execute instructions, and a retirement unit to retire instructions. The core includes circuitry to determine, during execution of an instruction, whether the value of a register input to an address generation operation for a memory access performed by the instruction is predictable in a subsequent instruction simulation, to output the value of the register to a trace if it is not predictable, and to refrain from outputting the value of the register to the trace if it is predictable. The target of the instruction may be a destination register. The core also includes circuitry to write a value to a prediction state indicator for the destination register indicating that the value of the destination register is unpredictable, in response to determining that at least one source operand of the instruction is unpredictable.

### FIELD OF THE INVENTION

The present disclosure pertains to the field of processing logic, microprocessors, and associated instruction set architecture that, when executed by the processor or other processing logic, perform logical, mathematical, or other functional operations.

### DESCRIPTION OF RELATED ART

Multiprocessor systems are becoming more and more common. Applications of multiprocessor systems include dynamic domain partitioning all the way down to desktop computing. Keep, modify or replace: In order to take advantage of multiprocessor systems, code to be executed may be separated into multiple threads for execution by various processing entities. Each thread may be executed in parallel with one another. Pipelining of applications may be implemented in systems in order to more efficiently execute applications. Instructions as they are received on a processor may be decoded into terms or instruction words that are native, or more native, for execution on the processor. Processors may be implemented in a system on chip.

### DESCRIPTION OF THE FIGURES

Embodiments are illustrated by way of example and not limitation in the Figures of the accompanying drawings:

FIG. 1A is a block diagram of an exemplary computer system formed with a processor that may include execution units to execute an instruction, in accordance with embodiments of the present disclosure;

FIG. 1B illustrates a data processing system, in accordance with embodiments of the present disclosure;

FIG. 1C illustrates other embodiments of a data processing system for performing text string comparison operations;

FIG. 2 is a block diagram of the micro-architecture for a processor that may include logic circuits to perform instructions, in accordance with embodiments of the present disclosure;

FIG. 3A illustrates various packed data type representations in multimedia registers, in accordance with embodiments of the present disclosure;

FIG. 3B illustrates possible in-register data storage formats, in accordance with embodiments of the present disclosure;

FIG. 3C illustrates various signed and unsigned packed data type representations in multimedia registers, in accordance with embodiments of the present disclosure;

FIG. 3D illustrates an embodiment of an operation encoding format;

FIG. 3E illustrates another possible operation encoding format having forty or more bits, in accordance with embodiments of the present disclosure;

FIG. 3F illustrates yet another possible operation encoding format, in accordance with embodiments of the present disclosure;

FIG. 4A is a block diagram illustrating an in-order pipeline and a register renaming stage, out-of-order issue/execution pipeline, in accordance with embodiments of the present disclosure;

FIG. 4B is a block diagram illustrating an in-order architecture core and a register renaming logic, out-of-order issue/execution logic to be included in a processor, in accordance with embodiments of the present disclosure;

FIG. 5A is a block diagram of a processor, in accordance with embodiments of the present disclosure;

FIG. 5B is a block diagram of an example implementation of a core, in accordance with embodiments of the present disclosure;

FIG. 6 is a block diagram of a system, in accordance with embodiments of the present disclosure;

FIG. 7 is a block diagram of a second system, in accordance with embodiments of the present disclosure;

FIG. 8 is a block diagram of a third system in accordance with embodiments of the present disclosure;

FIG. 9 is a block diagram of a system-on-a-chip, in accordance with embodiments of the present disclosure;

FIG. 10 illustrates a processor containing a central processing unit and a graphics processing unit which may perform at least one instruction, in accordance with embodiments of the present disclosure;

FIG. 11 is a block diagram illustrating the development of IP cores, in accordance with embodiments of the present disclosure;

FIG. 12 illustrates how an instruction of a first type may be emulated by a processor of a different type, in accordance with embodiments of the present disclosure;

FIG. 13 illustrates a block diagram contrasting the use of a software instruction converter to convert binary instructions in a source instruction set to binary instructions in a target instruction set, in accordance with embodiments of the present disclosure;

FIG. 14 is a block diagram of an instruction set architecture of a processor, in accordance with embodiments of the present disclosure;

FIG. 15 is a more detailed block diagram of an instruction set architecture of a processor, in accordance with embodiments of the present disclosure;

FIG. 16 is a block diagram of an execution pipeline for an instruction set architecture of a processor, in accordance with embodiments of the present disclosure;

FIG. 17 is a block diagram of an electronic device for utilizing a processor, in accordance with embodiments of the present disclosure;

FIG. 18 is an illustration of an example system for tracing data addresses, according to embodiments of the present disclosure;

FIG. 19 illustrates an example method for tracing data addresses and using the traced information in a simulation, according to embodiments of the present disclosure;

FIG. 20 illustrates selected elements of an example system that implements data address tracing, according to embodiments of the present disclosure;

FIG. 21A illustrates an example method for determining, during execution of an instruction, whether or not the value of a destination register for the instruction is predictable in a subsequent instruction simulation, according to embodiments of the present disclosure;

FIG. 21B illustrates an example method for outputting the values of some source registers and/or updating prediction state indicators for source and/or destination registers during retirement of an instruction, according to embodiments of the present disclosure;

FIG. 22 illustrates the propagation of the respective predication state bits for various registers used for address generation by different instructions, according to embodiments of the present disclosure;

FIG. 23 illustrates selected elements of an example system for simulating the execution of a program dependent on data address tracing, according to embodiments of the present disclosure; and

FIG. 24 illustrates an example method for simulating the execution of a program using data address trace information, according to embodiments of the present disclosure.

### DETAILED DESCRIPTION

The following description describes a processing apparatus and processing logic for performing data address tracing while executing a stream of program instructions. Such a processing apparatus may include an out-of-order processor. In the following description, numerous specific details such as processing logic, processor types, micro-architectural conditions, events, enablement mechanisms, and the like are set forth in order to provide a more thorough understanding of embodiments of the present disclosure. It will be appreciated, however, by one skilled in the art that the embodiments may be practiced without such specific details. Additionally, some well-known structures, circuits, and the like have not been shown in detail to avoid unnecessarily obscuring embodiments of the present disclosure.

Although the following embodiments are described with reference to a processor, other embodiments are applicable to other types of integrated circuits and logic devices. Similar techniques and teachings of embodiments of the present disclosure may be applied to other types of circuits or semiconductor devices that may benefit from higher pipeline throughput and improved performance. The teachings of embodiments of the present disclosure are applicable to any processor or machine that performs data manipulations. However, the embodiments are not limited to processors or machines that perform 512-bit, 256-bit, 128-bit, 64-bit, 32-bit, or 16-bit data operations and may be applied to any processor and machine in which manipulation or management of data may be performed. In addition, the following description provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

Although the below examples describe instruction handling and distribution in the context of execution units and logic circuits, other embodiments of the present disclosure may be accomplished by way of a data or instructions stored on a machine-readable, tangible medium, which when performed by a machine cause the machine to perform functions consistent with at least one embodiment of the disclosure. In one embodiment, functions associated with embodiments of the present disclosure are embodied in machine-executable instructions. The instructions may be used to cause a general-purpose or special-purpose processor that may be programmed with the instructions to perform the steps of the present disclosure. Embodiments of the present disclosure may be provided as a computer program product or software which may include a machine or computer-readable medium having stored thereon instructions which may be used to program a computer (or other electronic devices) to perform one or more operations according to embodiments of the present disclosure. Furthermore, steps of embodiments of the present disclosure might be performed by specific hardware components that contain fixed-function logic for performing the steps, or by any combination of programmed computer components and fixed-function hardware components.

Instructions used to program logic to perform embodiments of the present disclosure may be stored within a memory in the system, such as DRAM, cache, flash memory, or other storage. Furthermore, the instructions may be distributed via a network or by way of other computer-readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium may include any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as may be useful in simulations, the hardware may be represented using a hardware description language or another functional description language. Additionally, a circuit level model with logic and/or transistor gates may be produced at some stages of the design process. Furthermore, designs, at some stage, may reach a level of data representing the physical placement of various devices in the hardware model. In cases wherein some semiconductor fabrication techniques are used, the data representing the hardware model may be the data specifying the presence or absence of various features on different mask layers for masks used to produce the integrated circuit. In any representation of the design, the data may be stored in any form of a machine-readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or retransmission of the electrical signal is performed, a new copy may be made. Thus, a communication provider or a network provider may store on a tangible, machine-readable medium, at least temporarily, an article, such as information encoded into a carrier wave, embodying techniques of embodiments of the present disclosure.

In modern processors, a number of different execution units may be used to process and execute a variety of code and instructions. Some instructions may be quicker to complete while others may take a number of clock cycles to complete. The faster the throughput of instructions, the better the overall performance of the processor. Thus it would be advantageous to have as many instructions execute as fast as possible. However, there may be certain instructions that have greater complexity and require more in terms of execution time and processor resources, such as floating point instructions, load/store operations, data moves, etc.

As more computer systems are used in internet, text, and multimedia applications, additional processor support has been introduced over time. In one embodiment, an instruction set may be associated with one or more computer architectures, including data types, instructions, register architecture, addressing modes, memory architecture, interrupt and exception handling, and external input and output (I/O).

In one embodiment, the instruction set architecture (ISA) may be implemented by one or more micro-architectures, which may include processor logic and circuits used to implement one or more instruction sets. Accordingly, processors with different micro-architectures may share at least a portion of a common instruction set. For example, Intel® Pentium 4 processors, Intel® Core™ processors, and processors from Advanced Micro Devices, Inc. of Sunnyvale Calif. implement nearly identical versions of the x86 instruction set (with some extensions that have been added with newer versions), but have different internal designs. Similarly, processors designed by other processor development companies, such as ARM Holdings, Ltd., MIPS, or their licensees or adopters, may share at least a portion of a common instruction set, but may include different processor designs. For example, the same register architecture of the ISA may be implemented in different ways in different micro-architectures using new or well-known techniques, including dedicated physical registers, one or more dynamically allocated physical registers using a register renaming mechanism (e.g., the use of a Register Alias Table (RAT), a Reorder Buffer (ROB) and a retirement register file. In one embodiment, registers may include one or more registers, register architectures, register files, or other register sets that may or may not be addressable by a software programmer.

An instruction may include one or more instruction formats. In one embodiment, an instruction format may indicate various fields (number of bits, location of bits, etc.) to specify, among other things, the operation to be performed and the operands on which that operation will be performed. In a further embodiment, some instruction formats may be further defined by instruction templates (or sub-formats). For example, the instruction templates of a given instruction format may be defined to have different subsets of the instruction format's fields and/or defined to have a given field interpreted differently. In one embodiment, an instruction may be expressed using an instruction format (and, if defined, in a given one of the instruction templates of that instruction format) and specifies or indicates the operation and the operands upon which the operation will operate.

Scientific, financial, auto-vectorized general purpose, RMS (recognition, mining, and synthesis), and visual and multimedia applications (e.g., 2D/3D graphics, image processing, video compression/decompression, voice recognition algorithms and audio manipulation) may require the same operation to be performed on a large number of data items. In one embodiment, Single Instruction Multiple Data (SIMD) refers to a type of instruction that causes a processor to perform an operation on multiple data elements. SIMD technology may be used in processors that may logically divide the bits in a register into a number of fixed-sized or variable-sized data elements, each of which represents a separate value. For example, in one embodiment, the bits in a 64-bit register may be organized as a source operand containing four separate 16-bit data elements, each of which represents a separate 16-bit value. This type of data may be referred to as ‘packed’ data type or ‘vector’ data type, and operands of this data type may be referred to as packed data operands or vector operands. In one embodiment, a packed data item or vector may be a sequence of packed data elements stored within a single register, and a packed data operand or a vector operand may a source or destination operand of a SIMD instruction (or ‘packed data instruction’ or a ‘vector instruction’). In one embodiment, a SIMD instruction specifies a single vector operation to be performed on two source vector operands to generate a destination vector operand (also referred to as a result vector operand) of the same or different size, with the same or different number of data elements, and in the same or different data element order.

SIMD technology, such as that employed by the Intel® Core™ processors having an instruction set including x86, MMX™, Streaming SIMD Extensions (SSE), SSE2, SSE3, SSE4.1, and SSE4.2 instructions, ARM processors, such as the ARM Cortex® family of processors having an instruction set including the Vector Floating Point (VFP) and/or NEON instructions, and MIPS processors, such as the Loongson family of processors developed by the Institute of Computing Technology (ICT) of the Chinese Academy of Sciences, has enabled a significant improvement in application performance (Core™ and MMX™ are registered trademarks or trademarks of Intel Corporation of Santa Clara, Calif.).

In one embodiment, destination and source registers/data may be generic terms to represent the source and destination of the corresponding data or operation. In some embodiments, they may be implemented by registers, memory, or other storage areas having other names or functions than those depicted. For example, in one embodiment, “DEST1” may be a temporary storage register or other storage area, whereas “SRC1” and “SRC2” may be a first and second source storage register or other storage area, and so forth. In other embodiments, two or more of the SRC and DEST storage areas may correspond to different data storage elements within the same storage area (e.g., a SIMD register). In one embodiment, one of the source registers may also act as a destination register by, for example, writing back the result of an operation performed on the first and second source data to one of the two source registers serving as a destination registers.

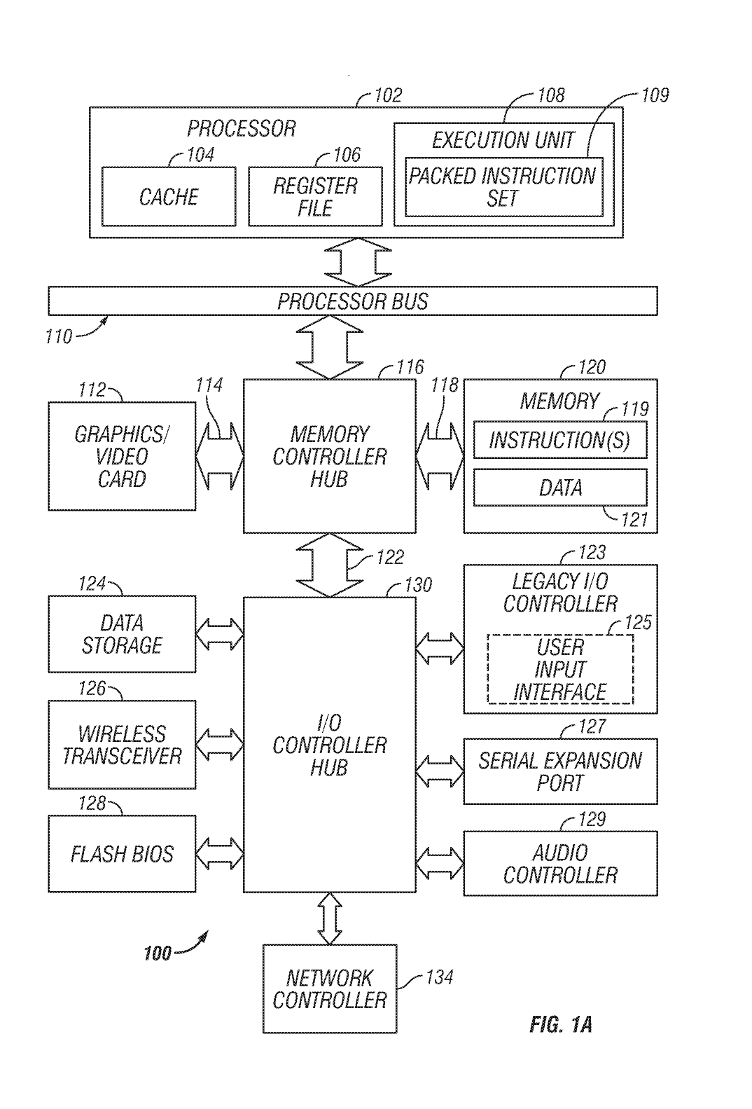

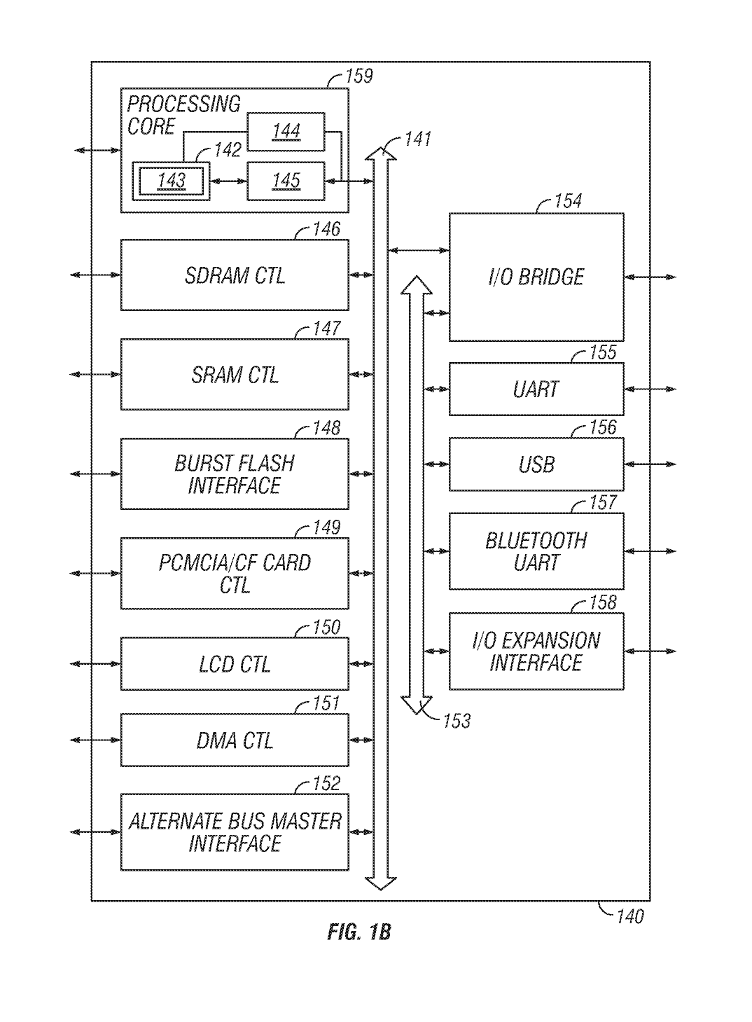

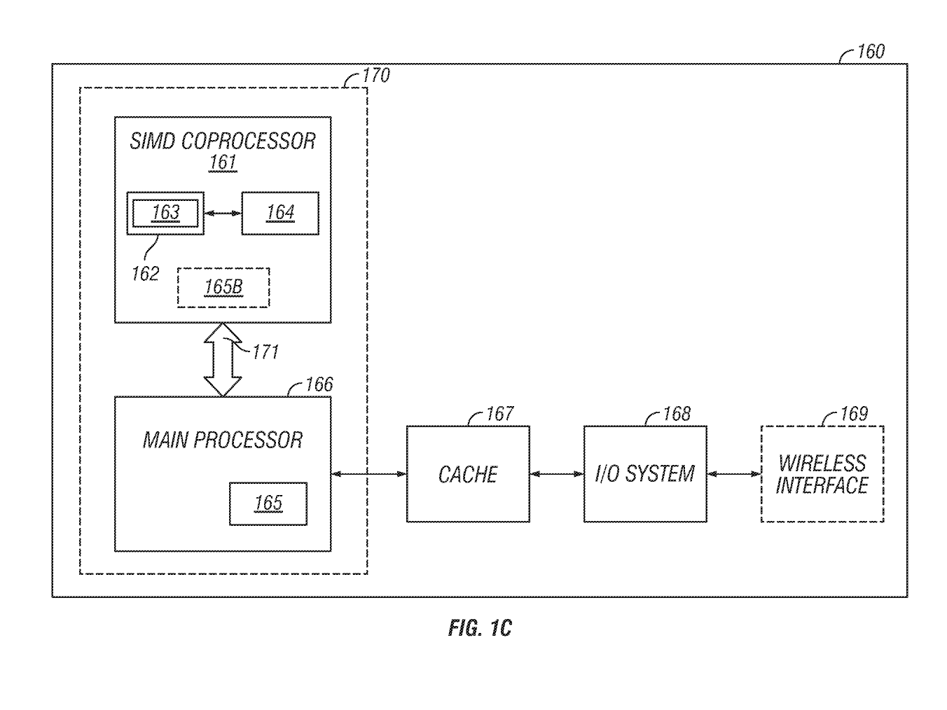

FIG. 1A is a block diagram of an exemplary computer system formed with a processor that may include execution units to execute an instruction, in accordance with embodiments of the present disclosure. System 100 may include a component, such as a processor 102 to employ execution units including logic to perform algorithms for process data, in accordance with the present disclosure, such as in the embodiment described herein. System 100 may be representative of processing systems based on the PENTIUM® III, PENTIUM® 4, Xeon™, Itanium®, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 100 may execute a version of the WINDOWS™ operating system available from Microsoft Corporation of Redmond, Wash., although other operating systems (UNIX and Linux for example), embedded software, and/or graphical user interfaces, may also be used. Thus, embodiments of the present disclosure are not limited to any specific combination of hardware circuitry and software.

Embodiments are not limited to computer systems. Embodiments of the present disclosure may be used in other devices such as handheld devices and embedded applications. Some examples of handheld devices include cellular phones, Internet Protocol devices, digital cameras, personal digital assistants (PDAs), and handheld PCs. Embedded applications may include a micro controller, a digital signal processor (DSP), system on a chip, network computers (NetPC), set-top boxes, network hubs, wide area network (WAN) switches, or any other system that may perform one or more instructions in accordance with at least one embodiment.

Computer system 100 may include a processor 102 that may include one or more execution units 108 to perform an algorithm to perform at least one instruction in accordance with one embodiment of the present disclosure. One embodiment may be described in the context of a single processor desktop or server system, but other embodiments may be included in a multiprocessor system. System 100 may be an example of a ‘hub’ system architecture. System 100 may include a processor 102 for processing data signals. Processor 102 may include a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. In one embodiment, processor 102 may be coupled to a processor bus 110 that may transmit data signals between processor 102 and other components in system 100. The elements of system 100 may perform conventional functions that are well known to those familiar with the art.

In one embodiment, processor 102 may include a Level 1 (L1) internal cache memory 104. Depending on the architecture, the processor 102 may have a single internal cache or multiple levels of internal cache. In another embodiment, the cache memory may reside external to processor 102. Other embodiments may also include a combination of both internal and external caches depending on the particular implementation and needs. Register file 106 may store different types of data in various registers including integer registers, floating point registers, status registers, and instruction pointer register.

Execution unit 108, including logic to perform integer and floating point operations, also resides in processor 102. Processor 102 may also include a microcode (ucode) ROM that stores microcode for certain macroinstructions. In one embodiment, execution unit 108 may include logic to handle a packed instruction set 109. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications may be accelerated and executed more efficiently by using the full width of a processor's data bus for performing operations on packed data. This may eliminate the need to transfer smaller units of data across the processor's data bus to perform one or more operations one data element at a time.

Embodiments of an execution unit 108 may also be used in micro controllers, embedded processors, graphics devices, DSPs, and other types of logic circuits. System 100 may include a memory 120. Memory 120 may be implemented as a dynamic random access memory (DRAM) device, a static random access memory (SRAM) device, flash memory device, or other memory device. Memory 120 may store instructions 119 and/or data 121 represented by data signals that may be executed by processor 102.

A system logic chip 116 may be coupled to processor bus 110 and memory 120. System logic chip 116 may include a memory controller hub (MCH). Processor 102 may communicate with MCH 116 via a processor bus 110. MCH 116 may provide a high bandwidth memory path 118 to memory 120 for storage of instructions 119 and data 121 and for storage of graphics commands, data and textures. MCH 116 may direct data signals between processor 102, memory 120, and other components in system 100 and to bridge the data signals between processor bus 110, memory 120, and system I/O 122. In some embodiments, the system logic chip 116 may provide a graphics port for coupling to a graphics controller 112. MCH 116 may be coupled to memory 120 through a memory interface 118. Graphics card 112 may be coupled to MCH 116 through an Accelerated Graphics Port (AGP) interconnect 114.

System 100 may use a proprietary hub interface bus 122 to couple MCH 116 to I/O controller hub (ICH) 130. In one embodiment, ICH 130 may provide direct connections to some I/O devices via a local I/O bus. The local I/O bus may include a high-speed I/O bus for connecting peripherals to memory 120, chipset, and processor 102. Examples may include the audio controller 129, firmware hub (flash BIOS) 128, wireless transceiver 126, data storage 124, legacy I/O controller 123 containing user input interface 125 (which may include a keyboard interface), a serial expansion port 127 such as Universal Serial Bus (USB), and a network controller 134. Data storage device 124 may comprise a hard disk drive, a floppy disk drive, a CD-ROM device, a flash memory device, or other mass storage device.

For another embodiment of a system, an instruction in accordance with one embodiment may be used with a system on a chip. One embodiment of a system on a chip comprises of a processor and a memory. The memory for one such system may include a flash memory. The flash memory may be located on the same die as the processor and other system components. Additionally, other logic blocks such as a memory controller or graphics controller may also be located on a system on a chip.

FIG. 1B illustrates a data processing system 140 which implements the principles of embodiments of the present disclosure. It will be readily appreciated by one of skill in the art that the embodiments described herein may operate with alternative processing systems without departure from the scope of embodiments of the disclosure.

Computer system 140 comprises a processing core 159 for performing at least one instruction in accordance with one embodiment. In one embodiment, processing core 159 represents a processing unit of any type of architecture, including but not limited to a CISC, a RISC or a VLIW type architecture. Processing core 159 may also be suitable for manufacture in one or more process technologies and by being represented on a machine-readable media in sufficient detail, may be suitable to facilitate said manufacture.

Processing core 159 comprises an execution unit 142, a set of register files 145, and a decoder 144. Processing core 159 may also include additional circuitry (not shown) which may be unnecessary to the understanding of embodiments of the present disclosure. Execution unit 142 may execute instructions received by processing core 159. In addition to performing typical processor instructions, execution unit 142 may perform instructions in packed instruction set 143 for performing operations on packed data formats. Packed instruction set 143 may include instructions for performing embodiments of the disclosure and other packed instructions. Execution unit 142 may be coupled to register file 145 by an internal bus. Register file 145 may represent a storage area on processing core 159 for storing information, including data. As previously mentioned, it is understood that the storage area may store the packed data might not be critical. Execution unit 142 may be coupled to decoder 144. Decoder 144 may decode instructions received by processing core 159 into control signals and/or microcode entry points. In response to these control signals and/or microcode entry points, execution unit 142 performs the appropriate operations. In one embodiment, the decoder may interpret the opcode of the instruction, which will indicate what operation should be performed on the corresponding data indicated within the instruction.

Processing core 159 may be coupled with bus 141 for communicating with various other system devices, which may include but are not limited to, for example, synchronous dynamic random access memory (SDRAM) control 146, static random access memory (SRAM) control 147, burst flash memory interface 148, personal computer memory card international association (PCMCIA)/compact flash (CF) card control 149, liquid crystal display (LCD) control 150, direct memory access (DMA) controller 151, and alternative bus master interface 152. In one embodiment, data processing system 140 may also comprise an I/O bridge 154 for communicating with various I/O devices via an I/O bus 153. Such I/O devices may include but are not limited to, for example, universal asynchronous receiver/transmitter (UART) 155, universal serial bus (USB) 156, Bluetooth wireless UART 157 and I/O expansion interface 158.

One embodiment of data processing system 140 provides for mobile, network and/or wireless communications and a processing core 159 that may perform SIMD operations including a text string comparison operation. Processing core 159 may be programmed with various audio, video, imaging and communications algorithms including discrete transformations such as a Walsh-Hadamard transform, a fast Fourier transform (FFT), a discrete cosine transform (DCT), and their respective inverse transforms; compression/decompression techniques such as color space transformation, video encode motion estimation or video decode motion compensation; and modulation/demodulation (MODEM) functions such as pulse coded modulation (PCM).

FIG. 1C illustrates other embodiments of a data processing system that performs SIMD text string comparison operations. In one embodiment, data processing system 160 may include a main processor 166, a SIMD coprocessor 161, a cache memory 167, and an input/output system 168. Input/output system 168 may optionally be coupled to a wireless interface 169. SIMD coprocessor 161 may perform operations including instructions in accordance with one embodiment. In one embodiment, processing core 170 may be suitable for manufacture in one or more process technologies and by being represented on a machine-readable media in sufficient detail, may be suitable to facilitate the manufacture of all or part of data processing system 160 including processing core 170.

In one embodiment, SIMD coprocessor 161 comprises an execution unit 162 and a set of register files 164. One embodiment of main processor 166 comprises a decoder 165 to recognize instructions of instruction set 163 including instructions in accordance with one embodiment for execution by execution unit 162. In other embodiments, SIMD coprocessor 161 also comprises at least part of decoder 165 (shown as 165B) to decode instructions of instruction set 163. Processing core 170 may also include additional circuitry (not shown) which may be unnecessary to the understanding of embodiments of the present disclosure.

In operation, main processor 166 executes a stream of data processing instructions that control data processing operations of a general type including interactions with cache memory 167, and input/output system 168. Embedded within the stream of data processing instructions may be SIMD coprocessor instructions. Decoder 165 of main processor 166 recognizes these SIMD coprocessor instructions as being of a type that should be executed by an attached SIMD coprocessor 161. Accordingly, main processor 166 issues these SIMD coprocessor instructions (or control signals representing SIMD coprocessor instructions) on the coprocessor bus 171. From coprocessor bus 171, these instructions may be received by any attached SIMD coprocessors. In this case, SIMD coprocessor 161 may accept and execute any received SIMD coprocessor instructions intended for it.

Data may be received via wireless interface 169 for processing by the SIMD coprocessor instructions. For one example, voice communication may be received in the form of a digital signal, which may be processed by the SIMD coprocessor instructions to regenerate digital audio samples representative of the voice communications. For another example, compressed audio and/or video may be received in the form of a digital bit stream, which may be processed by the SIMD coprocessor instructions to regenerate digital audio samples and/or motion video frames. In one embodiment of processing core 170, main processor 166, and a SIMD coprocessor 161 may be integrated into a single processing core 170 comprising an execution unit 162, a set of register files 164, and a decoder 165 to recognize instructions of instruction set 163 including instructions in accordance with one embodiment.

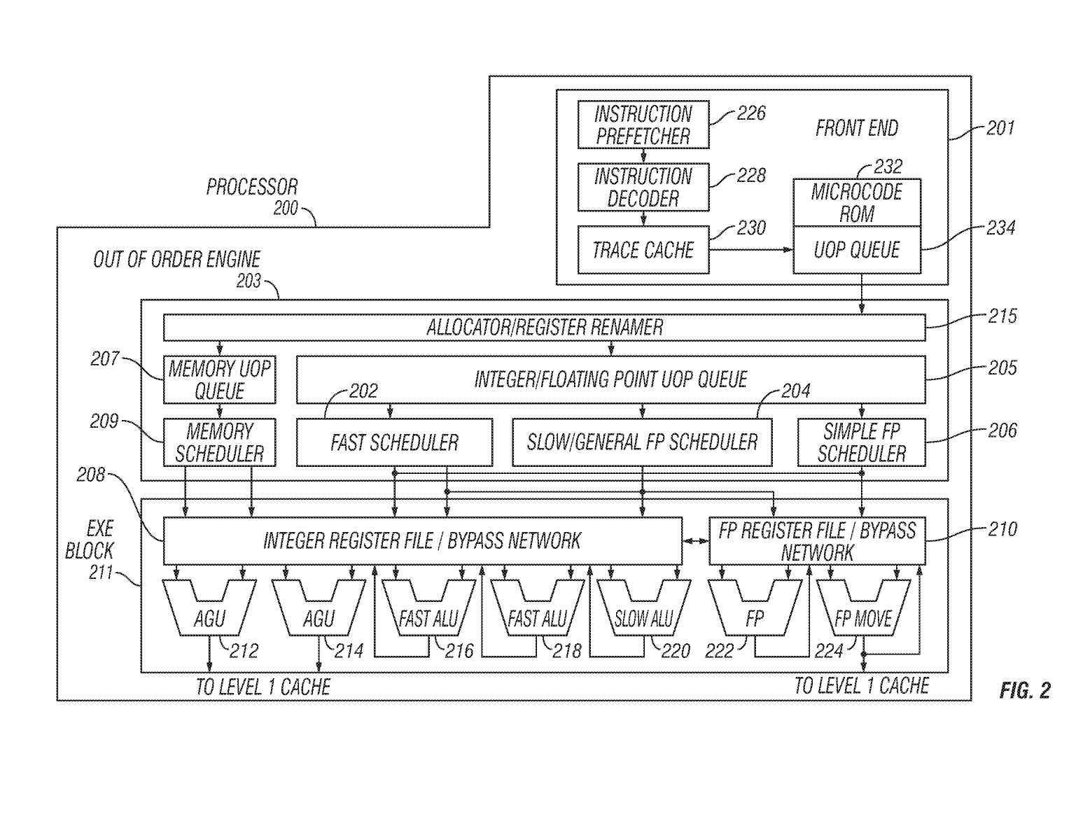

FIG. 2 is a block diagram of the micro-architecture for a processor 200 that may include logic circuits to perform instructions, in accordance with embodiments of the present disclosure. In some embodiments, an instruction in accordance with one embodiment may be implemented to operate on data elements having sizes of byte, word, doubleword, quadword, etc., as well as datatypes, such as single and double precision integer and floating point datatypes. In one embodiment, in-order front end 201 may implement a part of processor 200 that may fetch instructions to be executed and prepares the instructions to be used later in the processor pipeline. Front end 201 may include several units. In one embodiment, instruction prefetcher 226 fetches instructions from memory and feeds the instructions to an instruction decoder 228 which in turn decodes or interprets the instructions. For example, in one embodiment, the decoder decodes a received instruction into one or more operations called “micro-instructions” or “micro-operations” (also called micro op or uops) that the machine may execute. In other embodiments, the decoder parses the instruction into an opcode and corresponding data and control fields that may be used by the micro-architecture to perform operations in accordance with one embodiment. In one embodiment, trace cache 230 may assemble decoded uops into program ordered sequences or traces in uop queue 234 for execution. When trace cache 230 encounters a complex instruction, microcode ROM 232 provides the uops needed to complete the operation.

Some instructions may be converted into a single micro-op, whereas others need several micro-ops to complete the full operation. In one embodiment, if more than four micro-ops are needed to complete an instruction, decoder 228 may access microcode ROM 232 to perform the instruction. In one embodiment, an instruction may be decoded into a small number of micro ops for processing at instruction decoder 228. In another embodiment, an instruction may be stored within microcode ROM 232 should a number of micro-ops be needed to accomplish the operation. Trace cache 230 refers to an entry point programmable logic array (PLA) to determine a correct micro-instruction pointer for reading the micro-code sequences to complete one or more instructions in accordance with one embodiment from micro-code ROM 232. After microcode ROM 232 finishes sequencing micro-ops for an instruction, front end 201 of the machine may resume fetching micro-ops from trace cache 230.

Out-of-order execution engine 203 may prepare instructions for execution. The out-of-order execution logic has a number of buffers to smooth out and re-order the flow of instructions to optimize performance as they go down the pipeline and get scheduled for execution. The allocator logic in allocator/register renamer 215 allocates the machine buffers and resources that each uop needs in order to execute. The register renaming logic in allocator/register renamer 215 renames logic registers onto entries in a register file. The allocator 215 also allocates an entry for each uop in one of the two uop queues, one for memory operations (memory uop queue 207) and one for non-memory operations (integer/floating point uop queue 205), in front of the instruction schedulers: memory scheduler 209, fast scheduler 202, slow/general floating point scheduler 204, and simple floating point scheduler 206. Uop schedulers 202, 204, 206, determine when a uop is ready to execute based on the readiness of their dependent input register operand sources and the availability of the execution resources the uops need to complete their operation. Fast scheduler 202 of one embodiment may schedule on each half of the main clock cycle while the other schedulers may only schedule once per main processor clock cycle. The schedulers arbitrate for the dispatch ports to schedule uops for execution.

Register files 208, 210 may be arranged between schedulers 202, 204, 206, and execution units 212, 214, 216, 218, 220, 222, 224 in execution block 211. Each of register files 208, 210 perform integer and floating point operations, respectively. Each register file 208, 210, may include a bypass network that may bypass or forward just completed results that have not yet been written into the register file to new dependent uops. Integer register file 208 and floating point register file 210 may communicate data with the other. In one embodiment, integer register file 208 may be split into two separate register files, one register file for low-order thirty-two bits of data and a second register file for high order thirty-two bits of data. Floating point register file 210 may include 128-bit wide entries because floating point instructions typically have operands from 64 to 128 bits in width.

Execution block 211 may contain execution units 212, 214, 216, 218, 220, 222, 224. Execution units 212, 214, 216, 218, 220, 222, 224 may execute the instructions. Execution block 211 may include register files 208, 210 that store the integer and floating point data operand values that the micro-instructions need to execute. In one embodiment, processor 200 may comprise a number of execution units: address generation unit (AGU) 212, AGU 214, fast ALU 216, fast ALU 218, slow ALU 220, floating point ALU 222, floating point move unit 224. In another embodiment, floating point execution blocks 222, 224, may execute floating point, MMX, SIMD, and SSE, or other operations. In yet another embodiment, floating point ALU 222 may include a 64-bit by 64-bit floating point divider to execute divide, square root, and remainder micro-ops. In various embodiments, instructions involving a floating point value may be handled with the floating point hardware. In one embodiment, ALU operations may be passed to high-speed ALU execution units 216, 218. High-speed ALUs 216, 218 may execute fast operations with an effective latency of half a clock cycle. In one embodiment, most complex integer operations go to slow ALU 220 as slow ALU 220 may include integer execution hardware for long-latency type of operations, such as a multiplier, shifts, flag logic, and branch processing. Memory load/store operations may be executed by AGUs 212, 214. In one embodiment, integer ALUs 216, 218, 220 may perform integer operations on 64-bit data operands. In other embodiments, ALUs 216, 218, 220 may be implemented to support a variety of data bit sizes including sixteen, thirty-two, 128, 256, etc. Similarly, floating point units 222, 224 may be implemented to support a range of operands having bits of various widths. In one embodiment, floating point units 222, 224, may operate on 128-bit wide packed data operands in conjunction with SIMD and multimedia instructions.

In one embodiment, uops schedulers 202, 204, 206, dispatch dependent operations before the parent load has finished executing. As uops may be speculatively scheduled and executed in processor 200, processor 200 may also include logic to handle memory misses. If a data load misses in the data cache, there may be dependent operations in flight in the pipeline that have left the scheduler with temporarily incorrect data. A replay mechanism tracks and re-executes instructions that use incorrect data. Only the dependent operations might need to be replayed and the independent ones may be allowed to complete. The schedulers and replay mechanism of one embodiment of a processor may also be designed to catch instruction sequences for text string comparison operations.

The term “registers” may refer to the on-board processor storage locations that may be used as part of instructions to identify operands. In other words, registers may be those that may be usable from the outside of the processor (from a programmer's perspective). However, in some embodiments registers might not be limited to a particular type of circuit. Rather, a register may store data, provide data, and perform the functions described herein. The registers described herein may be implemented by circuitry within a processor using any number of different techniques, such as dedicated physical registers, dynamically allocated physical registers using register renaming, combinations of dedicated and dynamically allocated physical registers, etc. In one embodiment, integer registers store 32-bit integer data. A register file of one embodiment also contains eight multimedia SIMD registers for packed data. For the discussions below, the registers may be understood to be data registers designed to hold packed data, such as 64-bit wide MMX™ registers (also referred to as ‘mm’ registers in some instances) in microprocessors enabled with MMX technology from Intel Corporation of Santa Clara, Calif. These MMX registers, available in both integer and floating point forms, may operate with packed data elements that accompany SIMD and SSE instructions. Similarly, 128-bit wide XMM registers relating to SSE2, SSE3, SSE4, or beyond (referred to generically as “SSEx”) technology may hold such packed data operands. In one embodiment, in storing packed data and integer data, the registers do not need to differentiate between the two data types. In one embodiment, integer and floating point data may be contained in the same register file or different register files. Furthermore, in one embodiment, floating point and integer data may be stored in different registers or the same registers.

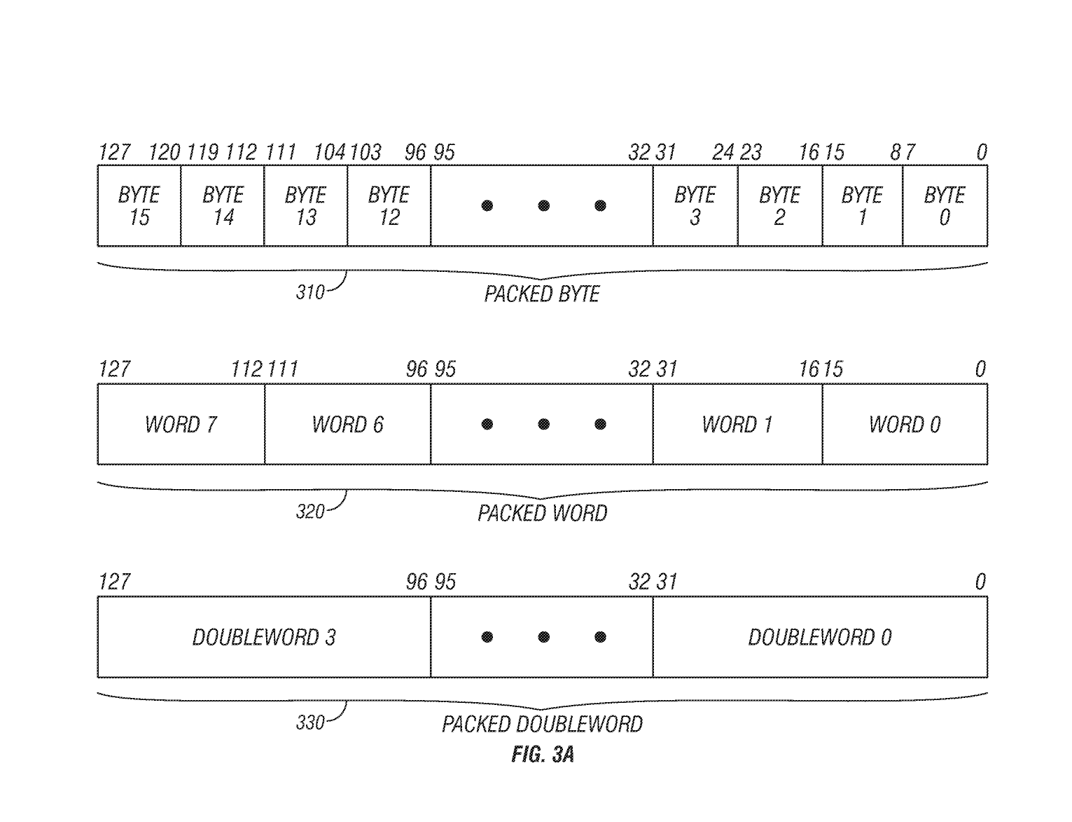

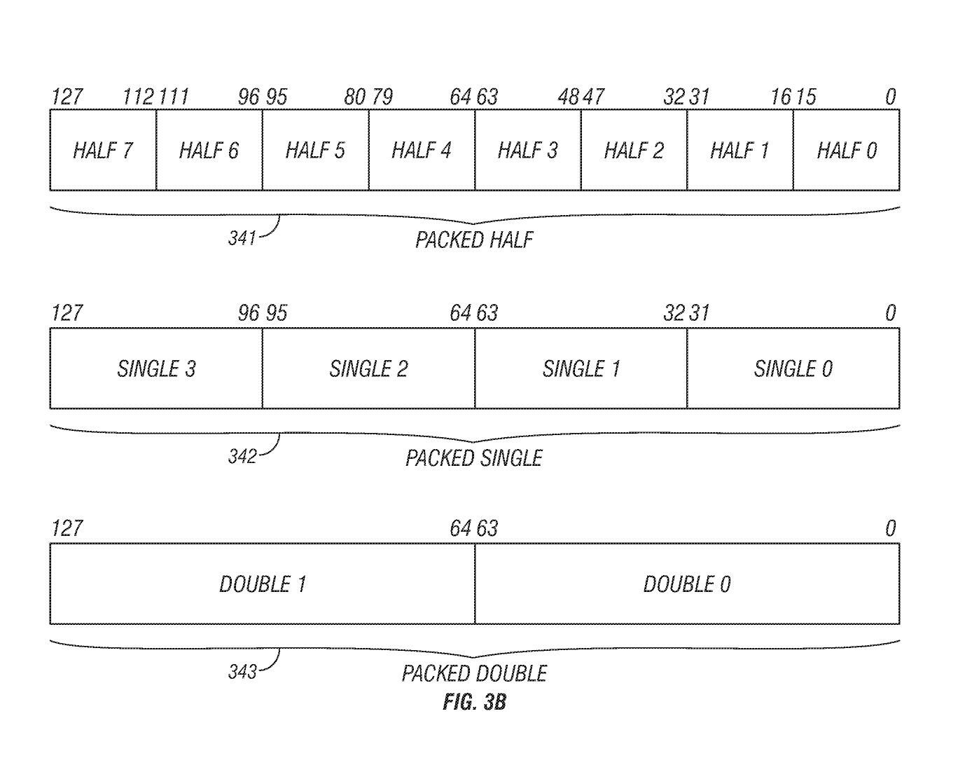

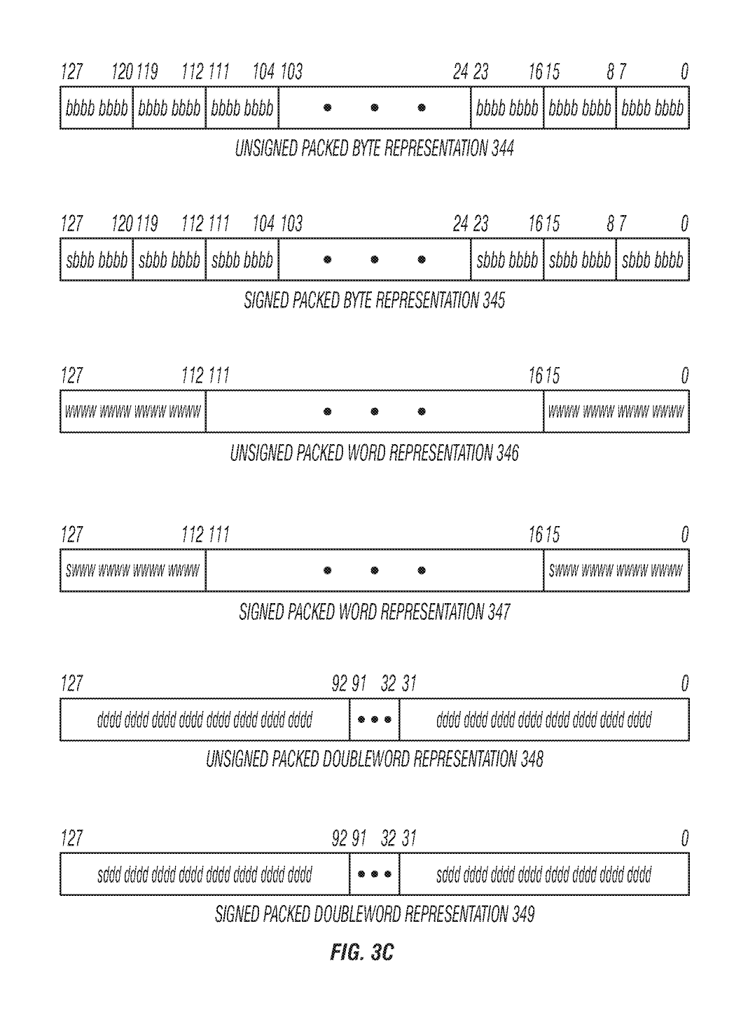

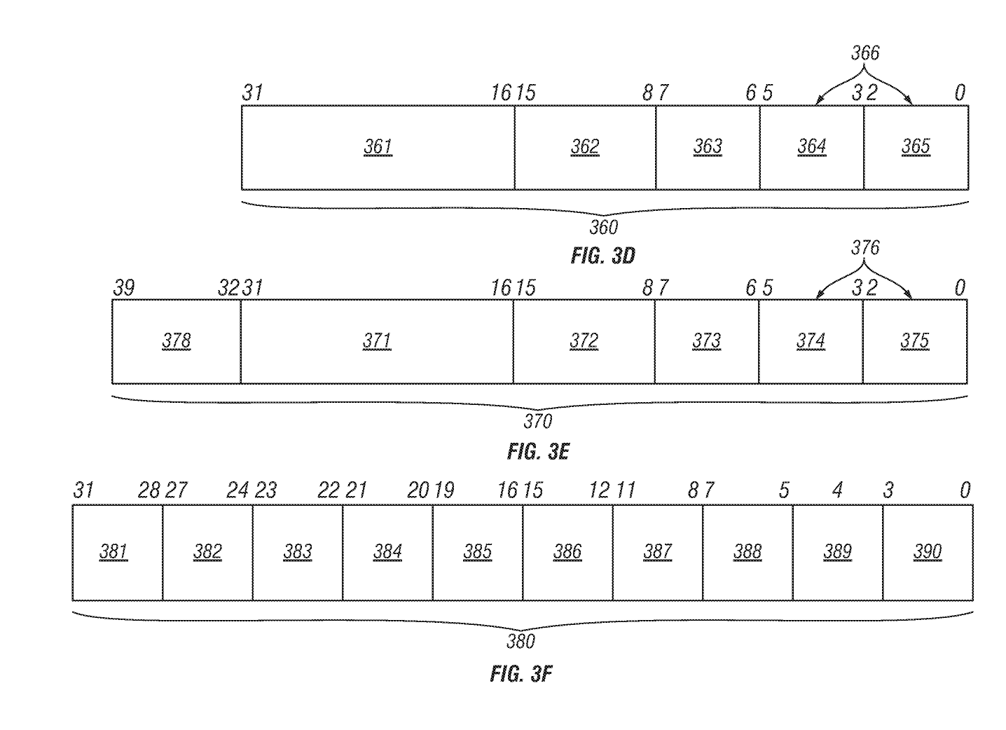

In the examples of the following figures, a number of data operands may be described. FIG. 3A illustrates various packed data type representations in multimedia registers, in accordance with embodiments of the present disclosure. FIG. 3A illustrates data types for a packed byte 310, a packed word 320, and a packed doubleword (dword) 330 for 128-bit wide operands. Packed byte format 310 of this example may be 128 bits long and contains sixteen packed byte data elements. A byte may be defined, for example, as eight bits of data. Information for each byte data element may be stored in bit 7 through bit 0 for byte 0, bit 15 through bit 8 for byte 1, bit 23 through bit 16 for byte 2, and finally bit 120 through bit 127 for byte 15. Thus, all available bits may be used in the register. This storage arrangement increases the storage efficiency of the processor. As well, with sixteen data elements accessed, one operation may now be performed on sixteen data elements in parallel.

Generally, a data element may include an individual piece of data that is stored in a single register or memory location with other data elements of the same length. In packed data sequences relating to SSEx technology, the number of data elements stored in a XMM register may be 128 bits divided by the length in bits of an individual data element. Similarly, in packed data sequences relating to MMX and SSE technology, the number of data elements stored in an MMX register may be 64 bits divided by the length in bits of an individual data element. Although the data types illustrated in FIG. 3A may be 128 bits long, embodiments of the present disclosure may also operate with 64-bit wide or other sized operands. Packed word format 320 of this example may be 128 bits long and contains eight packed word data elements. Each packed word contains sixteen bits of information. Packed doubleword format 330 of FIG. 3A may be 128 bits long and contains four packed doubleword data elements. Each packed doubleword data element contains thirty-two bits of information. A packed quadword may be 128 bits long and contain two packed quad-word data elements.

FIG. 3B illustrates possible in-register data storage formats, in accordance with embodiments of the present disclosure. Each packed data may include more than one independent data element. Three packed data formats are illustrated; packed half 341, packed single 342, and packed double 343. One embodiment of packed half 341, packed single 342, and packed double 343 contain fixed-point data elements. For another embodiment one or more of packed half 341, packed single 342, and packed double 343 may contain floating-point data elements. One embodiment of packed half 341 may be 128 bits long containing eight 16-bit data elements. One embodiment of packed single 342 may be 128 bits long and contains four 32-bit data elements. One embodiment of packed double 343 may be 128 bits long and contains two 64-bit data elements. It will be appreciated that such packed data formats may be further extended to other register lengths, for example, to 96-bits, 160-bits, 192-bits, 224-bits, 256-bits or more.

FIG. 3C illustrates various signed and unsigned packed data type representations in multimedia registers, in accordance with embodiments of the present disclosure. Unsigned packed byte representation 344 illustrates the storage of an unsigned packed byte in a SIMD register. Information for each byte data element may be stored in bit 7 through bit 0 for byte 0, bit 15 through bit 8 for byte 1, bit 23 through bit 16 for byte 2, and finally bit 120 through bit 127 for byte 15. Thus, all available bits may be used in the register. This storage arrangement may increase the storage efficiency of the processor. As well, with sixteen data elements accessed, one operation may now be performed on sixteen data elements in a parallel fashion. Signed packed byte representation 345 illustrates the storage of a signed packed byte. Note that the eighth bit of every byte data element may be the sign indicator. Unsigned packed word representation 346 illustrates how word seven through word zero may be stored in a SIMD register. Signed packed word representation 347 may be similar to the unsigned packed word in-register representation 346. Note that the sixteenth bit of each word data element may be the sign indicator. Unsigned packed doubleword representation 348 shows how doubleword data elements are stored. Signed packed doubleword representation 349 may be similar to unsigned packed doubleword in-register representation 348. Note that the necessary sign bit may be the thirty-second bit of each doubleword data element.

FIG. 3D illustrates an embodiment of an operation encoding (opcode). Furthermore, format 360 may include register/memory operand addressing modes corresponding with a type of opcode format described in the “IA-32 Intel Architecture Software Developer's Manual Volume 2: Instruction Set Reference,” which is available from Intel Corporation, Santa Clara, Calif. on the world-wide-web (www) at intel.com/design/litcentr. In one embodiment, an instruction may be encoded by one or more of fields 361 and 362. Up to two operand locations per instruction may be identified, including up to two source operand identifiers 364 and 365. In one embodiment, destination operand identifier 366 may be the same as source operand identifier 364, whereas in other embodiments they may be different. In another embodiment, destination operand identifier 366 may be the same as source operand identifier 365, whereas in other embodiments they may be different. In one embodiment, one of the source operands identified by source operand identifiers 364 and 365 may be overwritten by the results of the text string comparison operations, whereas in other embodiments identifier 364 corresponds to a source register element and identifier 365 corresponds to a destination register element. In one embodiment, operand identifiers 364 and 365 may identify 32-bit or 64-bit source and destination operands.

FIG. 3E illustrates another possible operation encoding (opcode) format 370, having forty or more bits, in accordance with embodiments of the present disclosure. Opcode format 370 corresponds with opcode format 360 and comprises an optional prefix byte 378. An instruction according to one embodiment may be encoded by one or more of fields 378, 371, and 372. Up to two operand locations per instruction may be identified by source operand identifiers 374 and 375 and by prefix byte 378. In one embodiment, prefix byte 378 may be used to identify 32-bit or 64-bit source and destination operands. In one embodiment, destination operand identifier 376 may be the same as source operand identifier 374, whereas in other embodiments they may be different. For another embodiment, destination operand identifier 376 may be the same as source operand identifier 375, whereas in other embodiments they may be different. In one embodiment, an instruction operates on one or more of the operands identified by operand identifiers 374 and 375 and one or more operands identified by operand identifiers 374 and 375 may be overwritten by the results of the instruction, whereas in other embodiments, operands identified by identifiers 374 and 375 may be written to another data element in another register. Opcode formats 360 and 370 allow register to register, memory to register, register by memory, register by register, register by immediate, register to memory addressing specified in part by MOD fields 363 and 373 and by optional scale-index-base and displacement bytes.

FIG. 3F illustrates yet another possible operation encoding (opcode) format, in accordance with embodiments of the present disclosure. 64-bit single instruction multiple data (SIMD) arithmetic operations may be performed through a coprocessor data processing (CDP) instruction. Operation encoding (opcode) format 380 depicts one such CDP instruction having CDP opcode fields 382 and 389. The type of CDP instruction, for another embodiment, operations may be encoded by one or more of fields 383, 384, 387, and 388. Up to three operand locations per instruction may be identified, including up to two source operand identifiers 385 and 390 and one destination operand identifier 386. One embodiment of the coprocessor may operate on eight, sixteen, thirty-two, and 64-bit values. In one embodiment, an instruction may be performed on integer data elements. In some embodiments, an instruction may be executed conditionally, using condition field 381. For some embodiments, source data sizes may be encoded by field 383. In some embodiments, Zero (Z), negative (N), carry (C), and overflow (V) detection may be done on SIMD fields. For some instructions, the type of saturation may be encoded by field 384.

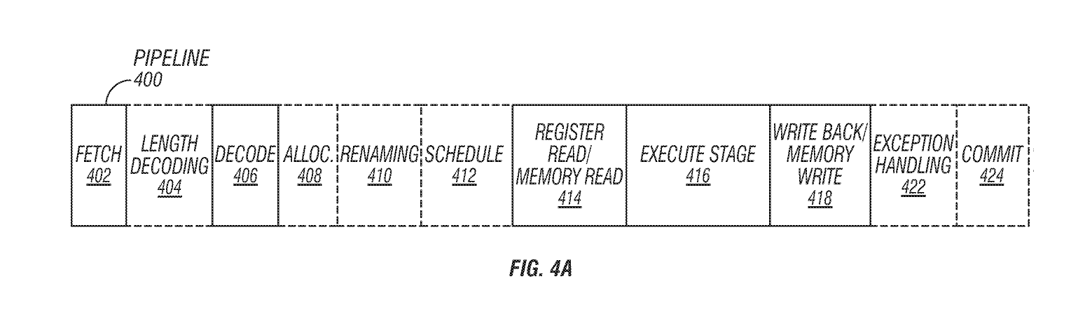

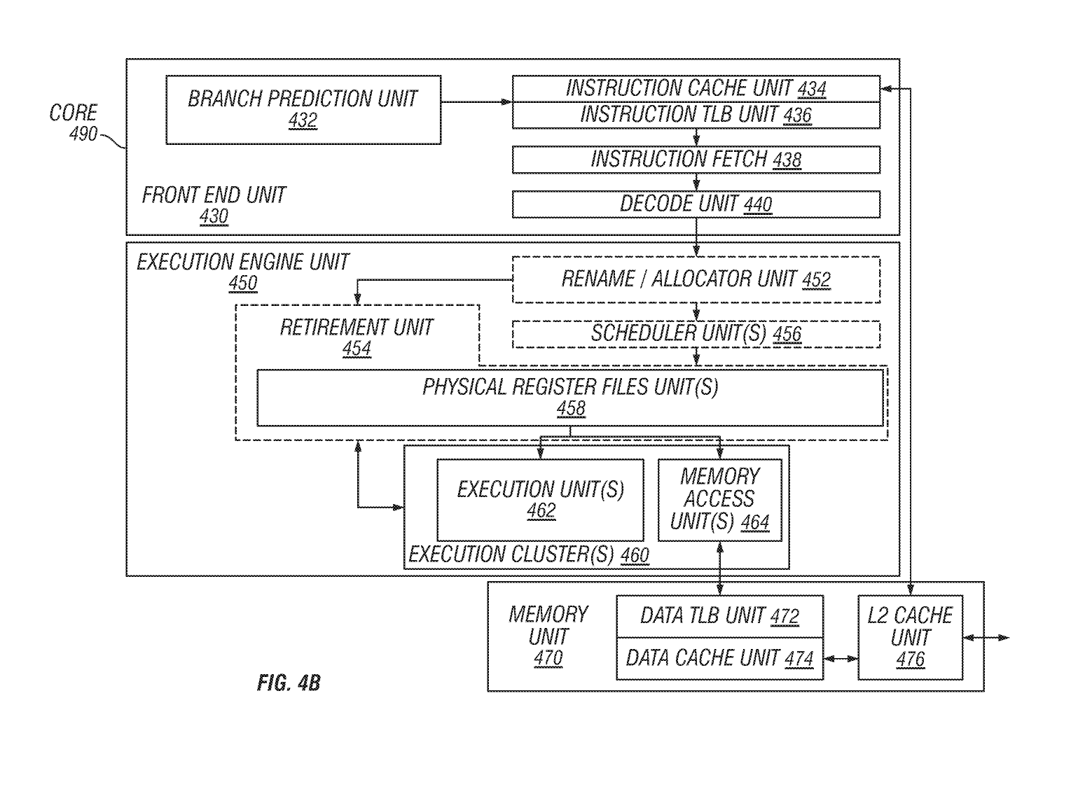

FIG. 4A is a block diagram illustrating an in-order pipeline and a register renaming stage, out-of-order issue/execution pipeline, in accordance with embodiments of the present disclosure. FIG. 4B is a block diagram illustrating an in-order architecture core and a register renaming logic, out-of-order issue/execution logic to be included in a processor, in accordance with embodiments of the present disclosure. The solid lined boxes in FIG. 4A illustrate the in-order pipeline, while the dashed lined boxes illustrates the register renaming, out-of-order issue/execution pipeline. Similarly, the solid lined boxes in FIG. 4B illustrate the in-order architecture logic, while the dashed lined boxes illustrates the register renaming logic and out-of-order issue/execution logic.

In FIG. 4A, a processor pipeline 400 may include a fetch stage 402, a length decode stage 404, a decode stage 406, an allocation stage 408, a renaming stage 410, a scheduling (also known as a dispatch or issue) stage 412, a register read/memory read stage 414, an execute stage 416, a write-back/memory-write stage 418, an exception handling stage 422, and a commit stage 424.

In FIG. 4B, arrows denote a coupling between two or more units and the direction of the arrow indicates a direction of data flow between those units. FIG. 4B shows processor core 490 including a front end unit 430 coupled to an execution engine unit 450, and both may be coupled to a memory unit 470.

Core 490 may be a reduced instruction set computing (RISC) core, a complex instruction set computing (CISC) core, a very long instruction word (VLIW) core, or a hybrid or alternative core type. In one embodiment, core 490 may be a special-purpose core, such as, for example, a network or communication core, compression engine, graphics core, or the like.

Front end unit 430 may include a branch prediction unit 432 coupled to an instruction cache unit 434. Instruction cache unit 434 may be coupled to an instruction translation lookaside buffer (TLB) 436. TLB 436 may be coupled to an instruction fetch unit 438, which is coupled to a decode unit 440. Decode unit 440 may decode instructions, and generate as an output one or more micro-operations, micro-code entry points, microinstructions, other instructions, or other control signals, which may be decoded from, or which otherwise reflect, or may be derived from, the original instructions. The decoder may be implemented using various different mechanisms. Examples of suitable mechanisms include, but are not limited to, look-up tables, hardware implementations, programmable logic arrays (PLAs), microcode read-only memories (ROMs), etc. In one embodiment, instruction cache unit 434 may be further coupled to a level 2 (L2) cache unit 476 in memory unit 470. Decode unit 440 may be coupled to a rename/allocator unit 452 in execution engine unit 450.

Execution engine unit 450 may include rename/allocator unit 452 coupled to a retirement unit 454 and a set of one or more scheduler units 456. Scheduler units 456 represent any number of different schedulers, including reservations stations, central instruction window, etc. Scheduler units 456 may be coupled to physical register file units 458. Each of physical register file units 458 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. Physical register file units 458 may be overlapped by retirement unit 454 to illustrate various ways in which register renaming and out-of-order execution may be implemented (e.g., using one or more reorder buffers and one or more retirement register files, using one or more future files, one or more history buffers, and one or more retirement register files; using register maps and a pool of registers; etc.). Generally, the architectural registers may be visible from the outside of the processor or from a programmer's perspective. The registers might not be limited to any known particular type of circuit. Various different types of registers may be suitable as long as they store and provide data as described herein. Examples of suitable registers include, but might not be limited to, dedicated physical registers, dynamically allocated physical registers using register renaming, combinations of dedicated and dynamically allocated physical registers, etc. Retirement unit 454 and physical register file units 458 may be coupled to execution clusters 460. Execution clusters 460 may include a set of one or more execution units 462 and a set of one or more memory access units 464. Execution units 462 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. Scheduler units 456, physical register file units 458, and execution clusters 460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file unit, and/or execution cluster—and in the case of a separate memory access pipeline, certain embodiments may be implemented in which only the execution cluster of this pipeline has memory access units 464). It should also be understood that where separate pipelines are used, one or more of these pipelines may be out-of-order issue/execution and the rest in-order.

The set of memory access units 464 may be coupled to memory unit 470, which may include a data TLB unit 472 coupled to a data cache unit 474 coupled to a level 2 (L2) cache unit 476. In one exemplary embodiment, memory access units 464 may include a load unit, a store address unit, and a store data unit, each of which may be coupled to data TLB unit 472 in memory unit 470. L2 cache unit 476 may be coupled to one or more other levels of cache and eventually to a main memory.

By way of example, the exemplary register renaming, out-of-order issue/execution core architecture may implement pipeline 400 as follows: 1) instruction fetch 438 may perform fetch and length decoding stages 402 and 404; 2) decode unit 440 may perform decode stage 406; 3) rename/allocator unit 452 may perform allocation stage 408 and renaming stage 410; 4) scheduler units 456 may perform schedule stage 412; 5) physical register file units 458 and memory unit 470 may perform register read/memory read stage 414; execution cluster 460 may perform execute stage 416; 6) memory unit 470 and physical register file units 458 may perform write-back/memory-write stage 418; 7) various units may be involved in the performance of exception handling stage 422; and 8) retirement unit 454 and physical register file units 458 may perform commit stage 424.

Core 490 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads) in a variety of manners. Multithreading support may be performed by, for example, including time sliced multithreading, simultaneous multithreading (where a single physical core provides a logical core for each of the threads that physical core is simultaneously multithreading), or a combination thereof. Such a combination may include, for example, time sliced fetching and decoding and simultaneous multithreading thereafter such as in the Intel® Hyperthreading technology.

While register renaming may be described in the context of out-of-order execution, it should be understood that register renaming may be used in an in-order architecture. While the illustrated embodiment of the processor may also include a separate instruction and data cache units 434/474 and a shared L2 cache unit 476, other embodiments may have a single internal cache for both instructions and data, such as, for example, a Level 1 (L1) internal cache, or multiple levels of internal cache. In some embodiments, the system may include a combination of an internal cache and an external cache that may be external to the core and/or the processor. In other embodiments, all of the caches may be external to the core and/or the processor.

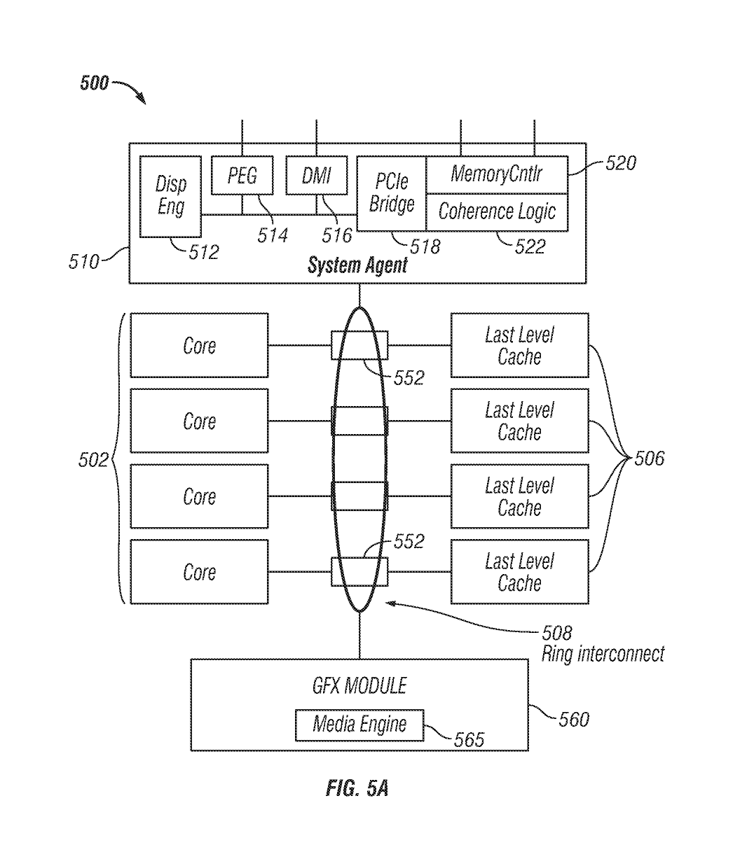

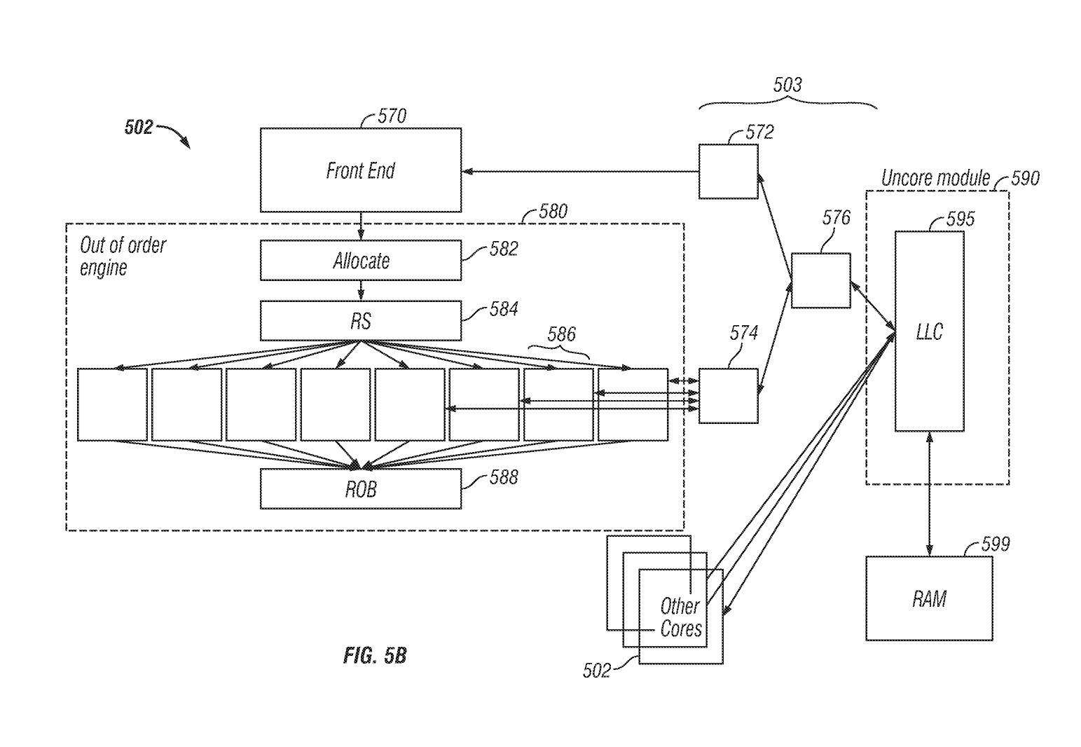

FIG. 5A is a block diagram of a processor 500, in accordance with embodiments of the present disclosure. In one embodiment, processor 500 may include a multicore processor. Processor 500 may include a system agent 510 communicatively coupled to one or more cores 502. Furthermore, cores 502 and system agent 510 may be communicatively coupled to one or more caches 506. Cores 502, system agent 510, and caches 506 may be communicatively coupled via one or more memory control units 552. Furthermore, cores 502, system agent 510, and caches 506 may be communicatively coupled to a graphics module 560 via memory control units 552.

Processor 500 may include any suitable mechanism for interconnecting cores 502, system agent 510, and caches 506, and graphics module 560. In one embodiment, processor 500 may include a ring-based interconnect unit 508 to interconnect cores 502, system agent 510, and caches 506, and graphics module 560. In other embodiments, processor 500 may include any number of well-known techniques for interconnecting such units. Ring-based interconnect unit 508 may utilize memory control units 552 to facilitate interconnections.

Processor 500 may include a memory hierarchy comprising one or more levels of caches within the cores, one or more shared cache units such as caches 506, or external memory (not shown) coupled to the set of integrated memory controller units 552. Caches 506 may include any suitable cache. In one embodiment, caches 506 may include one or more mid-level caches, such as level 2 (L2), level 3 (L3), level 4 (L4), or other levels of cache, a last level cache (LLC), and/or combinations thereof.

In various embodiments, one or more of cores 502 may perform multi-threading. System agent 510 may include components for coordinating and operating cores 502. System agent unit 510 may include for example a power control unit (PCU). The PCU may be or include logic and components needed for regulating the power state of cores 502. System agent 510 may include a display engine 512 for driving one or more externally connected displays or graphics module 560. System agent 510 may include an interface 514 for communications busses for graphics. In one embodiment, interface 514 may be implemented by PCI Express (PCIe). In a further embodiment, interface 514 may be implemented by PCI Express Graphics (PEG). System agent 510 may include a direct media interface (DMI) 516. DMI 516 may provide links between different bridges on a motherboard or other portion of a computer system. System agent 510 may include a PCIe bridge 518 for providing PCIe links to other elements of a computing system. PCIe bridge 518 may be implemented using a memory controller 520 and coherence logic 522.

Cores 502 may be implemented in any suitable manner. Cores 502 may be homogenous or heterogeneous in terms of architecture and/or instruction set. In one embodiment, some of cores 502 may be in-order while others may be out-of-order. In another embodiment, two or more of cores 502 may execute the same instruction set, while others may execute only a subset of that instruction set or a different instruction set.

Processor 500 may include a general-purpose processor, such as a Core™ i3, i5, i7, 2 Duo and Quad, Xeon™, Itanium™, XScale™ or StrongARM™ processor, which may be available from Intel Corporation, of Santa Clara, Calif. Processor 500 may be provided from another company, such as ARM Holdings, Ltd, MIPS, etc. Processor 500 may be a special-purpose processor, such as, for example, a network or communication processor, compression engine, graphics processor, co-processor, embedded processor, or the like. Processor 500 may be implemented on one or more chips. Processor 500 may be a part of and/or may be implemented on one or more substrates using any of a number of process technologies, such as, for example, BiCMOS, CMOS, or NMOS.

In one embodiment, a given one of caches 506 may be shared by multiple ones of cores 502. In another embodiment, a given one of caches 506 may be dedicated to one of cores 502. The assignment of caches 506 to cores 502 may be handled by a cache controller or other suitable mechanism. A given one of caches 506 may be shared by two or more cores 502 by implementing time-slices of a given cache 506.

Graphics module 560 may implement an integrated graphics processing subsystem. In one embodiment, graphics module 560 may include a graphics processor. Furthermore, graphics module 560 may include a media engine 565. Media engine 565 may provide media encoding and video decoding.

FIG. 5B is a block diagram of an example implementation of a core 502, in accordance with embodiments of the present disclosure. Core 502 may include a front end 570 communicatively coupled to an out-of-order engine 580. Core 502 may be communicatively coupled to other portions of processor 500 through cache hierarchy 503.

Front end 570 may be implemented in any suitable manner, such as fully or in part by front end 201 as described above. In one embodiment, front end 570 may communicate with other portions of processor 500 through cache hierarchy 503. In a further embodiment, front end 570 may fetch instructions from portions of processor 500 and prepare the instructions to be used later in the processor pipeline as they are passed to out-of-order execution engine 580.

Out-of-order execution engine 580 may be implemented in any suitable manner, such as fully or in part by out-of-order execution engine 203 as described above. Out-of-order execution engine 580 may prepare instructions received from front end 570 for execution. Out-of-order execution engine 580 may include an allocate module 582. In one embodiment, allocate module 582 may allocate resources of processor 500 or other resources, such as registers or buffers, to execute a given instruction. Allocate module 582 may make allocations in schedulers, such as a memory scheduler, fast scheduler, or floating point scheduler. Such schedulers may be represented in FIG. 5B by resource schedulers 584. Allocate module 582 may be implemented fully or in part by the allocation logic described in conjunction with FIG. 2. Resource schedulers 584 may determine when an instruction is ready to execute based on the readiness of a given resource's sources and the availability of execution resources needed to execute an instruction. Resource schedulers 584 may be implemented by, for example, schedulers 202, 204, 206 as discussed above. Resource schedulers 584 may schedule the execution of instructions upon one or more resources. In one embodiment, such resources may be internal to core 502, and may be illustrated, for example, as resources 586. In another embodiment, such resources may be external to core 502 and may be accessible by, for example, cache hierarchy 503. Resources may include, for example, memory, caches, register files, or registers. Resources internal to core 502 may be represented by resources 586 in FIG. 5B. As necessary, values written to or read from resources 586 may be coordinated with other portions of processor 500 through, for example, cache hierarchy 503. As instructions are assigned resources, they may be placed into a reorder buffer 588. Reorder buffer 588 may track instructions as they are executed and may selectively reorder their execution based upon any suitable criteria of processor 500. In one embodiment, reorder buffer 588 may identify instructions or a series of instructions that may be executed independently. Such instructions or a series of instructions may be executed in parallel from other such instructions. Parallel execution in core 502 may be performed by any suitable number of separate execution blocks or virtual processors. In one embodiment, shared resources-such as memory, registers, and caches—may be accessible to multiple virtual processors within a given core 502. In other embodiments, shared resources may be accessible to multiple processing entities within processor 500.

Cache hierarchy 503 may be implemented in any suitable manner. For example, cache hierarchy 503 may include one or more lower or mid-level caches, such as caches 572, 574. In one embodiment, cache hierarchy 503 may include an LLC 595 communicatively coupled to caches 572, 574. In another embodiment, LLC 595 may be implemented in a module 590 accessible to all processing entities of processor 500. In a further embodiment, module 590 may be implemented in an uncore module of processors from Intel, Inc. Module 590 may include portions or subsystems of processor 500 necessary for the execution of core 502 but might not be implemented within core 502. Besides LLC 595, Module 590 may include, for example, hardware interfaces, memory coherency coordinators, interprocessor interconnects, instruction pipelines, or memory controllers. Access to RAM 599 available to processor 500 may be made through module 590 and, more specifically, LLC 595. Furthermore, other instances of core 502 may similarly access module 590. Coordination of the instances of core 502 may be facilitated in part through module 590.

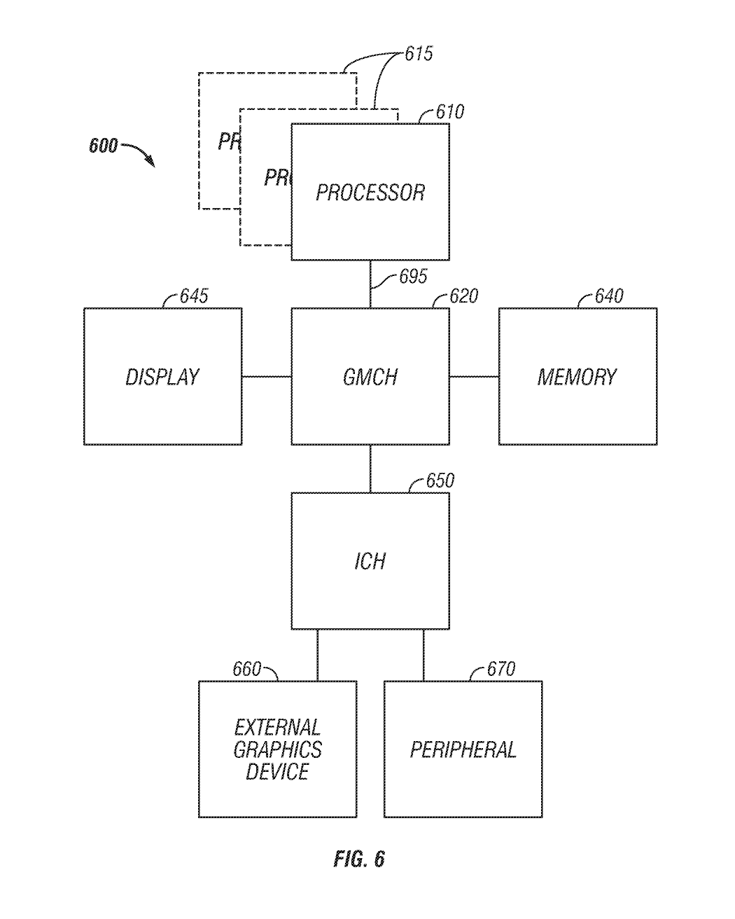

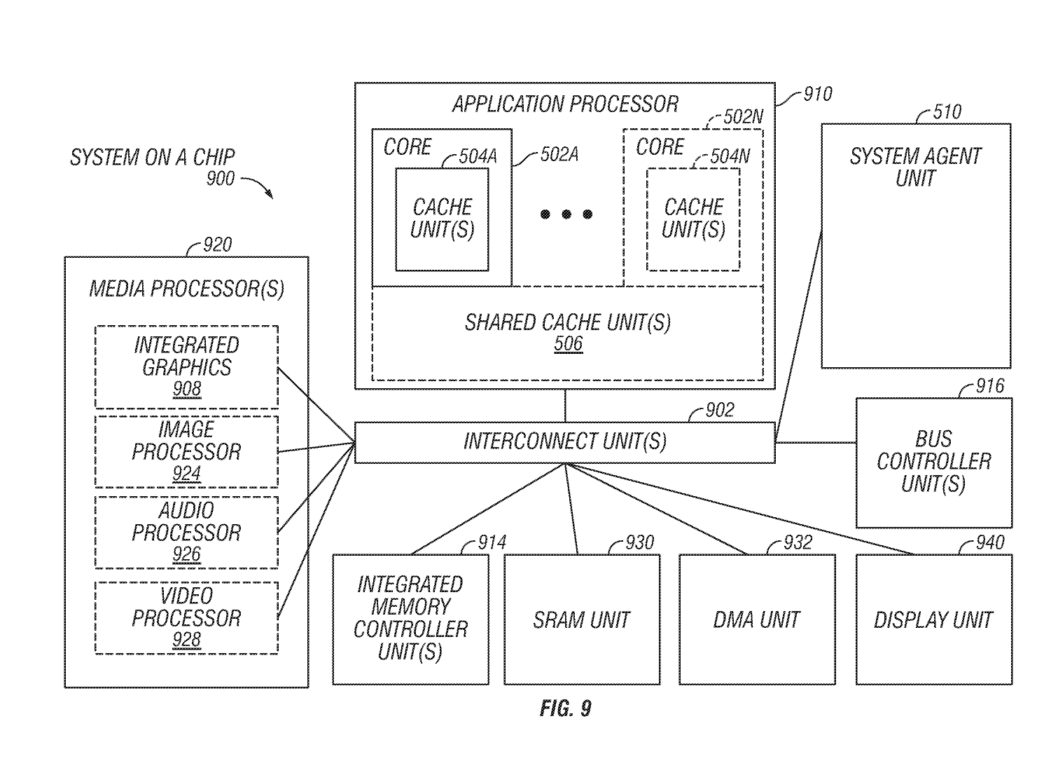

FIGS. 6-8 may illustrate exemplary systems suitable for including processor 500, while FIG. 9 may illustrate an exemplary system on a chip (SoC) that may include one or more of cores 502. Other system designs and implementations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, may also be suitable. In general, a huge variety of systems or electronic devices that incorporate a processor and/or other execution logic as disclosed herein may be generally suitable.

FIG. 6 illustrates a block diagram of a system 600, in accordance with embodiments of the present disclosure. System 600 may include one or more processors 610, 615, which may be coupled to graphics memory controller hub (GMCH) 620. The optional nature of additional processors 615 is denoted in FIG. 6 with broken lines.

Each processor 610,615 may be some version of processor 500. However, it should be noted that integrated graphics logic and integrated memory control units might not exist in processors 610,615. FIG. 6 illustrates that GMCH 620 may be coupled to a memory 640 that may be, for example, a dynamic random access memory (DRAM). The DRAM may, for at least one embodiment, be associated with a non-volatile cache.

GMCH 620 may be a chipset, or a portion of a chipset. GMCH 620 may communicate with processors 610, 615 and control interaction between processors 610, 615 and memory 640. GMCH 620 may also act as an accelerated bus interface between the processors 610, 615 and other elements of system 600. In one embodiment, GMCH 620 communicates with processors 610, 615 via a multi-drop bus, such as a frontside bus (FSB) 695.

Furthermore, GMCH 620 may be coupled to a display 645 (such as a flat panel display). In one embodiment, GMCH 620 may include an integrated graphics accelerator. GMCH 620 may be further coupled to an input/output (I/O) controller hub (ICH) 650, which may be used to couple various peripheral devices to system 600. External graphics device 660 may include a discrete graphics device coupled to ICH 650 along with another peripheral device 670.

In other embodiments, additional or different processors may also be present in system 600. For example, additional processors 610, 615 may include additional processors that may be the same as processor 610, additional processors that may be heterogeneous or asymmetric to processor 610, accelerators (such as, e.g., graphics accelerators or digital signal processing (DSP) units), field programmable gate arrays, or any other processor. There may be a variety of differences between the physical resources 610, 615 in terms of a spectrum of metrics of merit including architectural, micro-architectural, thermal, power consumption characteristics, and the like. These differences may effectively manifest themselves as asymmetry and heterogeneity amongst processors 610, 615. For at least one embodiment, various processors 610, 615 may reside in the same die package.

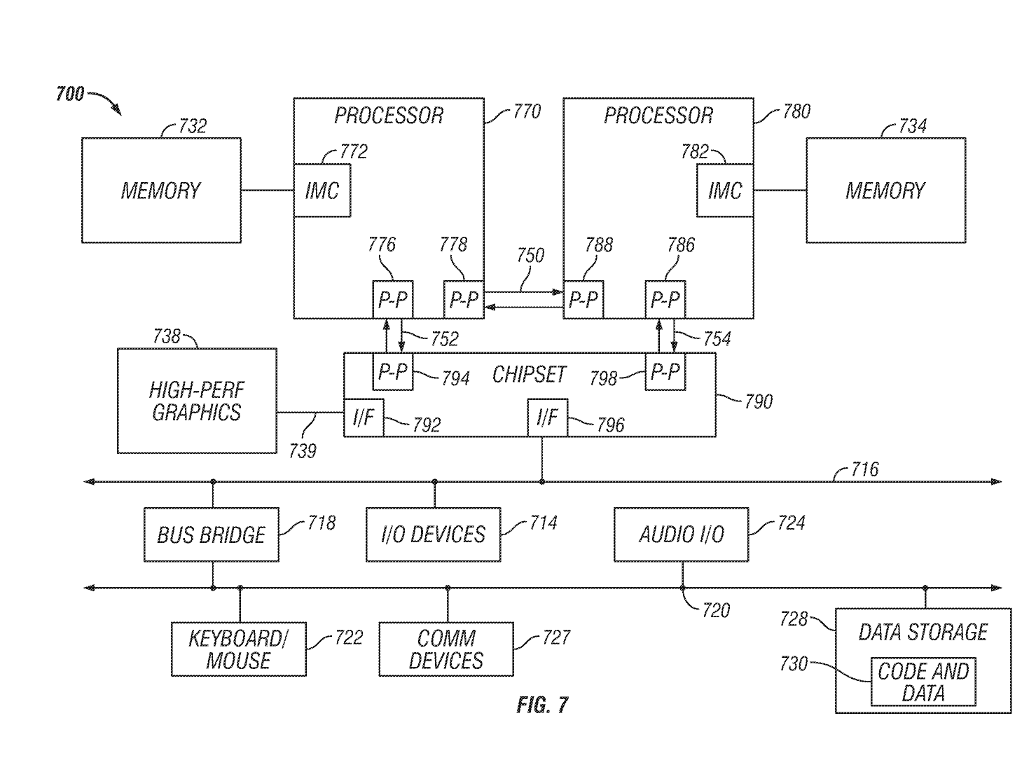

FIG. 7 illustrates a block diagram of a second system 700, in accordance with embodiments of the present disclosure. As shown in FIG. 7, multiprocessor system 700 may include a point-to-point interconnect system, and may include a first processor 770 and a second processor 780 coupled via a point-to-point interconnect 750. Each of processors 770 and 780 may be some version of processor 500 as one or more of processors 610,615.

While FIG. 7 may illustrate two processors 770, 780, it is to be understood that the scope of the present disclosure is not so limited. In other embodiments, one or more additional processors may be present in a given processor.

Processors 770 and 780 are shown including integrated memory controller units 772 and 782, respectively. Processor 770 may also include as part of its bus controller units point-to-point (P-P) interfaces 776 and 778; similarly, second processor 780 may include P-P interfaces 786 and 788. Processors 770, 780 may exchange information via a point-to-point (P-P) interface 750 using P-P interface circuits 778, 788. As shown in FIG. 7, IMCs 772 and 782 may couple the processors to respective memories, namely a memory 732 and a memory 734, which in one embodiment may be portions of main memory locally attached to the respective processors.

Processors 770, 780 may each exchange information with a chipset 790 via individual P-P interfaces 752, 754 using point to point interface circuits 776, 794, 786, 798. In one embodiment, chipset 790 may also exchange information with a high-performance graphics circuit 738 via a high-performance graphics interface 739.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present disclosure is not so limited.

As shown in FIG. 7, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one embodiment. Further, an audio 1/O 724 may be coupled to second bus 720. Note that other architectures may be possible. For example, instead of the point-to-point architecture of FIG. 7, a system may implement a multi-drop bus or other such architecture.

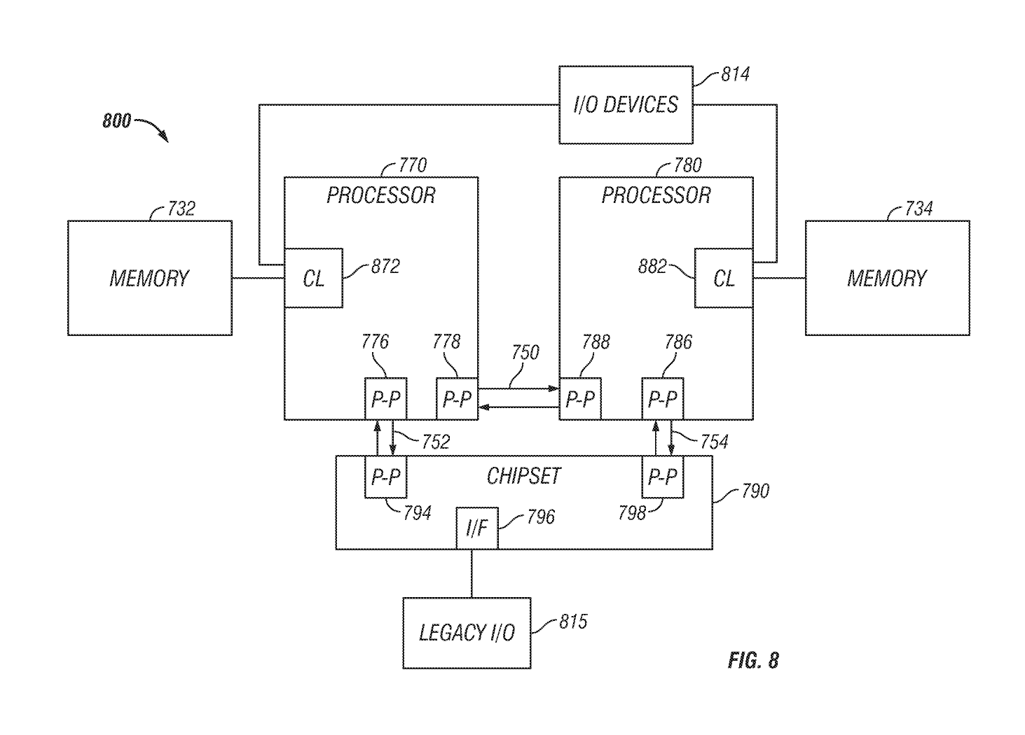

FIG. 8 illustrates a block diagram of a third system 800 in accordance with embodiments of the present disclosure. Like elements in FIGS. 7 and 8 bear like reference numerals, and certain aspects of FIG. 7 have been omitted from FIG. 8 in order to avoid obscuring other aspects of FIG. 8.

FIG. 8 illustrates that processors 770, 780 may include integrated memory and I/O control logic (“CL”) 872 and 882, respectively. For at least one embodiment, CL 872, 882 may include integrated memory controller units such as that described above in connection with FIGS. 5 and 7. In addition. CL 872, 882 may also include I/O control logic. FIG. 8 illustrates that not only memories 732, 734 may be coupled to CL 872, 882, but also that I/O devices 814 may also be coupled to control logic 872, 882. Legacy I/O devices 815 may be coupled to chipset 790.

FIG. 9 illustrates a block diagram of a SoC 900, in accordance with embodiments of the present disclosure. Similar elements in FIG. 5 bear like reference numerals. Also, dashed lined boxes may represent optional features on more advanced SoCs. An interconnect units 902 may be coupled to: an application processor 910 which may include a set of one or more cores 502A-N and shared cache units 506; a system agent unit 510; a bus controller units 916; an integrated memory controller units 914; a set of one or more media processors 920 which may include integrated graphics logic 908, an image processor 924 for providing still and/or video camera functionality, an audio processor 926 for providing hardware audio acceleration, and a video processor 928 for providing video encode/decode acceleration; an static random access memory (SRAM) unit 930; a direct memory access (DMA) unit 932; and a display unit 940 for coupling to one or more external displays.

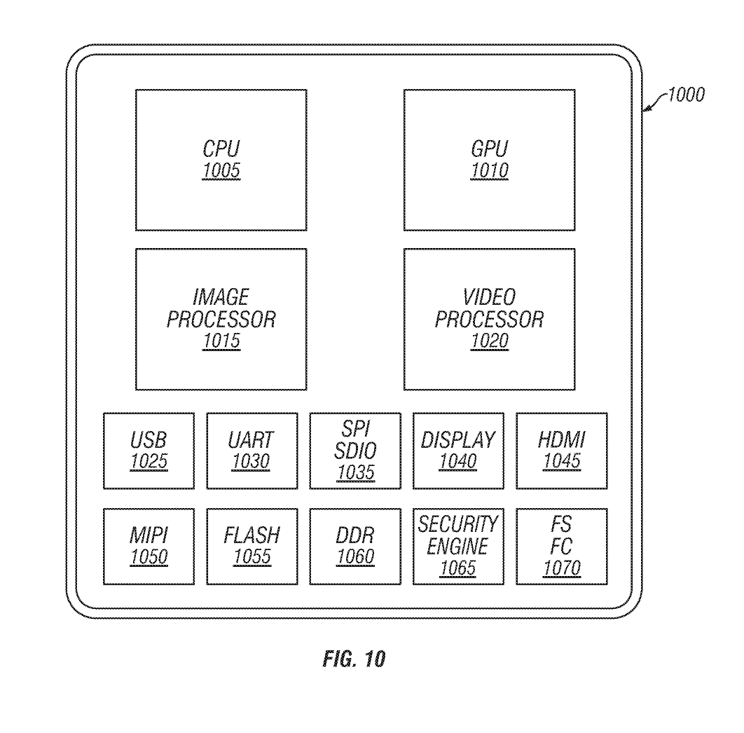

FIG. 10 illustrates a processor containing a central processing unit (CPU) and a graphics processing unit (GPU), which may perform at least one instruction, in accordance with embodiments of the present disclosure. In one embodiment, an instruction to perform operations according to at least one embodiment could be performed by the CPU. In another embodiment, the instruction could be performed by the GPU. In still another embodiment, the instruction may be performed through a combination of operations performed by the GPU and the CPU. For example, in one embodiment, an instruction in accordance with one embodiment may be received and decoded for execution on the GPU. However, one or more operations within the decoded instruction may be performed by a CPU and the result returned to the GPU for final retirement of the instruction. Conversely, in some embodiments, the CPU may act as the primary processor and the GPU as the co-processor.

In some embodiments, instructions that benefit from highly parallel, throughput processors may be performed by the GPU, while instructions that benefit from the performance of processors that benefit from deeply pipelined architectures may be performed by the CPU. For example, graphics, scientific applications, financial applications and other parallel workloads may benefit from the performance of the GPU and be executed accordingly, whereas more sequential applications, such as operating system kernel or application code may be better suited for the CPU.

In FIG. 10, processor 1000 includes a CPU 1005, GPU 1010, image processor 1015, video processor 1020, USB controller 1025, UART controller 1030, SPI/SDIO controller 1035, display device 1040, memory interface controller 1045, MIPI controller 1050, flash memory controller 1055, dual data rate (DDR) controller 1060, security engine 1065, and I²S/I²C controller 1070. Other logic and circuits may be included in the processor of FIG. 10, including more CPUs or GPUs and other peripheral interface controllers.

One or more aspects of at least one embodiment may be implemented by representative data stored on a machine-readable medium which represents various logic within the processor, which when read by a machine causes the machine to fabricate logic to perform the techniques described herein. Such representations, known as “IP cores” may be stored on a tangible, machine-readable medium (“tape”) and supplied to various customers or manufacturing facilities to load into the fabrication machines that actually make the logic or processor. For example, IP cores, such as the Cortex™ family of processors developed by ARM Holdings, Ltd. and Loongson IP cores developed the Institute of Computing Technology (ICT) of the Chinese Academy of Sciences may be licensed or sold to various customers or licensees, such as Texas Instruments, Qualcomm, Apple, or Samsung and implemented in processors produced by these customers or licensees.

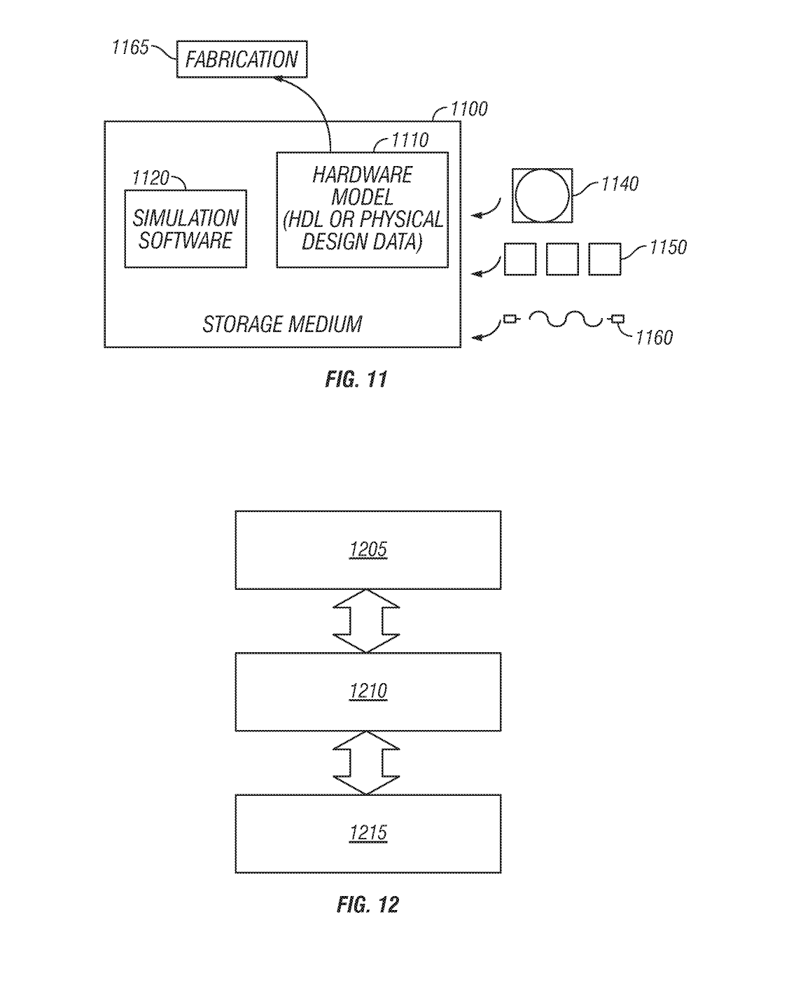

FIG. 11 illustrates a block diagram illustrating the development of IP cores, in accordance with embodiments of the present disclosure. Storage 1100 may include simulation software 1120 and/or hardware or software model 1110. In one embodiment, the data representing the IP core design may be provided to storage 1100 via memory 1140 (e.g., hard disk), wired connection (e.g., internet) 1150 or wireless connection 1160. The IP core information generated by the simulation tool and model may then be transmitted to a fabrication facility 1165 where it may be fabricated by a 3^{rd} party to perform at least one instruction in accordance with at least one embodiment.

In some embodiments, one or more instructions may correspond to a first type or architecture (e.g., x86) and be translated or emulated on a processor of a different type or architecture (e.g., ARM). An instruction, according to one embodiment, may therefore be performed on any processor or processor type, including ARM, x86, MIPS, a GPU, or other processor type or architecture.

FIG. 12 illustrates how an instruction of a first type may be emulated by a processor of a different type, in accordance with embodiments of the present disclosure. In FIG. 12, program 1205 contains some instructions that may perform the same or substantially the same function as an instruction according to one embodiment. However the instructions of program 1205 may be of a type and/or format that is different from or incompatible with processor 1215, meaning the instructions of the type in program 1205 may not be able to execute natively by the processor 1215. However, with the help of emulation logic, 1210, the instructions of program 1205 may be translated into instructions that may be natively be executed by the processor 1215. In one embodiment, the emulation logic may be embodied in hardware. In another embodiment, the emulation logic may be embodied in a tangible, machine-readable medium containing software to translate instructions of the type in program 1205 into the type natively executable by processor 1215. In other embodiments, emulation logic may be a combination of fixed-function or programmable hardware and a program stored on a tangible, machine-readable medium. In one embodiment, the processor contains the emulation logic, whereas in other embodiments, the emulation logic exists outside of the processor and may be provided by a third party. In one embodiment, the processor may load the emulation logic embodied in a tangible, machine-readable medium containing software by executing microcode or firmware contained in or associated with the processor.

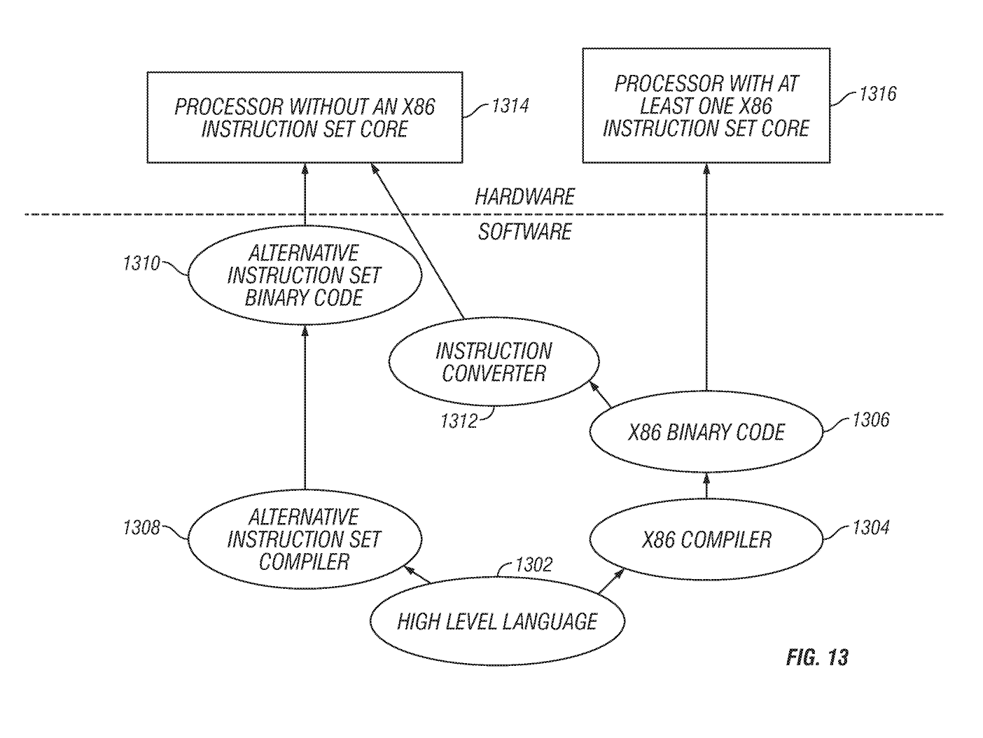

FIG. 13 illustrates a block diagram contrasting the use of a software instruction converter to convert binary instructions in a source instruction set to binary instructions in a target instruction set, in accordance with embodiments of the present disclosure. In the illustrated embodiment, the instruction converter may be a software instruction converter, although the instruction converter may be implemented in software, firmware, hardware, or various combinations thereof. FIG. 13 shows a program in a high level language 1302 may be compiled using an x86 compiler 1304 to generate x86 binary code 1306 that may be natively executed by a processor with at least one x86 instruction set core 1316. The processor with at least one x86 instruction set core 1316 represents any processor that may perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. x86 compiler 1304 represents a compiler that may be operable to generate x86 binary code 1306 (e.g., object code) that may, with or without additional linkage processing, be executed on the processor with at least one x86 instruction set core 1316. Similarly, FIG. 13 shows the program in high level language 1302 may be compiled using an alternative instruction set compiler 1308 to generate alternative instruction set binary code 1310 that may be natively executed by a processor without at least one x86 instruction set core 1314 (e.g., a processor with cores that execute the MIPS instruction set of MIPS Technologies of Sunnyvale, Calif. and/or that execute the ARM instruction set of ARM Holdings of Sunnyvale, Calif.). Instruction converter 1312 may be used to convert x86 binary code 1306 into code that may be natively executed by the processor without an x86 instruction set core 1314. This converted code might not be the same as alternative instruction set binary code 1310; however, the converted code will accomplish the general operation and be made up of instructions from the alternative instruction set. Thus, instruction converter 1312 represents software, firmware, hardware, or a combination thereof that, through emulation, simulation or any other process, allows a processor or other electronic device that does not have an x86 instruction set processor or core to execute x86 binary code 1306.

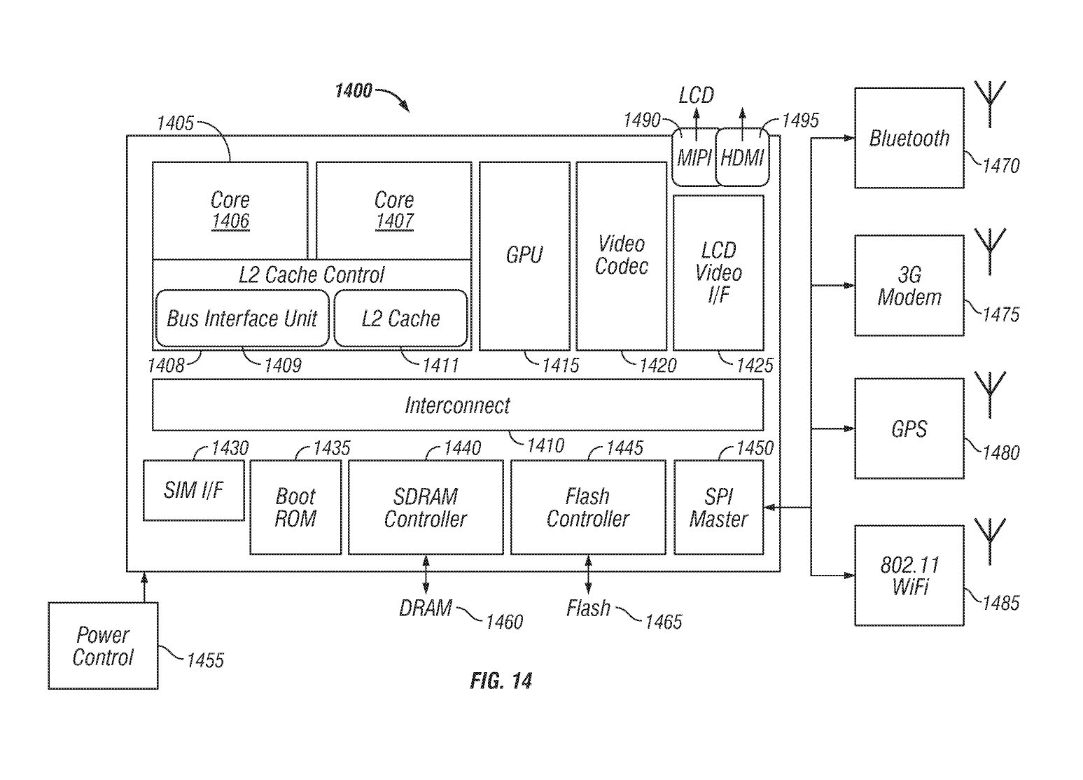

FIG. 14 is a block diagram of an instruction set architecture 1400 of a processor, in accordance with embodiments of the present disclosure. Instruction set architecture 1400 may include any suitable number or kind of components.

For example, instruction set architecture 1400 may include processing entities such as one or more cores 1406, 1407 and a graphics processing unit 1415. Cores 1406, 1407 may be communicatively coupled to the rest of instruction set architecture 1400 through any suitable mechanism, such as through a bus or cache. In one embodiment, cores 1406, 1407 may be communicatively coupled through an L2 cache control 1408, which may include a bus interface unit 1409 and an L2 cache 1411. Cores 1406, 1407 and graphics processing unit 1415 may be communicatively coupled to each other and to the remainder of instruction set architecture 1400 through interconnect 1410. In one embodiment, graphics processing unit 1415 may use a video codec 1420 defining the manner in which particular video signals will be encoded and decoded for output.

Instruction set architecture 1400 may also include any number or kind of interfaces, controllers, or other mechanisms for interfacing or communicating with other portions of an electronic device or system. Such mechanisms may facilitate interaction with, for example, peripherals, communications devices, other processors, or memory. In the example of FIG. 14, instruction set architecture 1400 may include a liquid crystal display (LCD) video interface 1425, a subscriber interface module (SIM) interface 1430, a boot ROM interface 1435, a synchronous dynamic random access memory (SDRAM) controller 1440, a flash controller 1445, and a serial peripheral interface (SPI) master unit 1450. LCD video interface 1425 may provide output of video signals from, for example, GPU 1415 and through, for example, a mobile industry processor interface (MIPI) 1490 or a high-definition multimedia interface (HDMI) 1495 to a display. Such a display may include, for example, an LCD. SIM interface 1430 may provide access to or from a SIM card or device. SDRAM controller 1440 may provide access to or from memory such as an SDRAM chip or module 1460. Flash controller 1445 may provide access to or from memory such as flash memory 1465 or other instances of RAM. SPI master unit 1450 may provide access to or from communications modules, such as a Bluetooth module 1470, high-speed 3G modem 1475, global positioning system module 1480, or wireless module 1485 implementing a communications standard such as 802.11.

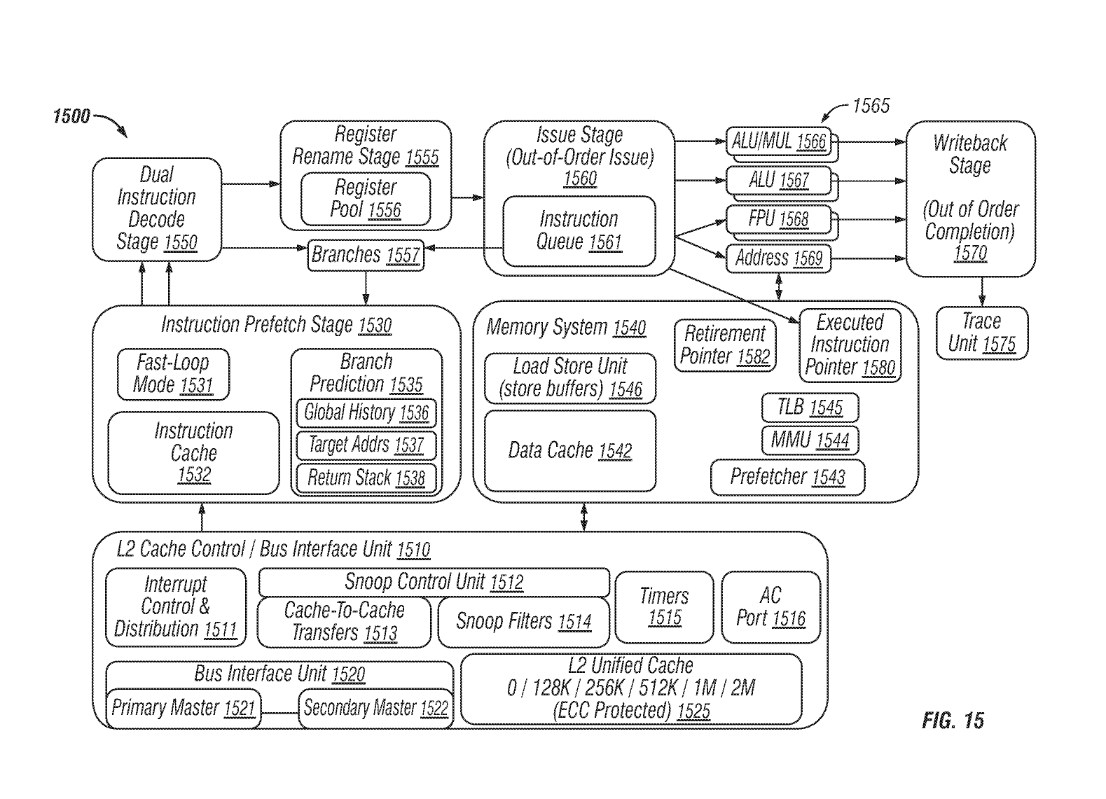

FIG. 15 is a more detailed block diagram of an instruction set architecture 1500 of a processor, in accordance with embodiments of the present disclosure. Instruction architecture 1500 may implement one or more aspects of instruction set architecture 1400. Furthermore, instruction set architecture 1500 may illustrate modules and mechanisms for the execution of instructions within a processor.

Instruction architecture 1500 may include a memory system 1540 communicatively coupled to one or more execution entities 1565. Furthermore, instruction architecture 1500 may include a caching and bus interface unit such as unit 1510 communicatively coupled to execution entities 1565 and memory system 1540. In one embodiment, loading of instructions into execution entities 1565 may be performed by one or more stages of execution. Such stages may include, for example, instruction prefetch stage 1530, dual instruction decode stage 1550, register rename stage 1555, issue stage 1560, and writeback stage 1570.

In one embodiment, memory system 1540 may include an executed instruction pointer 1580. Executed instruction pointer 1580 may store a value identifying the oldest, undispatched instruction within a batch of instructions. The oldest instruction may correspond to the lowest Program Order (PO) value. A PO may include a unique number of an instruction. Such an instruction may be a single instruction within a thread represented by multiple strands. A PO may be used in ordering instructions to ensure correct execution semantics of code. A PO may be reconstructed by mechanisms such as evaluating increments to PO encoded in the instruction rather than an absolute value. Such a reconstructed PO may be known as an “RPO.” Although a PO may be referenced herein, such a PO may be used interchangeably with an RPO. A strand may include a sequence of instructions that are data dependent upon each other. The strand may be arranged by a binary translator at compilation time. Hardware executing a strand may execute the instructions of a given strand in order according to the PO of the various instructions. A thread may include multiple strands such that instructions of different strands may depend upon each other. A PO of a given strand may be the PO of the oldest instruction in the strand which has not yet been dispatched to execution from an issue stage. Accordingly, given a thread of multiple strands, each strand including instructions ordered by PO, executed instruction pointer 1580 may store the oldest-illustrated by the lowest number-PO in the thread.

In another embodiment, memory system 1540 may include a retirement pointer 1582. Retirement pointer 1582 may store a value identifying the PO of the last retired instruction. Retirement pointer 1582 may be set by, for example, retirement unit 454. If no instructions have yet been retired, retirement pointer 1582 may include a null value.

Execution entities 1565 may include any suitable number and kind of mechanisms by which a processor may execute instructions. In the example of FIG. 15, execution entities 1565 may include ALU/multiplication units (MUL) 1566, ALUs 1567, and floating point units (FPU) 1568. In one embodiment, such entities may make use of information contained within a given address 1569. Execution entities 1565 in combination with stages 1530, 1550, 1555, 1560, 1570 may collectively form an execution unit.

Unit 1510 may be implemented in any suitable manner. In one embodiment, unit 1510 may perform cache control. In such an embodiment, unit 1510 may thus include a cache 1525. Cache 1525 may be implemented, in a further embodiment, as an L2 unified cache with any suitable size, such as zero, 128 k, 256 k, 512 k, 1M, or 2M bytes of memory. In another, further embodiment, cache 1525 may be implemented in error-correcting code memory. In another embodiment, unit 1510 may perform bus interfacing to other portions of a processor or electronic device. In such an embodiment, unit 1510 may thus include a bus interface unit 1520 for communicating over an interconnect, intraprocessor bus, interprocessor bus, or other communication bus, port, or line. Bus interface unit 1520 may provide interfacing in order to perform, for example, generation of the memory and input/output addresses for the transfer of data between execution entities 1565 and the portions of a system external to instruction architecture 1500.

To further facilitate its functions, bus interface unit 1510 may include an interrupt control and distribution unit 1511 for generating interrupts and other communications to other portions of a processor or electronic device. In one embodiment, bus interface unit 1510 may include a snoop control unit 1512 that handles cache access and coherency for multiple processing cores. In a further embodiment, to provide such functionality, snoop control unit 1512 may include a cache-to-cache transfer unit 1513 that handles information exchanges between different caches. In another, further embodiment, snoop control unit 1512 may include one or more snoop filters 1514 that monitors the coherency of other caches (not shown) so that a cache controller, such as unit 1510, does not have to perform such monitoring directly. Unit 1510 may include any suitable number of timers 1515 for synchronizing the actions of instruction architecture 1500. Also, unit 1510 may include an AC port 1516.

Memory system 1540 may include any suitable number and kind of mechanisms for storing information for the processing needs of instruction architecture 1500. In one embodiment, memory system 1540 may include a load store unit 1546 for storing information such as buffers written to or read back from memory or registers. In another embodiment, memory system 1540 may include a translation lookaside buffer (TLB) 1545 that provides look-up of address values between physical and virtual addresses. In yet another embodiment, memory system 1540 may include a memory management unit (MMU) 1544 for facilitating access to virtual memory. In still yet another embodiment, memory system 1540 may include a prefetcher 1543 for requesting instructions from memory before such instructions are actually needed to be executed, in order to reduce latency.

The operation of instruction architecture 1500 to execute an instruction may be performed through different stages. For example, using unit 1510 instruction prefetch stage 1530 may access an instruction through prefetcher 1543. Instructions retrieved may be stored in instruction cache 1532. Prefetch stage 1530 may enable an option 1531 for fast-loop mode, wherein a series of instructions forming a loop that is small enough to fit within a given cache are executed. In one embodiment, such an execution may be performed without needing to access additional instructions from, for example, instruction cache 1532. Determination of what instructions to prefetch may be made by, for example, branch prediction unit 1535, which may access indications of execution in global history 1536, indications of target addresses 1537, or contents of a return stack 1538 to determine which of branches 1557 of code will be executed next. Such branches may be possibly prefetched as a result. Branches 1557 may be produced through other stages of operation as described below. Instruction prefetch stage 1530 may provide instructions as well as any predictions about future instructions to dual instruction decode stage 1550.

Dual instruction decode stage 1550 may translate a received instruction into microcode-based instructions that may be executed. Dual instruction decode stage 1550 may simultaneously decode two instructions per clock cycle. Furthermore, dual instruction decode stage 1550 may pass its results to register rename stage 1555. In addition, dual instruction decode stage 1550 may determine any resulting branches from its decoding and eventual execution of the microcode. Such results may be input into branches 1557.

Register rename stage 1555 may translate references to virtual registers or other resources into references to physical registers or resources. Register rename stage 1555 may include indications of such mapping in a register pool 1556. Register rename stage 1555 may alter the instructions as received and send the result to issue stage 1560.

Issue stage 1560 may issue or dispatch commands to execution entities 1565. Such issuance may be performed in an out-of-order fashion. In one embodiment, multiple instructions may be held at issue stage 1560 before being executed. Issue stage 1560 may include an instruction queue 1561 for holding such multiple commands. Instructions may be issued by issue stage 1560 to a particular processing entity 1565 based upon any acceptable criteria, such as availability or suitability of resources for execution of a given instruction. In one embodiment, issue stage 1560 may reorder the instructions within instruction queue 1561 such that the first instructions received might not be the first instructions executed. Based upon the ordering of instruction queue 1561, additional branching information may be provided to branches 1557. Issue stage 1560 may pass instructions to executing entities 1565 for execution.

Upon execution, writeback stage 1570 may write data into registers, queues, or other structures of instruction set architecture 1500 to communicate the completion of a given command. Depending upon the order of instructions arranged in issue stage 1560, the operation of writeback stage 1570 may enable additional instructions to be executed. Performance of instruction set architecture 1500 may be monitored or debugged by trace unit 1575.

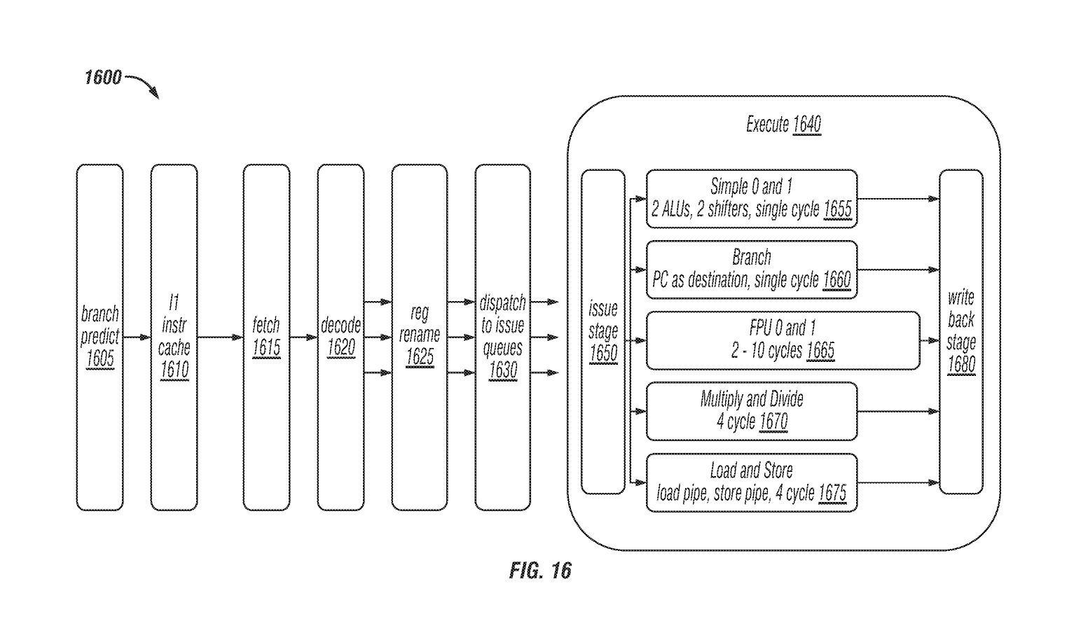

FIG. 16 is a block diagram of an execution pipeline 1600 for an instruction set architecture of a processor, in accordance with embodiments of the present disclosure. Execution pipeline 1600 may illustrate operation of, for example, instruction architecture 1500 of FIG. 15.

Execution pipeline 1600 may include any suitable combination of steps or operations. In 1605, predictions of the branch that is to be executed next may be made. In one embodiment, such predictions may be based upon previous executions of instructions and the results thereof. In 1610, instructions corresponding to the predicted branch of execution may be loaded into an instruction cache. In 1615, one or more such instructions in the instruction cache may be fetched for execution. In 1620, the instructions that have been fetched may be decoded into microcode or more specific machine language. In one embodiment, multiple instructions may be simultaneously decoded. In 1625, references to registers or other resources within the decoded instructions may be reassigned. For example, references to virtual registers may be replaced with references to corresponding physical registers. In 1630, the instructions may be dispatched to queues for execution. In 1640, the instructions may be executed. Such execution may be performed in any suitable manner. In 1650, the instructions may be issued to a suitable execution entity. The manner in which the instruction is executed may depend upon the specific entity executing the instruction. For example, at 1655, an ALU may perform arithmetic functions. The ALU may utilize a single clock cycle for its operation, as well as two shifters. In one embodiment, two ALUs may be employed, and thus two instructions may be executed at 1655. At 1660, a determination of a resulting branch may be made. A program counter may be used to designate the destination to which the branch will be made. 1660 may be executed within a single clock cycle. At 1665, floating point arithmetic may be performed by one or more FPUs. The floating point operation may require multiple clock cycles to execute, such as two to ten cycles. At 1670, multiplication and division operations may be performed. Such operations may be performed in four clock cycles. At 1675, loading and storing operations to registers or other portions of pipeline 1600 may be performed. The operations may include loading and storing addresses. Such operations may be performed in four clock cycles. At 1680, write-back operations may be performed as required by the resulting operations of 1655-1675.

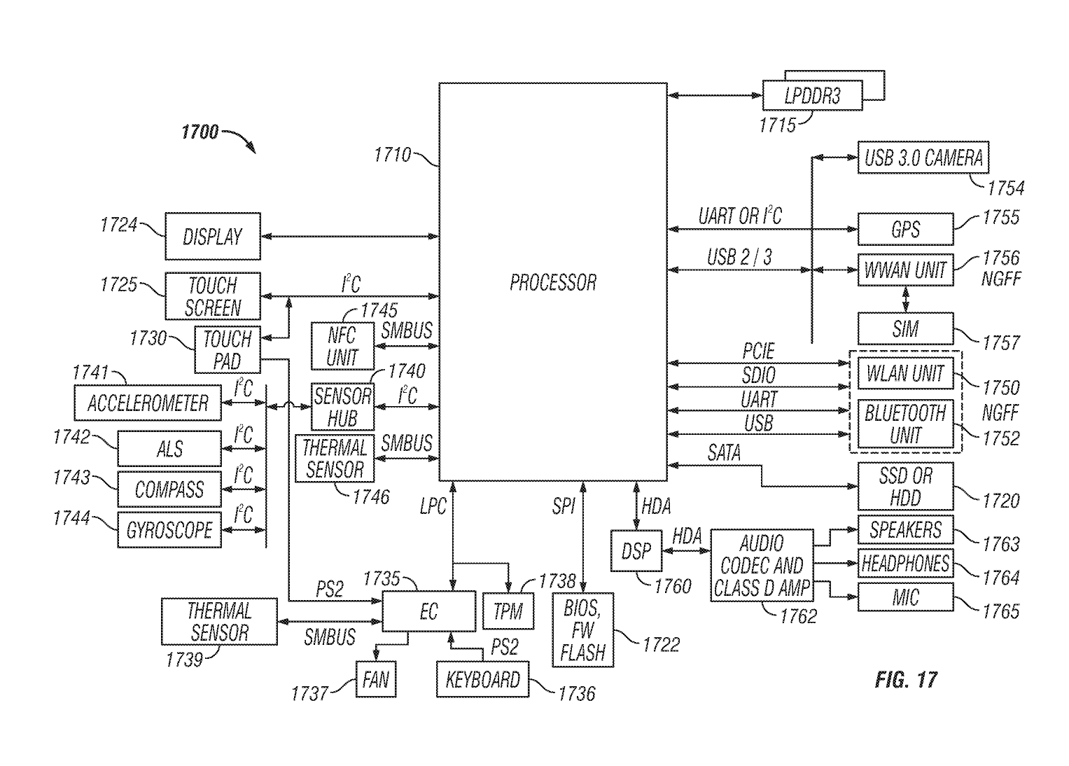

FIG. 17 is a block diagram of an electronic device 1700 for utilizing a processor 1710, in accordance with embodiments of the present disclosure. Electronic device 1700 may include, for example, a notebook, an ultrabook, a computer, a tower server, a rack server, a blade server, a laptop, a desktop, a tablet, a mobile device, a phone, an embedded computer, or any other suitable electronic device.

Electronic device 1700 may include processor 1710 communicatively coupled to any suitable number or kind of components, peripherals, modules, or devices. Such coupling may be accomplished by any suitable kind of bus or interface, such as I²C bus, system management bus (SMBus), low pin count (LPC) bus, SPI, high definition audio (HDA) bus, Serial Advance Technology Attachment (SATA) bus, USB bus (versions 1, 2, 3), or Universal Asynchronous Receiver/Transmitter (UART) bus.

Such components may include, for example, a display 1724, a touch screen 1725, a touch pad 1730, a near field communications (NFC) unit 1745, a sensor hub 1740, a thermal sensor 1746, an express chipset (EC) 1735, a trusted platform module (TPM) 1738, BIOS/firmware/flash memory 1722, a digital signal processor 1760, a drive 1720 such as a solid state disk (SSD) or a hard disk drive (HDD), a wireless local area network (WLAN) unit 1750, a Bluetooth unit 1752, a wireless wide area network (WWAN) unit 1756, a global positioning system (GPS) 1775, a camera 1754 such as a USB 3.0 camera, or a low power double data rate (LPDDR) memory unit 1715 implemented in, for example, the LPDDR3 standard. These components may each be implemented in any suitable manner.

Furthermore, in various embodiments other components may be communicatively coupled to processor 1710 through the components discussed above. For example, an accelerometer 1741, ambient light sensor (ALS) 1742, compass 1743, and gyroscope 1744 may be communicatively coupled to sensor hub 1740. A thermal sensor 1739, fan 1737, keyboard 1736, and touch pad 1730 may be communicatively coupled to EC 1735. Speakers 1763, headphones 1764, and a microphone 1765 may be communicatively coupled to an audio unit 1762, which may in turn be communicatively coupled to DSP 1760. Audio unit 1762 may include, for example, an audio codec and a class D amplifier. A SIM card 1757 may be communicatively coupled to WWAN unit 1756. Components such as WLAN unit 1750 and Bluetooth unit 1752, as well as WWAN unit 1756 may be implemented in a next generation form factor (NGFF).

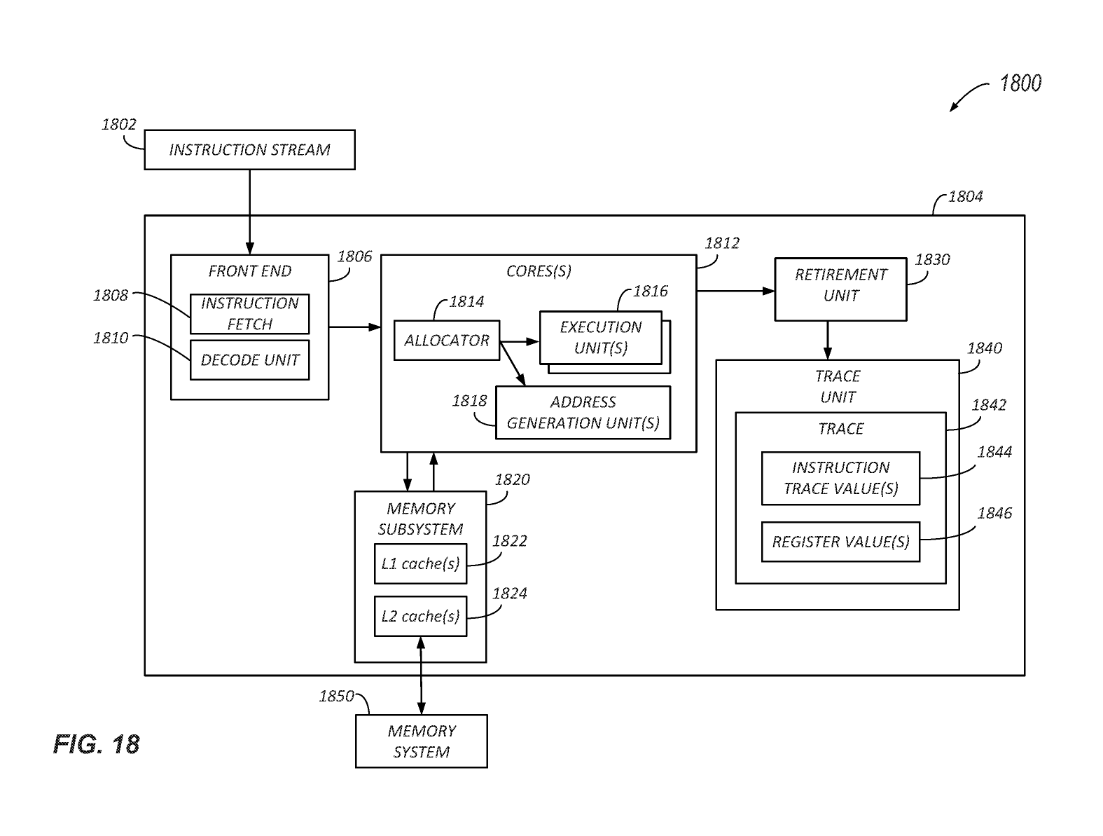

Embodiments of the present disclosure involve data address tracing during execution of a program and the subsequent simulation of the program using the data trace information. FIG. 18 is an illustration of an example system 1800 for performing data address tracing, according to embodiments of the present disclosure. Problem analysis and debugging methods involving the simulation of a program may sometimes be based on instruction tracing, which provides a stream of instructions executed by the processor to gain a deeper understanding of software behavior. In some cases, it may also be beneficial to implement data tracing. In embodiments of the present disclosure, system 1800 may include hardware circuitry or logic to perform data address tracing. In at least some embodiments, the resulting trace bandwidth may be significantly reduced when compared to existing data trace mechanisms, while the hardware complexity to implement this approach may be relatively low. For example, in some embodiments, immediate addresses, immediate offset values, read/write access widths, addressing modes and registers involved in address calculations may be known to, or may be predictable by, a simulation based on the executable binary and an instruction trace. In some embodiments, rather than tracing data addresses directly, the data address trace information generated by system 1800 may include only the values of registers that are used for address generation by the program being traced.

In at least some embodiments, the processor may keep track of which registers that are used for address generation have values that would be known to, or predictable by, a simulation, absent any data tracking. For example, each register that may potentially be used for address generation may be associated with a respective prediction state indicator whose value indicates whether or not the contents of the register would be known to, or predictable by, a simulation at a given point during the execution of the program being traced, and only the values of those registers whose prediction state indicator value indicates that its contents would not be known or predictable may be output to the trace for subsequent use by the simulation. Thus, the data address trace information generated by system 1800 may include only the values of registers that cannot be reconstructed from the instruction trace and the executable binary during the simulation. Data addresses may be reconstructed in the simulation based on the instruction trace and the additional register value information recorded by the trace unit during execution. In at least some embodiments, reconstructing the addresses on the simulation may include performing a partial (linear) instruction simulation that keeps track of the values of the registers included in the simulation. The inputs to the simulation may include the executable binary, an instruction trace stream, the currently known register values, and the values of the unpredictable register obtained using the data address tracing approach described herein. In at least some embodiments of the present disclosure, the contents of memory are not traced and do not have to be simulated.

System 1800 may include a processor, SoC, integrated circuit, or other mechanism. For example, system 1800 may include processor 1804. Although processor 1804 is shown and described as an example in FIG. 18, any suitable mechanism may be used. Processor 1804 may include any suitable mechanisms for performing data address tracing, including those that deliver only the register values used for address generation and only those which cannot be reconstructed from an instruction trace and the executable binary of the program being traced. In one embodiment, such mechanisms may be implemented in hardware. Processor 1804 may be implemented fully or in part by the elements described in FIGS. 1-17.

Instructions to be executed on processor 1804 may be included in instruction stream 1802. Instruction stream 1802 may be generated by, for example, a compiler, just-in-time interpreter, or other suitable mechanism (which might or might not be included in system 1800), or may be designated by a drafter of code resulting in instruction stream 1802. For example, a compiler may take application code and generate executable code in the form of instruction stream 1802. Instructions may be received by processor 1804 from instruction stream 1802. Instruction stream 1802 may be loaded to processor 1804 in any suitable manner. For example, instructions to be executed by processor 1804 may be loaded from storage, from other machines, or from other memory, such as memory system 1830. The instructions may arrive and be available in resident memory, such as RAM, and may be fetched from storage to be executed by processor 1804. The instructions may be fetched from resident memory by, for example, a prefetcher or fetch unit (such as instruction fetch unit 1808).

Processor 1804 may include a front end 1806, which may include an instruction fetch pipeline stage (such as instruction fetch unit 1808) and a decode pipeline stage (such as decide unit 1810). Front end 1806 may receive and decode instructions from instruction stream 1802 using decode unit 1810. The decoded instructions may be dispatched, allocated, and scheduled for execution by an allocation stage of a pipeline (such as allocator 1814) and allocated to specific execution units 1816 for execution. One or more specific instructions to be executed by processor 1804 may be included in a library defined for execution by processor 1804. In another embodiment, specific instructions may be targeted by particular portions of processor 1804. For example, processor 1804 may recognize an attempt in instruction stream 1802 to execute a vector operation in software and may issue the instruction to a particular one of execution units 1816 to execute the instruction.

During execution, access to data or additional instructions (including data or instructions resident in memory system 1850) may be made through memory subsystem 1820. Moreover, results from execution may be stored in memory subsystem 1820 and may subsequently be flushed to memory system 1850. Memory subsystem 1820 may include, for example, memory, RAM, or a cache hierarchy, which may include one or more Level 1 (L1) caches 1822 or Level 2 (L2) caches 1824, some of which may be shared by multiple cores 1812 or processors 1804. After execution by execution units 1816, instructions may be retired by a writeback stage or retirement stage in retirement unit 1830. Various portions of such execution pipelining may be performed by one or more cores 1812.

In at least some embodiments, one or more of the execution units in cores 1812 may be an address generation unit 1818. Address generation unit 1818 may be implemented in any suitable manner, such as fully or in part by address generation unit 212 illustrated in FIG. 2 and described above. In at least some embodiments, address generation unit 1818 may generate addresses to be used by load or store instructions involving memory access. In other embodiments, address generation unit 1818 may generate addresses to be used by other types of instructions. In some cases, depending on the addressing modes employed by different instructions in instruction stream 1802, address generation unit 1818 may generate addresses for the source and/or target (destination) operands of an instruction based on the values of one or more registers specified in the instruction.

Instruction tracing may, in general, provide a stream of instructions executed by a processor that leads to a deeper understanding of behavior of a software program. In some cases, in addition to a stream of executed instructions, it may be beneficial to provide a data trace. A data trace can include a data value trace (which records what was read or written by the processor) and/or a data address trace (which record where data was read from or written to). While an instruction trace may, in some embodiments, be encoded in a very efficient way (such as with only 1 bit per conditional branch), data trace encoding typically imposes big challenges with respect to the resulting trace bandwidth. As described in more detail herein, system 1800 may implement data address tracing in a manner in which the resulting trace bandwidth is significantly reduced compared to existing data trace approaches, while keeping the hardware complexity to implement data address tracing relatively low.

System 1800 may include a trace unit 1840, which may include hardware circuitry or logic for capturing and recording information usable to visualize or characterize the behavior of a software program executing on processor 1804. Trace unit 1840 may be implemented in any suitable manner, such as fully or in part by trace unit 1575 illustrated in FIG. 15 and described above. In the example embodiment illustrated in FIG. 15, trace unit 1575 may include storage in which to record and/or assemble a trace 1842. Trace 1842 may include instruction trace information (shown as instruction trace values 1844). For example, instruction trace values 1844 may include, for each executed conditional branch instruction in instruction stream 1802, a register, a flag, a bit, or another type of indicator whose value indicates whether the branch was taken or not taken. In some embodiments, more or different information about the execution of the instructions in instruction stream 1802 may be recorded as instruction trace values 1844.

In at least some embodiments of the present disclosure, trace 1842 may also include storage for one or more register values 1846, each of which represents the value in a register that is used for address generation and that is considered to be unpredictable at the time that it is used for address generation. For example, a register may be considered to be unpredictable if a simulator having access to the binary executable of the program and an instruction trace would not be able to predicate the value of the register, absent any additional data tracing, such as that described herein. After the instruction trace values 1844 and register values 1846 within trace 1842, trace unit 1840 may make trace 1840 available for use in simulating, characterizing, or debugging the program that was traced. For example, in one embodiment, the trace may be written out to memory system 1850. In another embodiment, the trace may be written out to a remote memory from which it may be subsequently read by a simulator. In yet another embodiment, the trace may be transferred off-chip via any of various standard or custom trace interfaces, such as an interface that adheres to a serial or parallel trace protocol of the Mobile Industry Processor Interface (MIPI) Alliance, or any other suitable interface. Trace 1842 may be provided as an input to any of a variety of simulation, characterization or debugging tools. In some embodiments, trace 1842 may be integrated with the binary executable of the program before being provided to a simulation, characterization or debugging tool.

In some embodiments, the current prediction state of the source and/or targets registers for a given instruction may be tracked by the processor as the instruction passes through the execution pipeline. If and when the given instruction is retired, a respective predication state indicator associated with each of those registers may be updated to match the current prediction state of the registers, as tracked by the processor. For example, in some embodiments, processor 1804 may include storage for one or more register prediction state values, each of which may indicate, at any given time during execution of a program, whether the value contained in a corresponding register is currently predictable. In some embodiments, for each register in processor 1804 that is potentially involved in address generation, processor 1804 may maintain a respective one of these prediction state values, and may update its value, if necessary, during the retirement of an instruction that used the register for address generation. In some embodiments, these prediction state indicators may be attached to these registers in the physical register file. In this way, the prediction state of each such register may propagate together with the register values in the case of register renaming and speculative execution. As described in more detail herein, the prediction status of a given register may be updated whenever the given register is the target operand of an instruction. In some embodiments, register prediction state indicators for each of the potentially involved in address generation may be implemented by hardware or logic within the cores 1812. In one example, the value of the prediction state indicator for a target register of a given instruction may be updated when the given instruction is retired. In another example, during retirement of an instruction that used a given register for address generation, the value of the predication state indicator for the given register may be read in order to determine whether its value is to be traced out. In some embodiments, each register in processor 1804 that is potentially involved in address generation may be extended with one sideband status bit indicating whether or not its value would be predictable in a subsequent simulation of the program being executed.

In general, most of data accessed by a processor is the actual input/output data of the executed algorithm, and only a small fraction of this data is used for address generation. In at least some embodiments of the present disclosure, the processor may differentiate between those two kinds of data and may avoid tracing out data that is not related to address generation. The knowledge about how to access data may, in most cases, be compiled into the software executable. Data addresses may be generated internally by the processor, based on executed instructions, addressing modes and current register values. One example of an instruction for which the processor generates a data addresses is a stack operation, such as a push or pop operation that uses a known stack pointer value. Another example of an instruction for which the processor generates a data addresses is an operation that accesses a member of a structure using a known base pointer plus an immediate offset. Other examples include operations on arrays (where the address is incremented in a loop by an immediate value), memcpys operations involving known source and destination address ranges, and SIMD processing operations.

Due to the nature of these types of instructions, instead of tracing data addresses directly, it may be enough to deliver to a trace the inputs used by the processor (or a core thereof) for address generation. For example, immediate addresses, immediate offset values, read/write access widths, addressing modes and/or the registers involved in address calculations may obtained by the simulation from the executable binary. Therefore, the only inputs that have to be traced out are the current register values that are needed for address generation. In some embodiments, the resulting data addresses may be reconstructed in a simulation based on these traced register values and the instruction trace.

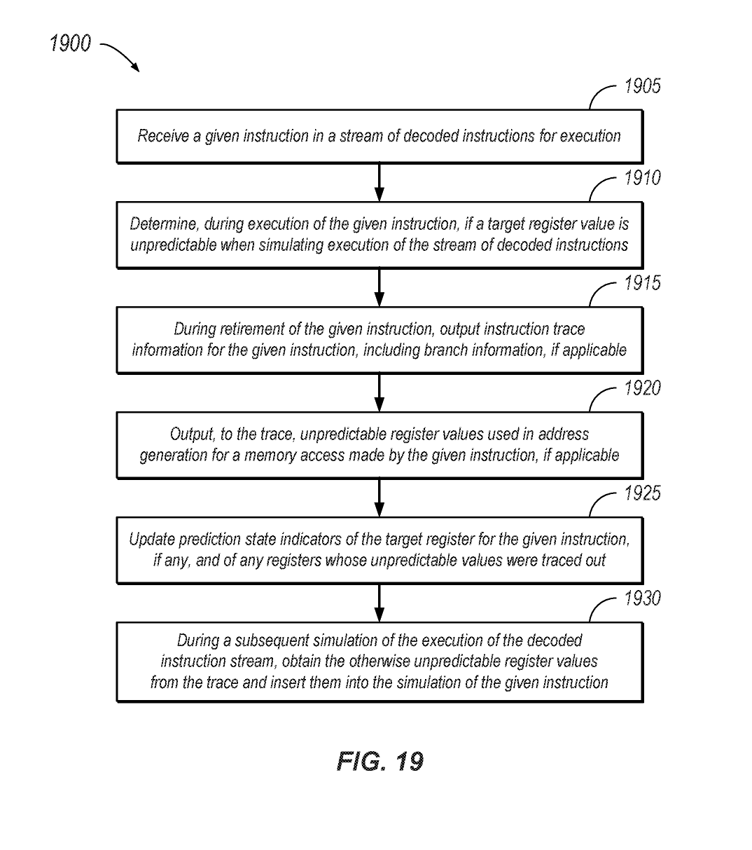

FIG. 19 illustrates an example method 1900 for tracing data addresses and using the traced information in a simulation, according to embodiments of the present disclosure. Method 1900 may be implemented by any of the elements shown in FIGS. 1-18 or FIG. 20. Method 1900 may be initiated by any suitable criteria and may initiate operation at any suitable point. In one embodiment, method 1900 may initiate operation at 1905. Method 1900 may include greater or fewer steps than those illustrated. Moreover, method 1900 may execute its steps in an order different than those illustrated below. Method 1900 may terminate at any suitable step. Moreover, method 1900 may repeat operation at any suitable step. Method 1900 may perform any of its steps in parallel with other steps of method 1900, or in parallel with steps of other methods.

Furthermore, method 1900 may be executed multiple times to trace data addresses associated with different instructions and to use the traced information in a simulation. Method 1900 may be executed over time to characterize execution of a program over time. During the performance of method 1900, other methods may be invoked, such as methods 2100 and 2400, described below.

At 1905, in one embodiment, a given instruction in a stream of decoded instructions is received for execution. At 1910, during execution of the given instruction, a determination is made about whether the value of a target register for the given instruction is unpredictable when simulating execution of the stream of decoded instructions. As described in more detail herein, in some embodiments, the determination may be made based on whether the source operands for the given instruction are predictable or not. At 1915, during retirement of the given instruction, instruction trace information for the given instruction is output, including branch information, if applicable.

At 1920, any unpredictable register values used in address generation for a memory access made by the given instruction are output to the trace, if applicable. At 1925, prediction state indicators of the target register for the given instruction, if any, and of any registers whose unpredictable values were traced out, are updated based on the execution of the instruction. In at least some embodiments, steps 1910 to 1925 may be executed in hardware as part of executing the received instruction. At 1930, during a subsequent simulation of the execution of the decoded instruction stream, the otherwise unpredictable register values are obtained from the trace and are inserted into the simulation of the given instruction.

In at least some embodiments of the present disclosure, the processor (or a core thereof) may keep track of which register values can be reconstructed in a simulation. In some embodiments, in order to track this information, every architectural general purpose register may be extended with one “sideband” status bit indicating whether or not its value would be predictable in a simulation. In embodiments in which the cores implement out-of-order execution and that include a large physical register file, every physical register may include this extension. For example, this extension may be applied to some or all of the registers within register files 208 and/or 210 illustrated in FIG. 2 and described above.

In at least some embodiments of the present disclosure, for every instruction that includes a register as a target operand, the value of the prediction state bit for the target register may be set to a value indicating that its contents would be known to, or predictable by, a simulation, if all the sources of the instruction were considered to be predictable. In some embodiments, predictable sources may include other registers whose respective prediction state bits are set to a value indicating that their contents would be known to, or predictable by, a simulation. In some embodiments, predictable sources may also include any immediate values supplied by the binary. In at least some embodiments, if source values are obtained from memory, they are not considered predictable. For example, in some embodiments, memory contents may always be treated as if they are known to, and unpredictable by, a simulation.

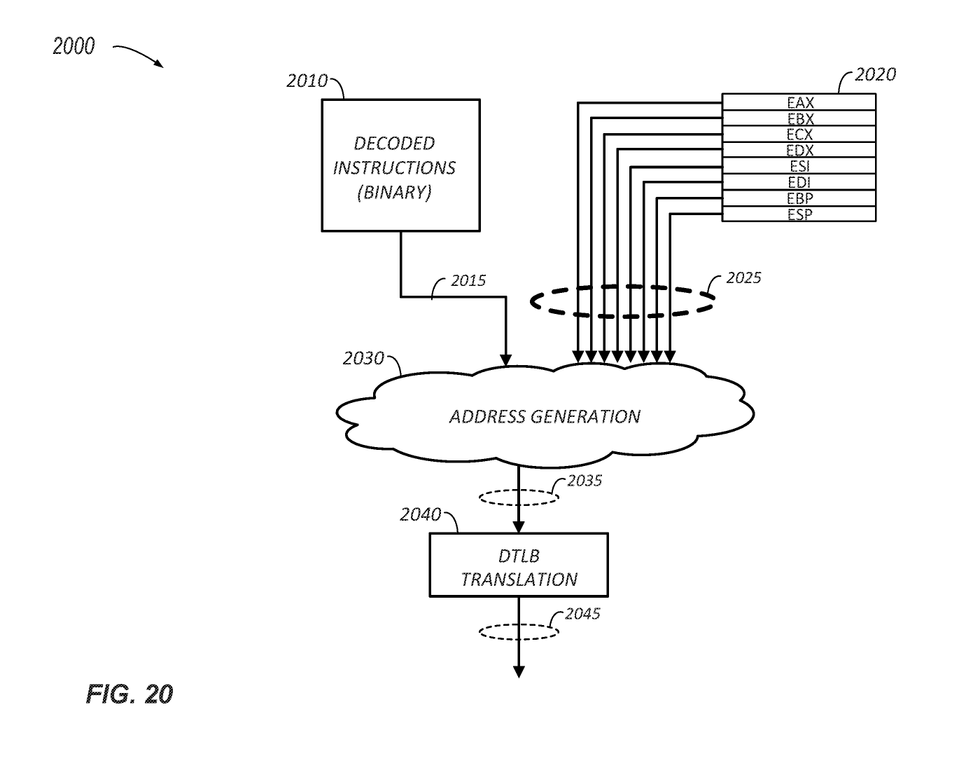

FIG. 20 illustrates selected elements of an example system 2000 that implements data address tracing, according to embodiments of the present disclosure. In this example, system 2000 includes an executable image (e.g., a binary executable) of a program being traced, shown as decoded instructions (binary) 2010. System 2000 also includes a collection of registers 2020, each of which can potentially be used in an address generation, depending on the addressing modes employed in the instructions in the program. In at least some embodiments, each of these registers may be associated with a respective prediction state indicator. System 2000 also includes address generation circuitry (shown as address generation 2030) and data translation lookaside buffer circuitry (shown as DTLB translation circuitry 2040). Address generation circuitry 2030 may be implemented in any suitable manner, such as fully or in part by address generation unit 212 illustrated in FIG. 2 and described above. DTLB translation circuitry 2040 may be implemented in any suitable manner, such as fully or in part by data TLB unit 472 illustrated in FIG. 4B and described above.

In this example, an instruction stream 2015 is received by address generation circuitry 2030 as input. The instruction stream 2015 may include, for each instruction in the instruction stream, its access type and width, addressing modes used, registers used, scale information, displacement information, and/or other information usable in generating addresses for load operations, store operations, or other operations for which an address is to be generated using one or more register addressing modes. Other inputs to address generation circuitry 2030 include the values of the registers 2020 (shown as register values 2025).

Based on the information obtained from the decoded instructions (binary) 2010 in instruction stream 2015 and the register values 2025, the address generation circuitry may produce virtual addresses 2035. DTLB translation circuitry 2040 may receive virtual addresses 2035 and may produce physical addresses 2045 corresponding to those virtual addresses 2035.

In the example embodiment illustrated in FIG. 20, the processor (or a core thereof) may keep track of which register values can be reconstructed in a simulation by maintaining a respective prediction state bit for each of the registers 2020. In at least some embodiments of the present disclosure, register values 2025 may, if they are used for address generation and are marked as not predictable, be output to a trace when the instruction that used them for address generation is retired. For example, if the value of a prediction state bit associated with one of the registers that is used for address generation indicates that the register's value would be unpredictable by a simulation, the value of the register may be traced out when the instruction is retired. However, neither virtual addresses 2035 nor physical addresses 2045 for the instruction will be output to the trace.

In some embodiments, a trace unit, such as trace unit 1840 in FIG. 18, may output an instruction trace that includes one bit for each conditional branch whose value indicates whether the branch was taken or not taken. By combining this information with the executable binary, the stream of the instructions, and the order in which they were executed, may be known. In some embodiments of the present disclosure, the processor (or a core thereof) may also keep track of which registers will be needed by the simulation in order to reconstruct data addresses. For example, each time an instruction that performs a load or store operation retires, there is a write back to memory. At this point, the processor (or core) may determine that some outputs that the simulation cannot know about nor predict were used for the address generation. In these cases, the processor (or core) may insert this information into the instruction trace. In some embodiments, the processor (or a core thereof) may include hardware circuitry or logic to determine when the predication state bit for a given register should be set to a values of “1” and when the predication state bit for the given register should be set to a values of “0”. In at least some embodiments of the present disclosure, the value of this predication state bit may propagate together with the rest of the register contents through any calculations performed by the executing instructions. Subsequently, the processor (or core) may update the value of the predication state bit, if necessary, to reflect any change in the predictability of the register following the execution of the instruction. In embodiments of the present disclosure, the data addresses resulting from the address calculation are not, themselves, output to the trace directly.

In at least some embodiments, during the execution of each operation that performs a memory access, if the address calculation is based only on the values in one or more registers that are marked as predictable and/or on one or more immediate values, no data address trace information will be traced out. In this case, a subsequent simulation should already know all the necessary inputs needed for reconstructing the address. However, if the address calculation involves values in one or more registers that are marked as unpredictable, the values of those registers may be traced out. In some embodiments, the values of these registers may be traced out at the time of address generation. In other embodiments, because address generation may be speculative, the values of these registers may not be traced out until the retirement of any instruction that uses them for address generation. Once the values of these registers have been traced out, their respective predication state bits may be updated to values reflecting that these register values are now predictable, because the simulation will be able to obtain their values from the trace, and then subsequently track any changes to them on its own. In embodiments that include superscalar cores that implement out-of-order execution, a respective predication state bit may propagate on each of the allocated physical registers, and may flow through the execution pipeline together with the data value in the register. In such embodiments, the ordering of any changes made to the predication state bits may be handled by the core itself, as this will be done by the core for the data, as well.

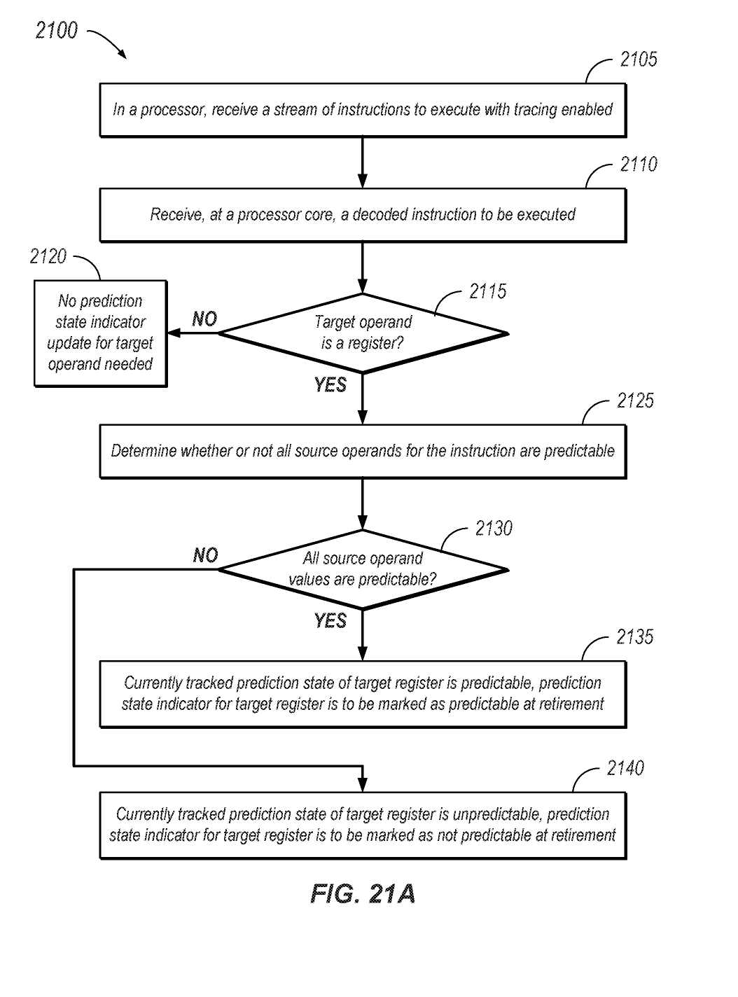

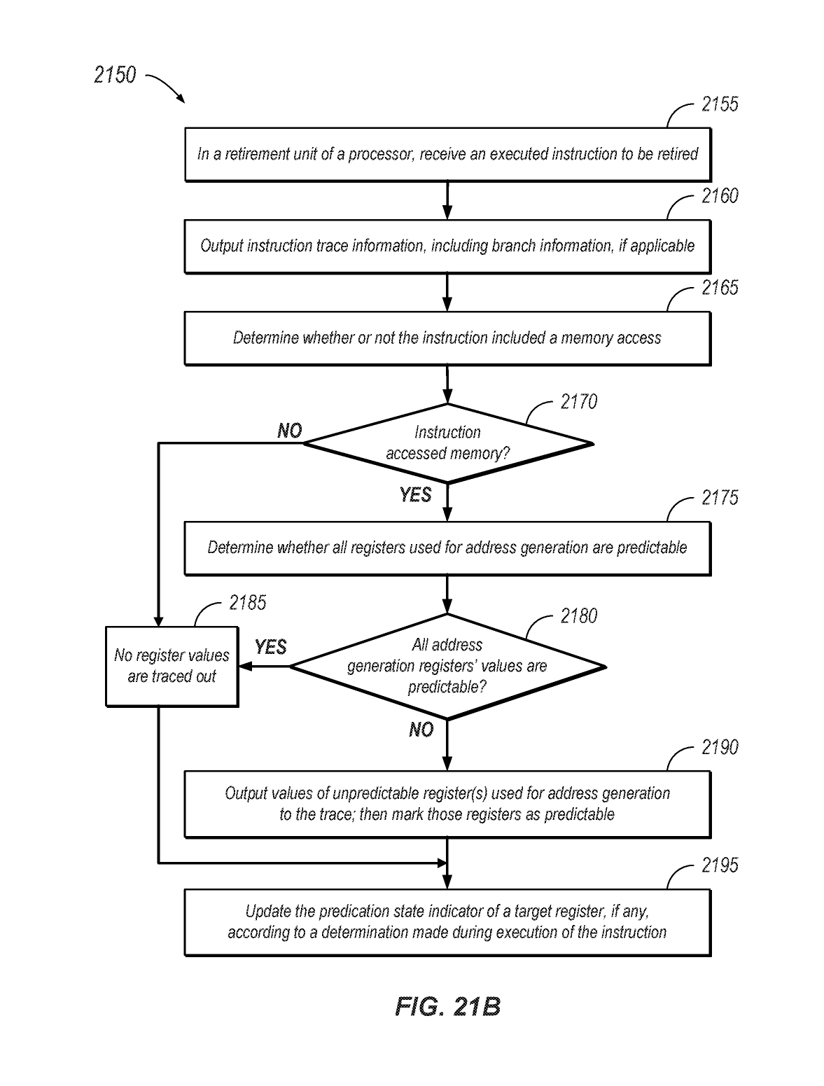

FIG. 21A illustrates an example method 2100 for determining, during execution of an instruction, whether or not the value of a destination register for the instruction is predictable in a subsequent instruction simulation, according to embodiments of the present disclosure. Method 2100 may be implemented by any of the elements shown in FIGS. 1-20. Method 2100 may be initiated by any suitable criteria and may initiate operation at any suitable point. In one embodiment, method 2100 may initiate operation at 2105. Method 2100 may include greater or fewer steps than those illustrated. Moreover, method 2100 may execute its steps in an order different than those illustrated below. Method 2100 may terminate at any suitable step. Moreover, method 2100 may repeat operation at any suitable step. Method 2100 may perform any of its steps in parallel with other steps of method 2100, or in parallel with steps of other methods.

Furthermore, method 2100 may be executed multiple times to determine whether or not the value of a destination register for any of the instructions in the stream of instructions is predictable in a subsequent instruction simulation. Method 2100 may be executed over time to as part of characterizing the execution of the program over time. Method 2100 may be invoked during execution of method 1900 described above.

At 2105, a stream of instructions to be executed with tracing enabled is received at a processor. At 2110, a decoded instruction to be executed is received at a processor core within the processor. At 2115, it is determined whether or not the target operand is a register. If so, the method proceeds to 2125. Otherwise, the method proceeds to 2120. At 2120, since the target operand is not a register, there is no need to update a prediction state indicator for the target operand.

At 2125, a determination is made as to whether or not all source operands for the instruction are predictable. In some embodiments, a source register's value may be considered unpredictable if it cannot be determined based on the executable image of the program and the instruction trace, absent any data tracing. In some embodiments, the values of any registers used in generating addresses for memory accesses may be considered unpredictable. As described herein, the processor core may track which registers are predictable based on the executable image and instruction trace by maintaining a predication state indicator for each register. The processor core may update the values of these indicators when the corresponding register value become predictable or become unpredictable as execution of the program progresses. In one embodiment, a values of “1” or “true” may indicate that the corresponding register is predictable, while a value of “0” or “false” may indicate that the corresponding register is currently unpredictable. If it is determined that all of the source registers' values are predictable, the method proceeds to 2135. Otherwise, the method proceeds to 2140.

At 2135, since all source operands for the instruction are predictable, the currently tracked prediction state of the target register is predictable, and the prediction state indicator for target register is to be marked as predictable when and if the instruction is retired. For example, in some embodiments, the current prediction state of the source and/or targets register for a given instruction may be tracked by the processor as the instruction passes through the execution pipeline. If and when the given instruction is retired, the respective predication state indicators associated with those registers may be updated to match the current prediction state of the registers, as tracked by the processor. At 2140, since at least one source operand for the instruction is not predictable, the currently tracked prediction state of the target register is unpredictable, and the prediction state indicator for the target register is to be marked as not predictable when and if the instruction is retired.

In at least some embodiments, steps 2115 to 2140 may be executed in hardware as part of executing the received (decoded) instruction.

In some embodiments, the marking to be applied to the prediction states of various registers may be calculated in parallel with the execution of each instruction. In some embodiments, the execution of instructions that are passing through the pipeline following a given instruction, but prior to the retirement of the given instruction, may be dependent on the current prediction state of the source and/or targets register for the given instruction, as tracked by the processor. For example, if the current prediction state of the target register for a first instruction is unpredictable and this target register for the first instruction is a source register for a second instruction that begins execution prior to retirement of the first instruction, the current prediction state of the target register for the first instruction may be used to determine whether or not a target register for the second instruction is predictable, even though the predication state indicator for the target register for the first instruction may not yet reflect that its value is unpredictable.

FIG. 21B illustrates an example method 2150 for outputting the values of some source registers and/or updating prediction state indicators for source and/or destination registers during retirement of an instruction, according to embodiments of the present disclosure. Method 2150 may be implemented by any of the elements shown in FIGS. 1-20. Method 2150 may be initiated by any suitable criteria and may initiate operation at any suitable point. In one embodiment, method 2150 may initiate operation at 2155. Method 2150 may include greater or fewer steps than those illustrated. Moreover, method 2150 may execute its steps in an order different than those illustrated below. Method 2150 may terminate at any suitable step. Moreover, method 2150 may repeat operation at any suitable step. Method 2150 may perform any of its steps in parallel with other steps of method 2150, or in parallel with steps of other methods.

Furthermore, method 2150 may be executed multiple times to output the values of source registers and/or to update prediction state indicators for source and/or destination registers during retirement of different instructions in the program. Method 2150 may be executed over time as part of characterizing the execution of the program over time. Method 2150 may be invoked during execution of method 1900 described above.

At 2155, in one embodiment, an executed instruction to be retired is received in a retirement unit of a processor. At 2160, instruction trace information for the instruction being retired is output to a trace, including branch information, if applicable. At 2165, it is determined whether or not the instruction included a memory access. If so, the method proceeds to 2175. Otherwise, the method proceeds to 2185. At 2185, since the instruction did not include a memory access, no register values are output to the trace.

At 2175, a determination is made as to whether all registers used for address generation for the memory access are predictable. At 2180, if it is determined that the values of all registers used for address generation are predictable, the method proceeds to 2185. Otherwise, the method proceeds to 2190. At 2185, since the values of all registers used for address generation are predictable, no register values are output to the trace. At 2190, the values of the unpredictable register (or registers) used for address generation are output to the trace, after which the register (or registers) are marked as predictable. At 2195, the predication state indicator of the target register for the instruction, if any, is updated according to a determination made during execution of the instruction. For example, in some embodiments, the current prediction state of a target register for the instruction may be tracked by the processor as the instruction passes through the execution pipeline. If and when the instruction retires, the predication state indicator of the target register for the instruction may be updated to match the current prediction state of the target register, as tracked by the processor.

In at least some embodiments, steps 2160 to 2195 may be executed in hardware as part of retiring the received (executed) instruction.

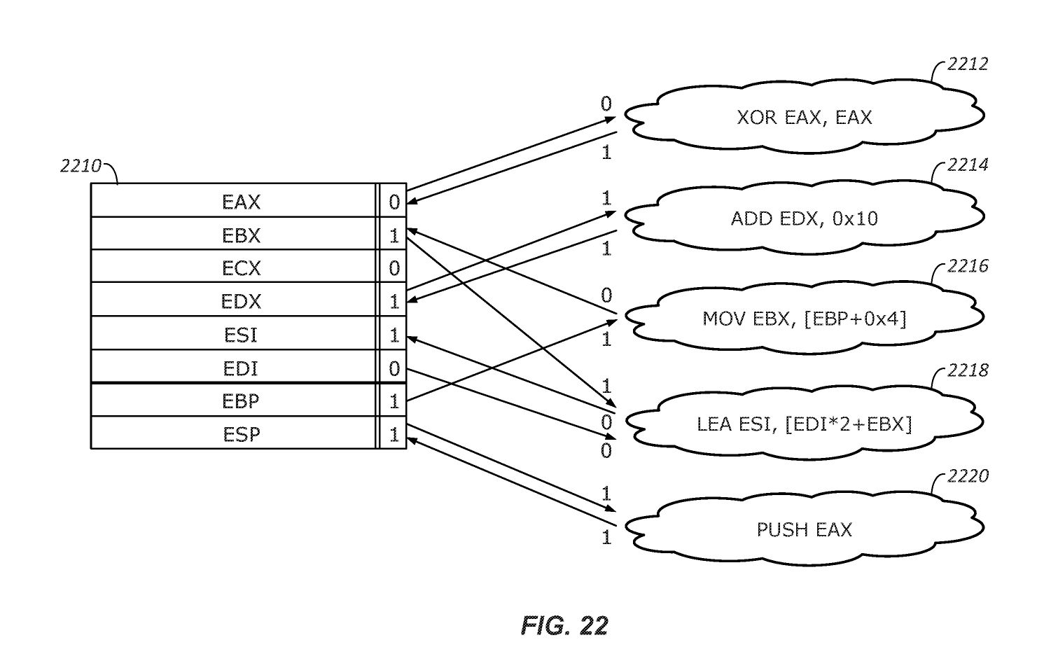

The systems and methods described herein for performing data address tracing may be further illustrated using an example in which different prediction state bit values are associated with different registers used for address generation. FIG. 22 illustrates the propagation of the respective predication state bits for various registers used for address generation by different instructions, according to embodiments of the present disclosure. In this example, registers 2210 includes eight 32-bit registers that can be used in address generation. These registers include four general-purpose registers (EAX, EBX, ECX, and EDX). In some embodiments, register EAX may typically be used as an accumulator register (e.g., in arithmetic operations), register EBX may typically be used as a base register (e.g., as a pointer to data), register ECX may typically be used as a counter register (e.g., in shift/rotate instructions and loops), and register EDX may typically be used as a data register (e.g., in arithmetic and input/output operations), although they may be used for other purposes. Registers 2210 also includes a source index register ESI and a destination index register EDI, which may typically be used as pointers in stream operations. Registers 2210 also includes a stack base pointer register EBP (which may typically be used to point to the base of the stack) and a stack pointer register ESP (which may typically be used to point to the top of the stack).

In this example, each of the registers 2210 includes an additional prediction state bit. The effects of the prediction state bits on the execution of five instructions, and the effects of the execution of each of the five instructions on the prediction state bits, are described below. In some embodiments, the initial values of at least some of the prediction state bits may have been written to the prediction state bits as a result of the execution of a previous instruction. In other embodiments, the initial values of at least some of the prediction state bits may have been set during a boot operation after a power-on or reset event. In some embodiments, the initial values of the prediction state bits for the registers to be used for address generation when executing a given instruction may be read prior to performing the address generation. In some embodiments, up-to-date values of the prediction state bits for these registers based on the execution of the given instruction may be written to the prediction state bits subsequent to executing the given instruction, such as during a retirement or writeback stage. The value written to the prediction state bit of a register subsequent to executing the given instruction may or may not be different than the initial value of the prediction state bit of the register.

In this example, the first instruction to be executed, instruction 2212, performs the operation “XOR, EAX, EAX”. Initially, the prediction state bit for the EAX register has a value of “0”, meaning that a simulation will not know nor be able predict its value. In this example, it is known that this instruction will zero out the contents of EAX. Therefore, the simulation will be able to calculate that the value of the EAX register following the execution of this instruction will be zero, no matter what its value was before instruction 2212 was executed. In this example, since the value of register EAX will be predictable at that point, after instruction 2212 is executed, the value of the prediction state bit for the EAX register will be set to “1”. Therefore, the next time this register is used for address generation, it will not need to be traced out.

In this example, the second instruction to be executed, instruction 2214, performs the operation “ADD EDX, 0x10”. Initially, the predication state bit for the EDX register is set to “1”, meaning that the value of the EDX register (prior to execution of instruction 2214) is known to or is predictable by the simulation. In this case, since the initial value of the EDX register is known to or is predictable by the simulation, the simulation will be able to calculate its value after the execution of instruction 2214 by adding a value of sixteen (hex) to the known initial value. Since the result of the execution of instruction 2214 will also be known to the simulation. The predication state bit for the EDX register is again set to “1” following the execution of instruction 2214.

In this example, the third instruction to be executed, instruction 2216, performs the operation “MOV EBX, [EBP+0x4]”. This instruction is a read from memory. More specifically, it is read from a location pointed to by the value of the EBP register incremented by four, and the result is written to the EBX register. In this example, even though the value of the prediction state bit for the EBP register is initially set to “1”, meaning that its value is known to or is predictable by the simulation, the value of the prediction state bit for the EBX register following the execution of instruction 2216 will be set to “0”. This is because instruction 2216 is a memory access, and the simulation, which in this case does not keep track of the memory contents nor simulate memory reads and writes, cannot know what has been read from memory. Therefore, the value of the target (destination) register following the execution of instruction 2216 is considered unpredictable. In this case, the execution of instruction 2215 would cause the prediction state bit for the EBX register to be reset to a value of “O”.

In this example, the fourth instruction to be executed, instruction 2218, performs an operation to load an effective address into the ESI register using the addressing mode “[EDI*2+EBX]”. In this example, although the initial values of both the prediction state bit for the ESI register and the prediction state bit for the EBX register are “1”, meaning that that their values are known to or are predictable by the simulation, the value of the prediction state bit for the ESI register following the execution of instruction 2218 will be reset to “0”. In this example, this is due to the fact that one of the inputs to the address generation calculation (in this case, the value of the EDI register) is unknown. Since at least one of the inputs to the operation is marked as unpredictable (with an initial prediction state bit value of “0”), the value of the target (destination) register following the execution of instruction 2218 is considered unpredictable. In this case, since the simulation cannot know what the value of the EDI register was prior to the execution of instruction 2218, it cannot know what was loaded into the ESI register. In this case, however, the core would not output the value of the EDI register in the trace because the LEA instruction is not a memory access.

In this example, the last instruction to be executed, instruction 2220, performs the operation “PUSH EAX.” Initially, the value of the prediction state bit for the stack pointer (ESP) is set to “1”. In addition, following the execution of instruction 2212, the prediction state bit for the EAX register is also set to “1”. In this example, because the stack pointer (the ESP register) had a predictable value (e.g., X) before the push operation, its value after the push operation will be X−4, and is thus still predictable. Therefore, the value of the prediction state bit for the stack pointer (ESP) remains “1” following the execution of instruction 2220. In at least some embodiments, because of the nature of stack operations, it may typically be the case that the simulation is able to recalculate the value of the stack pointer (ESP) following operations on the contents of the stack. Therefore, it may be that case that value of the prediction state bit for the stack pointer (ESP) is almost always “1”.

In at least some embodiments of the present disclosure, a simulation that has access to the binary executable of a program and a trace that includes both instruction trace information and the values of otherwise unpredictable registers may only keep track of register values during the simulation of the program. For example, the simulation may not keep track of the memory contents nor simulate memory reads and writes. Therefore, the simulation cannot know what has been read from memory. The simulation may keep track of which, if any, simulated registers contain known (or predictable) values by maintaining a respective known state bit for each of the simulated registers whose value indicates whether or not the value of the register is considered known or unknown.

The executable binary may provide information indicating any immediate addresses and values, read/write access widths, addressing modes and the registers involved in address calculations. The instruction trace may deliver a stream of executed instructions. In at least some embodiments, the simulation may keep track of the current register values by simulating the registers and, when possible, updating their values, as appropriate, while simulation of the program progresses. In some embodiments, not all of the register values have to be known at all times. Values that are needed may be recalculated by the simulation based on the instruction trace whenever possible. For example, the simulation may recalculate any values needed for address generation for instructions that perform register moves. In another example, the simulation may recalculate any values needed for address generation for instructions that perform arithmetic instructions involving known register values and/or immediate values obtained from the binary. Because the simulation might not know what registers will be needed for address generation later, it may attempt to recalculate the values of any registers that it can. If at least one of instruction sources is unknown (e.g., due to an unknown source register value or an unknown memory operand), the target register may also marked be as unknown. In at least some embodiments, as soon as the unknown value of a register is needed for address calculation, its value may be delivered (e.g., just in time) by the trace stream, after which the target register value becomes known again.

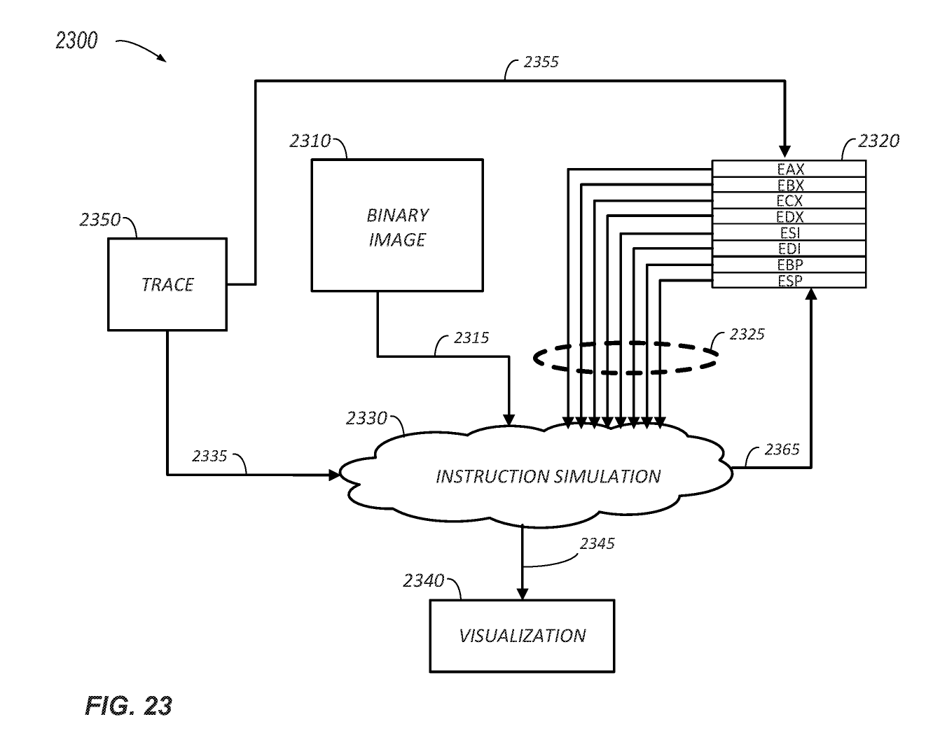

FIG. 23 illustrates selected elements of an example system for simulating the execution of a program dependent on data address tracing, according to embodiments of the present disclosure. In this example, system 2300 includes an executable image (e.g., a binary executable) of a program that has been traced and is being simulated, shown as binary image 2310. System 2300 also includes an instruction simulation (shown as instruction simulation 2330) and a visualization component (shown as visualization 2340). System 2300 also includes a collection of simulated registers 2320, each of which can potentially be used in an address generation in the program being simulated, depending on the addressing modes employed in the instructions in the program. In at least some embodiments, each of these simulated registers may be associated with a respective known state indicator whose value indicates whether or not its contents are known to instruction simulation 2330. Finally, system 2300 includes a trace 2350 that was recorded during execution of the program represented in binary image 2310 and that is being simulated in system 2300. In at least some embodiments, trace 2350 may include instruction trace information. This instruction trace information may include, for each conditional branch in the instruction stream, an indication of whether the branch was taken or not taken. In at least some embodiments, trace 2350 may include register trace information. This may include the values of registers that were used for address generation when the program was executed and traced and that are unpredictable by the simulation. These register values may have been captured in trace 2350 upon retirement of the instructions that used them in address generation.

In this example, an instruction stream 2315 is received by instruction simulation 2330 as input. The instruction stream 2315 may include, for each instruction in the instruction stream, its access type and width, addressing modes used, registers used, scale information, displacement information, and/or other information usable in generating addresses for load operations, store operations, or other operations for which an address is to be generated using one or more register addressing modes. Other inputs to instruction simulation 2330 include the current values of the simulated registers 2320 (shown as register values 2325) and instruction trace information obtained from trace 2350 (shown as instruction trace information 2335).

In order to generate addresses for the source and/or target (destination) operands of at least some of the instructions in instruction stream 2315, the instruction simulation 2330 may need to calculate the values of one or more of the simulated registers 2320 that are used to generate those addresses. For example, if one or more of the register values required to generate an address are unknown (as indicated by the value of their respective known state bits), and the instruction simulation 2330 cannot predict their values based on instruction stream 2315 (or binary image 2310) and the instruction trace information 2335 obtained from trace 2350, the simulation may obtain the recorded values of the registers from trace 2350 as unpredictable register values 2355. Instruction simulation 2330 may use the unpredictable register values 2355 to recalculate the register values needed for address generation and may insert the results (shown as recalculated register values 2365) into the appropriate ones of the simulated registers 2320 in time for their use in executing the corresponding instruction. For example, in some embodiments, instruction simulation 2330 may re-execute the portion of the instruction in which it writes to the registers, inserting the recalculated register value.

In at least some embodiments, as instructions are executed within instruction simulation 2330, information may be provided to a visualization tool (shown as visualization 2340). This information (shown as 2345) may include data indicating the instructions that were executed and the data addresses that were employed in data access operations. In some embodiments, this and other information may presented to a user through the visualization tool for a better understanding of the execution of the program. In some embodiments, visualization 2340 may be integrated with, or may be a component of, any of a variety of simulation, characterization or debugging tools. In other embodiments, visualization 2340 may provide inputs to a simulation, characterization or debugging tool.

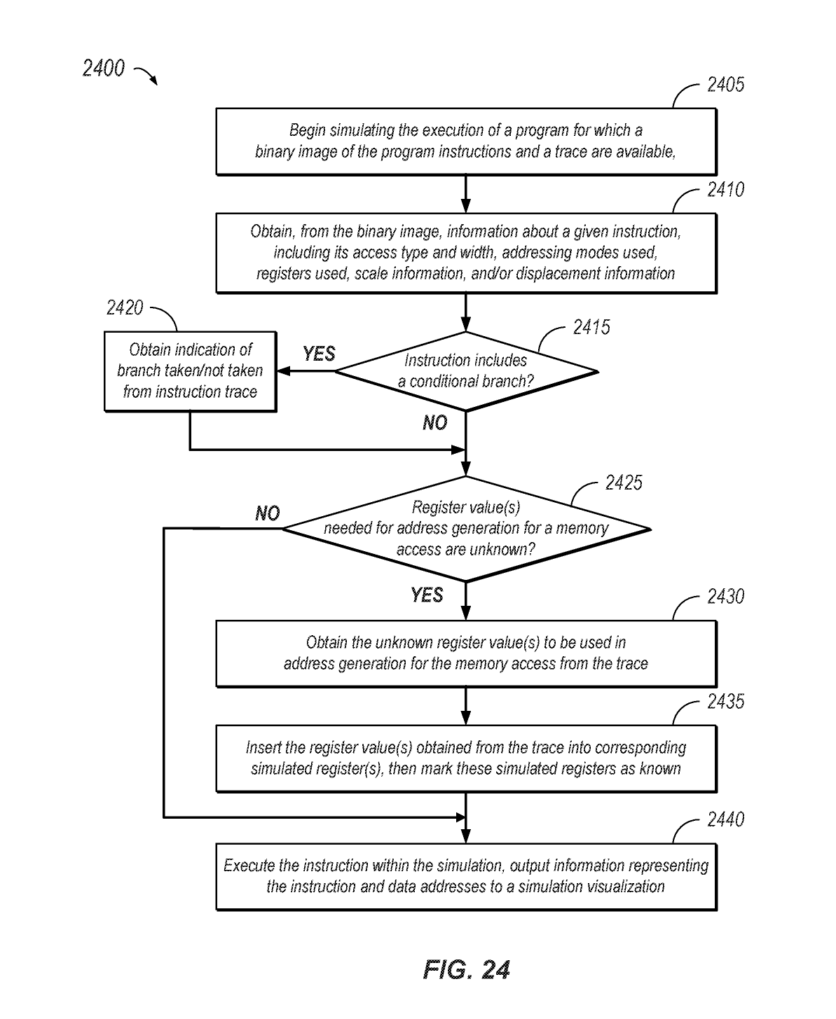

FIG. 24 illustrates an example method 2400 for simulating the execution of a program using data address trace information, according to embodiments of the present disclosure. Method 2400 may be implemented by any of the elements shown in FIGS. 1-23. Method 2400 may be initiated by any suitable criteria and may initiate operation at any suitable point. In one embodiment, method 2400 may initiate operation at 2405. Method 2400 may include greater or fewer steps than those illustrated. Moreover, method 2400 may execute its steps in an order different than those illustrated below. Method 2400 may terminate at any suitable step. Moreover, method 2400 may repeat operation at any suitable step. Method 2400 may perform any of its steps in parallel with other steps of method 2400, or in parallel with steps of other methods.

Furthermore, method 2400 may be executed multiple times to simulate the execution of different instructions in a stream of instructions. Method 2400 may be executed over time to simulate execution of a program over time. Method 2400 may be invoked by method 1900, described above.

At 2405, in one embodiment, a simulation of the execution of a program for which a binary image of the program instructions and a trace are available begins. In one embodiment, the trace may be generated in manner similar to that illustrated in FIGS. 21A and 21B, and described above. The trace may include both instruction trace information and register values that were output to the trace in response to a determination that they would otherwise be unpredictable in the simulation. At 2410, information about a given instruction, including its access type and width, the addressing modes it used, the registers it used, scale information, and/or displacement information is obtained, as applicable, from the binary image.

At 2415, it is determined whether or not the instruction includes a conditional branch. If so, the method proceeds to 2420. Otherwise, the method proceeds to 2425. At 2420, an indication of whether the branch was taken or was not taken is obtained from instruction trace.

At 2425, it may be determined whether or not any register values needed for address generation for a memory access to be performed by the given instruction are unknown in the simulation. If so, the method proceeds to 2430. Otherwise, the method proceeds to 2440.

In one embodiment, the simulation may track the status of each register that is potentially involved in address generation by maintaining, for each register, a “known state” indicator, whose value indicates whether or not the register's value is currently known to the simulator. In one embodiment, a value of “1” or “true” may indicate that the register's value is currently known, while a value of “0” or “false” may indicate that the register's value is not currently known. Determining whether or not any register values needed for address generation are unknown may include examining the respective “known state” indicators of those registers.

At 2430, the unknown register value (or values) to be used in address generation for the memory access are obtained from the trace. At 2435, the register value(s) obtained from the trace are inserted into the corresponding simulated register(s), after which these simulated registers are marked as containing known values. At 2440, the instruction is executed within the simulation, and information representing the instruction and its data addresses are output to a simulation visualization. In some embodiments, one or more of steps 2405 through 2440 may be executed in hardware as part of simulating the program. In other embodiments, one or more of steps 2405 through 2440 may be performed by program instructions executing on a system that implements a simulation environment in order to characterize or debug the program.

In some embodiments of the present disclosure, if there are data drops in the data address trace, only the current values of some of the registers in the simulation will be lost. However, since these registers are simulated, the simulation may quickly recognize the situation. In addition, since the memory is not simulated, the situation may not affect the whole shared state of the system memory. If some of the register values in the trace data are lost, this may affect a few reads or writes. However, at some point, there will be new trace data for registers whose values were lost because at another point in the program they became unpredictable and were traced out again. At this point, the simulation may be resynchronized, after which it may correctly calculate addresses as it continues forward past that point. In other word, using the data address tracing approach described herein, although data losses may result in small gaps in the simulation during which information is missing, once additional register values are available, the simulation will be able to correctly calculate addresses going forward. In contrast, in some other data tracing approaches, if just one piece of information is missing in the trace, the simulation may not be a reliable reflection of the execution of the traced program.

In at least some embodiments, in the case of data drops in the trace stream, where the required register value has not been delivered, the simulation may mark the register as unknown and may indicates to the user (e.g., through a visualization) that the address resulting from a calculation involving the dropped register value is unknown. However, the simulation may continue without corruption.

In at least some embodiments, in the case of a full trace corruption (e.g., one that affects the instruction trace stream), the simulation may mark all tracked register values as unknown. In this case, the simulation may deliver data addresses only after the necessary register values have been traced out again. For registers which are only rarely traced out, such as the stack pointer register, the tracing out of its current value may be forced in the processor by a periodic resetting of the predication state bit for the stack pointer register.

While the systems and methods for performing data address tracing disclosed herein are described primarily in terms of specific systems and processors (and their ISAs), these techniques may be applied in systems and processors having different architectures than those described herein. For example, a processor having a different architecture than those described herein may include hardware circuitry or logic to determine which, if any, register values involved in address generation should be traced out, and to output those register values, along with an instruction trace, for use in a subsequent simulation. In this way, rather than having to output addresses and corresponding data values to the trace, these address values may be recalculated by the subsequent simulation and used to determine the corresponding data values.

In at least some embodiments of the present disclosure, all memory operands may treated as unpredictable. However, since the percentage of memory accesses that are stack operations (e.g., push and pop operations) is typically relatively large, it may be beneficial to avoid having to trace out a previously pushed known register value when it is popped and subsequently used for address calculation. For example, when a known register value is pushed onto the stack, and subsequently popped, its value may be known to the simulation. This is the case even though the pop operation is a memory operation whose result would otherwise be considered unpredictable. In some embodiments of the present disclosure, the processor (or a core thereof) may include a small attribute stack in hardware in which the processor (or core) keeps track of the predication state of the last N pushed values. In one example, an attribute stack may include 64 one-bit entries, the respective values of which indicate whether or not a corresponding pushed value was known (or predictable) or unknown (and unpredictable) when it was pushed onto the stack. For embodiments in which the processor (or core) include an attribute stack, a corresponding simulation environment may simulate the attribute stack. When a register value is pushed or popped, its known state indicator may also be pushed or popped, accordingly. In some embodiments, this approach may reduce the trace data rate for stack-intensive applications. In addition, it may increase the sensitivity of the solution to trace corruptions. For example, in the case of trace corruption, the current stack content may become (and be marked) unknown.

In some embodiments of the present disclosure, the trace data bandwidth may be reduced by the application of one or more compression techniques. For example, in one embodiment, if the traced register values are used as offsets or indexes, they may include a relatively large number of leading zeros. These leading zeros may be stripped from the trace, saving one or more bytes each time one of these register is traced out. Similarly, in the case of good data locality, register values holding addresses may be traced out as deltas to the previous values. In some embodiments, the leading zeros of the deltas may be removed from the trace stream. In some embodiments, however, absolute values may be traced from time to time. For example, one or more absolute values may be traced periodically in order to synchronize a simulation at the beginning of a trace or to resynchronize a simulation after trace corruptions and/or a loss of trace data.

In at least some embodiments of the present disclosure, the complexity of the disclosed approach to data address tracing may be relatively low. For example, it may require only minor hardware enhancements on the processors (or cores thereof). This may include one predication state bit per register and hardware circuitry or logic to propagate the value of the predication state bit, and to output the values of register used for address generation that would otherwise be unknown to, and unpredictable by, a subsequent simulation. In at least some embodiments, the approach described herein may reduce data trace bandwidth requirements when compared to other data trace approaches. It may deliver to the trace virtual addresses as seen by the code, rather than physical addresses or cache line addresses that would require additional translation by a subsequent simulation.

In at least some embodiments, because only a small amount of state information (e.g., register values) is shared between the traced processor (or core thereof) and a subsequent simulation, the approach described herein may be extremely robust. For example, in case of trace corruptions or dropped trace data, the simulation may re-synchronize very quickly. In this case, the user may see only a few unknown addresses, but the rest of the trace may not be corrupted and may be fully reliable. In contrast, this would not be the case if the memory contents and/or caches were simulated as well. In at least some embodiments of the present disclosure, traced processors (or cores thereof) may not need to be slowed down (or stalled) in order to get a flawless trace. For example, in some embodiments, trace drops due to bandwidth peaks may be explicitly allowed, making this approach suitable for tracing real-time systems. In some embodiments, knowledge of an initial state of the registers or cache contents may not be required in order to perform data address tracing or to simulate a program based on data address tracing, as described herein. Consequently, there may be no initial trace bandwidth peak or slow-down required to transfer the initial state. This may also make “hot-plugging” to real-time systems possible, in some embodiments.

In at least some embodiments, since the necessary register values are included in the trace stream, the processing of the trace stream may be simplified, when compared to other data trace approaches. For example, the approach described herein does not require running lengthy simulations of all the memory contents. In addition, using this approach, it may be possible to edit the recorded trace stream (such as by cutting or post-filtering). In at least some embodiments, the approach described herein may be well suited for application to out-of-order architectures.

Embodiments of the mechanisms disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code may be applied to input instructions to perform the functions described herein and generate output information. The output information may be applied to one or more output devices, in known fashion. For purposes of this application, a processing system may include any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine-readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, embodiments of the disclosure may also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part-on and part-off processor.

Thus, techniques for performing one or more instructions according to at least one embodiment are disclosed. While certain exemplary embodiments have been described and shown in the accompanying drawings, it is to be understood that such embodiments are merely illustrative of and not restrictive on other embodiments, and that such embodiments not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

Some embodiments of the present disclosure include a processor. In at least some of these embodiments, the processor may include a front end to receive a plurality of instructions, a decoder to decode the plurality of instructions, a core to execute the plurality of instructions, and a retirement unit to retire the plurality of instructions. The core may include circuitry to determine, during execution of a first instruction of the plurality of instructions, whether or not a value of a first register input to an address generation operation for a memory access performed by the first instruction is predictable in an instruction simulation of the plurality of instructions. The processor may also include a trace unit, including circuitry to output, during retirement of the first instruction, in response to determining that the value of the first register is not predictable in the instruction simulation, the value of the first register to a trace of the execution of the plurality of instructions, and to elide the output of the value of the first register to the trace of the execution of the plurality of instructions, in response to determining that the value of the first register is predictable in the instruction simulation. In combination with any of the above embodiments, the target of the first instruction may be a destination register for the first instruction, the core may further include circuitry to write, during retirement of the first instruction, in response to determining that the first instruction performs a memory access, a value to a prediction state indicator associated with the destination register for the first instruction to indicate that the value of the destination register of the first instruction is not predictable in the instruction simulation. In combination with any of the above embodiments, the value of the first register input to the address generation operation for the memory access performed by the first instruction may not be predictable in the instruction simulation, and the core may further include circuitry to update, subsequent to the output of the value of the first register to the trace, a value of a prediction state indicator associated with the first register to indicate that the value of the first register is currently predictable in the instruction simulation. In combination with any of the above embodiments, the value of the first register input to the address generation operation for the memory access performed by the first instruction may be predictable in the instruction simulation, and the core may further include circuitry to determine, during execution of the first instruction, that the value of a second register input to the address generation operation for the memory access performed by the first instruction is not predictable in the instruction simulation. The trace unit may further include circuitry to output, during retirement of the first instruction, the value of the second register to the trace of the execution of the plurality of instructions. In combination with any of the above embodiments, the first register may be one of a plurality of registers to be used for address generation during execution of the plurality of instructions, and each of the plurality of registers to be used for address generation during execution of the plurality of instructions may be associated with a respective prediction state indicator whose value indicates whether or not the value of the register is predictable in the instruction simulation. In combination with any of the above embodiments, to determine, during execution of the first instruction, whether or not the value of the first register is predictable in the instruction simulation, the core may further include circuitry to determine a current value of the prediction state indicator associated with the first register. In combination with any of the above embodiments, the core may further include circuitry to determine, during execution of the first instruction, that respective values of all of a plurality of register inputs to the address generation operation for the memory access performed by the first instruction are predictable in the instruction simulation, and to elide the output of the respective values of the plurality of registers to the trace, responsive to the determination that the respective values of all of the plurality of register inputs to the address generation operation for the memory access performed by the first instruction are predictable in the instruction simulation. In combination with any of the above embodiments, the core may further include circuitry to determine, during execution of a second instruction of the plurality of instructions that the target of the second instruction is a destination register for the second instruction, to determine, during execution of the second instruction, whether or not all source operands for the second instruction are predictable in the instruction simulation, to write, during retirement of the second instruction, in response to determining that all source operands for the second instruction are predictable in the instruction simulation, a value to a prediction state indicator associated with the destination register for the second instruction to indicate that the value of the destination register of the second instruction is predictable in the instruction simulation, and to write, during retirement of the second instruction, in response to determining that at least one source operand for the second instruction is not predictable in the instruction simulation, a value to the prediction state indicator associated with the destination register for the second instruction to indicate that the value of the destination register of the second instruction is not predictable in the instruction simulation. In combination with any of the above embodiments, the core may further include circuitry to track, prior to retirement of the second instruction and dependent the determination of whether or not all source operands for the second instruction are predictable in the instruction simulation, a current prediction state of the destination register for the second instruction, to determine, during execution of a third instruction of the plurality of instructions and prior to retirement of the second instruction, that the value of the destination register for the second instruction is an input to an address generation operation for a memory access performed by the third instruction, and to track, prior to retirement of the third instruction, in response to determining that the current prediction state of the destination register for the second instruction is unpredictable, a current prediction state of the destination register for the third instruction, the current prediction state of the destination register for the third instruction to be unpredictable. The trace unit may further include circuitry to output, during retirement of the third instruction, in response to determining that the value of the destination register for the second instruction is not predictable in the instruction simulation, the value of the destination register for the second instruction to a trace of the execution of the plurality of instructions, and to elide the output of the value of the destination register for the second instruction the trace of the execution of the plurality of instructions, in response to determining that the value of the destination register for the second instruction is predictable in the instruction simulation. In combination with any of the above embodiments, the core may further include circuitry to output, to the trace of the execution of the plurality of instructions, instruction trace data for the first instruction.

Some embodiments of the present disclosure include a method. In at least some embodiments, the method may include, in a processor, receiving a first instruction in an instruction stream, decoding the first instruction, executing the first instruction, and retiring the first instruction. Executing the first instruction may include determining that a value of a first register input to an address generation operation for a memory access performed by the first instruction is not predictable in an instruction simulation of the plurality of instructions. Retiring the first instruction may include outputting, in response to determining that the value of the first register is not predictable in the instruction simulation, the value of the first register to a trace of the execution of the plurality of instructions. In combination with any of the above embodiments, the target of the first instruction may be a destination register for the first instruction, and retiring the first instruction may further include writing a value to a prediction state indicator associated with the destination register for the first instruction to indicate that the value of the destination register of the first instruction is not predictable in the instruction simulation. In combination with any of the above embodiments, the method may further include updating, subsequent to outputting the value of the first register to the trace, a value of a prediction state indicator associated with the first register to indicate that the value of the first register is currently predictable in the instruction simulation. In combination with any of the above embodiments, the value of the first register input to the address generation operation for the memory access performed by the first instruction may be predictable in the instruction simulation, and the method may further include determining, during execution of the first instruction, that the value of a second register input to the address generation operation for the memory access performed by the first instruction is not predictable in the instruction simulation, and outputting, during retirement of the first instruction, the value of the second register to the trace of the execution of the plurality of instructions. In combination with any of the above embodiments, the first register may be one of a plurality of registers used for address generation during execution of the plurality of instructions, and each of the plurality of registers used for address generation during execution of the plurality of instructions may be associated with a respective prediction state indicator whose value indicates whether or not the value of the register is predictable in the instruction simulation. In combination with any of the above embodiments, determining whether or not the value of the first register is predictable in the instruction simulation may include determining a current value of the prediction state indicator associated with the first register. In combination with any of the above embodiments, the method may further include receiving a second instruction in an instruction stream, the target of the second instruction being a destination register for the second instruction, decoding the second instruction, executing the second instruction, including determining that all source operands for the second instruction are predictable in the instruction simulation, and retiring the second instruction, including writing, in response to determining that all source operands for the second instruction are predictable in the instruction simulation, a value to a prediction state indicator associated with the destination register for the second instruction to indicate that the value of the destination register of the second instruction is predictable in the instruction simulation. In combination with any of the above embodiments, the method may further include receiving a second instruction in an instruction stream, the target of the second instruction being a destination register for the second instruction, decoding the second instruction, executing the second instruction, including determining that at least one source operand for the second instruction is not predictable in the instruction simulation, and retiring the second instruction, including writing, in response to determining that at least one source operand for the second instruction is not predictable in the instruction simulation, a value to a prediction state indicator associated with the destination register for the second instruction to indicate that the value of the destination register of the second instruction is not predictable in the instruction simulation. In combination with any of the above embodiments, determining that at least one source operand for the second instruction is not predictable in the instruction simulation may include determining that a prediction state indicator associated with a source register for the second instruction indicates that the value of the source register for the second instruction is not predictable in the instruction simulation, or determining that the second instruction performs a memory access. In combination with any of the above embodiments, the method may further include outputting, to the trace of the execution of the instruction stream, instruction trace data for one or more instructions in the instruction stream, and simulating, dependent on an executable image of the instruction stream and the trace of the execution of the instruction stream, the execution of the instruction stream. Simulating the execution of the instruction stream may include beginning simulation of the execution of the first instruction, obtaining the value of the first register from the trace, inserting the value of the first register obtained from the trace into a simulated register corresponding to the first register, and simulating the execution of the first instruction, which may include performing the memory access using the value inserted into the simulated register as the first register input to the address generation for the memory access.

Some embodiments of the present disclosure include a system. In at least some of these embodiments, the system may include a front end to receive a plurality of instructions, a decoder to decode the plurality of instructions, a core to execute the plurality of instructions, and a retirement unit to retire the plurality of instructions. The core may include circuitry to determine, during execution of a first instruction of the plurality of instructions, whether or not a value of a first register input to an address generation operation for a memory access performed by the first instruction is predictable in an instruction simulation of the plurality of instructions. The system may also include a trace unit, which may include circuitry to output, during retirement of the first instruction, in response to determining that the value of the first register is not predictable in the instruction simulation, the value of the first register to a trace of the execution of the plurality of instructions, and to elide the output of the value of the first register to the trace of the execution of the plurality of instructions, in response to determining that the value of the first register is predictable in the instruction simulation. In combination with any of the above embodiments, the target of the first instruction may be a destination register for the first instruction, and the core may further include circuitry to write, during retirement of the first instruction, in response to determining that the first instruction performs a memory access, a value to a prediction state indicator associated with the destination register for the first instruction to indicate that the value of the destination register of the first instruction is not predictable in the instruction simulation. In combination with any of the above embodiments, the value of the first register input to the address generation operation for the memory access performed by the first instruction may not be predictable in the instruction simulation, and the core may further include circuitry to update, subsequent to the output of the value of the first register to the trace, a value of a prediction state indicator associated with the first register to indicate that the value of the first register is currently predictable in the instruction simulation. In combination with any of the above embodiments, the value of the first register input to the address generation operation for the memory access performed by the first instruction may be predictable in the instruction simulation, and the core may further include circuitry to determine, during execution of the first instruction, that the value of a second register input to the address generation operation for the memory access performed by the first instruction is not predictable in the instruction simulation. The trace unit may further include circuitry to output, during retirement of the first instruction, the value of the second register to the trace of the execution of the plurality of instructions. In combination with any of the above embodiments, the core may further include circuitry to determine, during execution of the first instruction, that respective values of all of a plurality of register inputs to the address generation operation for the memory access performed by the first instruction are predictable in the instruction simulation, and to elide the output of the respective values of the plurality of registers to the trace, responsive to the determination that the respective values of all of the plurality of register inputs to the address generation operation for the memory access performed by the first instruction are predictable in the instruction simulation. In combination with any of the above embodiments, the core may further include circuitry to determine, during execution of a second instruction of the plurality of instructions that the target of the second instruction may be a destination register for the second instruction, to determine, during execution of the second instruction, whether or not all source operands for the second instruction are predictable in the instruction simulation, to write, during retirement of the second instruction, in response to determining that all source operands for the second instruction are predictable in the instruction simulation, a value to a prediction state indicator associated with the destination register for the second instruction to indicate that the value of the destination register of the second instruction is predictable in the instruction simulation, and to write, during retirement of the second instruction, in response to determining that at least one source operand for the second instruction is not predictable in the instruction simulation, a value to the prediction state indicator associated with the destination register for the second instruction to indicate that the value of the destination register of the second instruction is not predictable in the instruction simulation. In combination with any of the above embodiments, the first register may be one of a plurality of registers to be used for address generation during execution of the plurality of instructions, each of the plurality of registers to be used for address generation during execution of the plurality of instructions may be associated with a respective prediction state indicator whose value indicates whether or not the value of the register is predictable in the instruction simulation, and to determine, during execution of the first instruction, whether or not the value of the first register is predictable in the instruction simulation, the core may further include circuitry to determine a current value of the prediction state indicator associated with the first register. In combination with any of the above embodiments, the core may further include circuitry to track, prior to retirement of the second instruction and dependent the determination of whether or not all source operands for the second instruction are predictable in the instruction simulation, a current prediction state of the destination register for the second instruction, to determine, during execution of a third instruction of the plurality of instructions and prior to retirement of the second instruction, that the value of the destination register for the second instruction is an input to an address generation operation for a memory access performed by the third instruction, and to track, prior to retirement of the third instruction, in response to determining that the current prediction state of the destination register for the second instruction is unpredictable, a current prediction state of the destination register for the third instruction, the current prediction state of the destination register for the third instruction to be unpredictable. The trace unit further may include circuitry to output, during retirement of the third instruction, in response to determining that the value of the destination register for the second instruction is not predictable in the instruction simulation, the value of the destination register for the second instruction to a trace of the execution of the plurality of instructions, and to elide the output of the value of the destination register for the second instruction the trace of the execution of the plurality of instructions, in response to determining that the value of the destination register for the second instruction is predictable in the instruction simulation. In combination with any of the above embodiments, the core may further include circuitry to output, to the trace of the execution of the plurality of instructions, instruction trace data for the first instruction.

Some embodiments of the present disclosure include a system for executing instructions. In at least some of these embodiments, the system may include means for receiving a first instruction in an instruction stream, means for decoding the first instruction, means for executing the first instruction, including means for determining that a value of a first register input to an address generation operation for a memory access performed by the first instruction is not predictable in an instruction simulation of the plurality of instructions, and means for retiring the first instruction, including means for outputting, in response to determining that the value of the first register is not predictable in the instruction simulation, the value of the first register to a trace of the execution of the plurality of instructions. In combination with any of the above embodiments, the target of the first instruction may be a destination register for the first instruction, and the means for retiring the first instruction may further include means for writing a value to a prediction state indicator associated with the destination register for the first instruction to indicate that the value of the destination register of the first instruction is not predictable in the instruction simulation. In combination with any of the above embodiments, the system may further include means for updating, subsequent to outputting the value of the first register to the trace, a value of a prediction state indicator associated with the first register to indicate that the value of the first register is currently predictable in the instruction simulation. In combination with any of the above embodiments, the value of the first register input to the address generation operation for the memory access performed by the first instruction may be predictable in the instruction simulation, and the system may further include means for determining, during execution of the first instruction, that the value of a second register input to the address generation operation for the memory access performed by the first instruction is not predictable in the instruction simulation, and means for outputting, during retirement of the first instruction, the value of the second register to the trace of the execution of the plurality of instructions. In combination with any of the above embodiments, the first register may be one of a plurality of registers used for address generation during execution of the plurality of instructions, and each of the plurality of registers used for address generation during execution of the plurality of instructions may be associated with a respective prediction state indicator whose value indicates whether or not the value of the register is predictable in the instruction simulation. In combination with any of the above embodiments, the means for determining whether or not the value of the first register is predictable in the instruction simulation, may include means for determining a current value of the prediction state indicator associated with the first register. In combination with any of the above embodiments, the system may further include means for receiving a second instruction in an instruction stream, the target of the second instruction being a destination register for the second instruction, means for decoding the second instruction, means for executing the second instruction, including means for determining that all source operands for the second instruction are predictable in the instruction simulation, and means for retiring the second instruction, including means for writing, in response to determining that all source operands for the second instruction are predictable in the instruction simulation, a value to a prediction state indicator associated with the destination register for the second instruction to indicate that the value of the destination register of the second instruction is predictable in the instruction simulation. In combination with any of the above embodiments, the system may further include means for receiving a second instruction in an instruction stream, the target of the second instruction being a destination register for the second instruction, means for decoding the second instruction, means for executing the second instruction, including means for determining that at least one source operand for the second instruction is not predictable in the instruction simulation, and means for retiring the second instruction, including means for writing, in response to determining that at least one source operand for the second instruction is not predictable in the instruction simulation, a value to a prediction state indicator associated with the destination register for the second instruction to indicate that the value of the destination register of the second instruction is not predictable in the instruction simulation. In combination with any of the above embodiments, the means for determining that at least one source operand for the second instruction is not predictable in the instruction simulation may include means for determining that a prediction state indicator associated with a source register for the second instruction indicates that the value of the source register for the second instruction is not predictable in the instruction simulation, or means for determining that the second instruction performs a memory access. In combination with any of the above embodiments, the system may further include means for outputting, to the trace of the execution of the instruction stream, instruction trace data for one or more instructions in the instruction stream, and means for simulating, dependent on an executable image of the instruction stream and the trace of the execution of the instruction stream, the execution of the instruction stream. The means for simulating the instruction stream may include means for beginning simulation of the execution of the first instruction, means for obtaining the value of the first register from the trace, means for inserting the value of the first register obtained from the trace into a simulated register corresponding to the first register, and means for simulating the execution of the first instruction, which may include means for performing the memory access using the value inserted into the simulated register as the first register input to the address generation for the memory access.

What is claimed is:

1. A processor, comprising:
a front end to receive a plurality of instructions;
a decoder to decode the plurality of instructions;
a core to execute the plurality of instructions, including circuitry to:
determine, during execution of a first instruction of the plurality of instructions, whether or not a value of a first register input to an address generation operation for a memory access performed by the first instruction is predictable in an instruction simulation of the plurality of instructions;
a retirement unit to retire the plurality of instructions; and
a trace unit, including circuitry to:
output, during retirement of the first instruction, responsive to a determination that the value of the first register is not predictable in the instruction simulation, the value of the first register to a trace of the execution of the plurality of instructions;
elide the output of the value of the first register to the trace of the execution of the plurality of instructions, responsive to a determination that the value of the first register is predictable in the instruction simulation.

2. The processor of claim 1, wherein:
the target of the first instruction is a destination register for the first instruction;
the core further comprises circuitry to:
write, during retirement of the first instruction, responsive to a determination that the first instruction performs a memory access, a value to a prediction state indicator associated with the destination register for the first instruction to indicate that the value of the destination register of the first instruction is not predictable in the instruction simulation.

3. The processor of claim 1, wherein:
the value of the first register input to the address generation operation for the memory access performed by the first instruction is not predictable in the instruction simulation;
the core further comprises circuitry to:
update, subsequent to the output of the value of the first register to the trace, a value of a prediction state indicator associated with the first register to indicate that the value of the first register is currently predictable in the instruction simulation.

4. The processor of claim 1, wherein:
the value of the first register input to the address generation operation for the memory access performed by the first instruction is predictable in the instruction simulation;
the core further comprises circuitry to:
determine, during execution of the first instruction, that the value of a second register input to the address generation operation for the memory access performed by the first instruction is not predictable in the instruction simulation;
the trace unit further comprises circuitry to:
output, during retirement of the first instruction, the value of the second register to the trace of the execution of the plurality of instructions.

5. The processor of claim 1, wherein:
the first register is one of a plurality of registers to be used for address generation during execution of the plurality of instructions;
each of the plurality of registers to be used for address generation during execution of the plurality of instructions is associated with a respective prediction state indicator whose value indicates whether or not the value of the register is predictable in the instruction simulation.

6. The processor of claim 5, wherein:
to determine, during execution of the first instruction, whether or not the value of the first register is predictable in the instruction simulation, the core further includes circuitry to determine a current value of the prediction state indicator associated with the first register.

7. The processor of claim 1, wherein:
the core further comprises circuitry to:
determine, during execution of the first instruction, that respective values of all of a plurality of register inputs to the address generation operation for the memory access performed by the first instruction are predictable in the instruction simulation;
elide the output of the respective values of the plurality of registers to the trace, responsive to the determination that the respective values of all of the plurality of register inputs to the address generation operation for the memory access performed by the first instruction are predictable in the instruction simulation.

8. The processor of claim 1, wherein:
the core further comprises circuitry to:
determine, during execution of a second instruction of the plurality of instructions that the target of the second instruction is a destination register for the second instruction;
determine, during execution of the second instruction, whether or not all source operands for the second instruction are predictable in the instruction simulation;
write, during retirement of the second instruction, responsive to a determination that all source operands for the second instruction are predictable in the instruction simulation, a value to a prediction state indicator associated with the destination register for the second instruction to indicate that the value of the destination register of the second instruction is predictable in the instruction simulation;
write, during retirement of the second instruction, responsive to a determination that at least one source operand for the second instruction is not predictable in the instruction simulation, a value to the prediction state indicator associated with the destination register for the second instruction to indicate that the value of the destination register of the second instruction is not predictable in the instruction simulation.

9. The processor of claim 8, wherein:
the core further comprises circuitry to:
track, prior to retirement of the second instruction and dependent the determination of whether or not all source operands for the second instruction are predictable in the instruction simulation, a current prediction state of the destination register for the second instruction;
determine, during execution of a third instruction of the plurality of instructions and prior to retirement of the second instruction, that the value of the destination register for the second instruction is an input to an address generation operation for a memory access performed by the third instruction;
track, prior to retirement of the third instruction, responsive to a determination that the current prediction state of the destination register for the second instruction is unpredictable, a current prediction state of the destination register for the third instruction, the current prediction state of the destination register for the third instruction to be unpredictable;
the trace unit further includes circuitry to:
output, during retirement of the third instruction, responsive to a determination that the value of the destination register for the second instruction is not predictable in the instruction simulation, the value of the destination register for the second instruction to a trace of the execution of the plurality of instructions;
elide the output of the value of the destination register for the second instruction the trace of the execution of the plurality of instructions, responsive to a determination that the value of the destination register for the second instruction is predictable in the instruction simulation.

10. The processor of claim 1, wherein the core further comprises circuitry to:
output, to the trace of the execution of the plurality of instructions, instruction trace data for the first instruction.

11. A method, comprising, in a processor:
receiving a first instruction in an instruction stream;
decoding the first instruction;
executing the first instruction, including:
determining that a value of a first register input to an address generation operation for a memory access performed by the first instruction is not predictable in an instruction simulation of the plurality of instructions;
retiring the first instruction, including:
outputting, in response to determining that the value of the first register is not predictable in the instruction simulation, the value of the first register to a trace of the execution of the plurality of instructions.

12. The method of claim 11, wherein:
the target of the first instruction is a destination register for the first instruction;
retiring the first instruction further includes:
writing a value to a prediction state indicator associated with the destination register for the first instruction to indicate that the value of the destination register of the first instruction is not predictable in the instruction simulation.

13. The method of claim 11, further comprising:
updating, subsequent to outputting the value of the first register to the trace, a value of a prediction state indicator associated with the first register to indicate that the value of the first register is currently predictable in the instruction simulation.

14. The method of claim 11, further comprising:
receiving a second instruction in an instruction stream, the target of the second instruction being a destination register for the second instruction;
decoding the second instruction;
executing the second instruction, including:
determining that all source operands for the second instruction are predictable in the instruction simulation;
retiring the second instruction, including:
writing, in response to determining that all source operands for the second instruction are predictable in the instruction simulation, a value to a prediction state indicator associated with the destination register for the second instruction to indicate that the value of the destination register of the second instruction is predictable in the instruction simulation.

15. The method of claim 11, further comprising:
receiving a second instruction in an instruction stream, the target of the second instruction being a destination register for the second instruction;
decoding the second instruction;
executing the second instruction, including:
determining that at least one source operand for the second instruction is not predictable in the instruction simulation;
retiring the second instruction, including:
writing, in response to determining that at least one source operand for the second instruction is not predictable in the instruction simulation, a value to a prediction state indicator associated with the destination register for the second instruction to indicate that the value of the destination register of the second instruction is not predictable in the instruction simulation.

16. The method of claim 15, wherein:
determining that at least one source operand for the second instruction is not predictable in the instruction simulation comprises:
determining that a prediction state indicator associated with a source register for the second instruction indicates that the value of the source register for the second instruction is not predictable in the instruction simulation; or
determining that the second instruction performs a memory access.

17. The method of claim 11, further comprising:
outputting, to the trace of the execution of the instruction stream, instruction trace data for one or more instructions in the instruction stream;
simulating, dependent on an executable image of the instruction stream and the trace of the execution of the instruction stream, the execution of the instruction stream, including:
beginning simulation of the execution of the first instruction;
obtaining the value of the first register from the trace;
inserting the value of the first register obtained from the trace into a simulated register corresponding to the first register; and
simulating the execution of the first instruction, including performing the memory access using the value inserted into the simulated register as the first register input to the address generation for the memory access.

18. A system, comprising:
a front end to receive a plurality of instructions;
a decoder to decode the plurality of instructions;
a core to execute the plurality of instructions, including circuitry to:
determine, during execution of a first instruction of the plurality of instructions, whether or not a value of a first register input to an address generation operation for a memory access performed by the first instruction is predictable in an instruction simulation of the plurality of instructions;
a retirement unit to retire the plurality of instructions; and
a trace unit, including circuitry to:
output, during retirement of the first instruction, responsive to a determination that the value of the first register is not predictable in the instruction simulation, the value of the first register to a trace of the execution of the plurality of instructions;
elide the output of the value of the first register to the trace of the execution of the plurality of instructions, responsive to a determination that the value of the first register is predictable in the instruction simulation.

19. The system of claim 18, wherein:
the core further comprises circuitry to:
determine, during execution of a second instruction of the plurality of instructions that the target of the second instruction is a destination register for the second instruction;
determine, during execution of the second instruction, whether or not all source operands for the second instruction are predictable in the instruction simulation;
write, during retirement of the second instruction, responsive to a determination that all source operands for the second instruction are predictable in the instruction simulation, a value to a prediction state indicator associated with the destination register for the second instruction to indicate that the value of the destination register of the second instruction is predictable in the instruction simulation;
write, during retirement of the second instruction, responsive to a determination that at least one source operand for the second instruction is not predictable in the instruction simulation, a value to the prediction state indicator associated with the destination register for the second instruction to indicate that the value of the destination register of the second instruction is not predictable in the instruction simulation.

20. The system of claim 19, wherein:
the first register is one of a plurality of registers to be used for address generation during execution of the plurality of instructions;
each of the plurality of registers to be used for address generation during execution of the plurality of instructions is associated with a respective prediction state indicator whose value indicates whether or not the value of the register is predictable in the instruction simulation;
to determine, during execution of the first instruction, whether or not the value of the first register is predictable in the instruction simulation, the core further includes circuitry to determine a current value of the prediction state indicator associated with the first register.
